(19) United States
(12) Patent Application Publication
(10) Pub. No.: US 2025/0315760 A1
(43) Pub. Date: Oct. 9, 2025

(54) AI-Driven Digital Asset Co-pilot Apparatuses, Mechanisms, Mediums, Processes and Systems

(71) Applicant: Wrap Drive Inc., San Mateo, CA (US)

(72) Inventor: Raghu Veer Yarlagadda, Radwood, CA (US)

(21) Appl. No.: 19/245,151

(22) Filed: Jun. 20, 2025

Related U.S. Application Data
(63) Continuation-in-part of application No. 19/056,380, filed on Feb. 18, 2025.
Application No. 19/056,380 is a continuation-in-part of application No. 18/379,640, filed on Oct. 12, 2023.
(63) Continuation-in-part of application No. 19/056,402, filed on Feb. 18, 2025.
Application No. 19/056,402 is a continuation-in-part of application No. 18/379,640, filed on Oct. 12, 2023.
(60) Provisional application No. 63/415,602, filed on Oct. 12, 2022.
(60) Provisional application No. 63/415,602, filed on Oct. 12, 2022.
(60) Provisional application No. 63/744,355, filed on Jan. 12, 2025.

(51) Int. Cl. G06Q 10/0631

(52) U.S. Cl. CPC G06Q 10/06316

(57) ABSTRACT

The AI-Driven Digital Asset Co-pilot Apparatuses, Mechanisms, Mediums, Processes and Systems (“AIDAC”) transforms temporal quantum limited asset value request, temporal quantum limited asset fill request, ML engine training request, AI task processing request datastructure/inputs via AIDAC components into temporal quantum limited asset value response, temporal quantum limited asset fill response, ML engine training response, AI task processing response datastructure/outputs. A task processing request datastructure is obtained. A set of subtasks for the task is determined via an orchestration artificial intelligence engine. A subtask execution generative AI engine for each subtask is determined. A relevant subtask dataset is determined for each subtask and incorporated into an execution context of the subtask execution generative AI engine to utilize for the respective subtask. A subtask execution result is obtained for each subtask and evaluated for acceptability. A task execution result is composited via the subtask execution results via the orchestration artificial intelligence engine.

### PRIORITY CLAIM

Applicant hereby claims benefit to priority under 35 USC § 120 as a continuation-in-part of: U.S. patent application Ser. No. 19/056,380, filed Feb. 18, 2025, entitled “Temporal Quantum Assurance User Interface, Sandboxed Distributed Asset Router, and Edge Caching Datastructures Apparatuses, Processes and Systems”, (attorney docket no. WarpDrive0001CP2); and which in turn claims benefit to priority under 35 USC § 120 as a continuation-in-part of: U.S. patent application Ser. No. 18/379,640, filed Oct. 12, 2023, entitled “Temporal Quantum Assurance User Interface, Sandboxed Distributed Asset Router, and Edge Caching Datastructures Apparatuses, Processes and Systems”, (attorney docket no. WarpDrive0001US); and which in turn claims benefit to priority under 35 USC § 119 as a non-provisional conversion of: U.S. provisional patent application Ser. No. 63/415,602, filed Oct. 12, 2022, entitled “Temporal Quantum Assurance User Interface, Sandboxed Distributed Asset Router, and Edge Caching Datastructures Apparatuses, Processes and Systems”, (attorney docket no. WarpDrive0001PV).

Applicant hereby claims benefit to priority under 35 USC § 120 as a continuation-in-part of: U.S. patent application Ser. No. 19/056,402, filed Feb. 18, 2025, entitled “Temporal Quantum Assurance User Interface, Sandboxed Distributed Asset Router, and Edge Caching Datastructures Apparatuses, Processes and Systems”, (attorney docket no. WarpDrive0001CP3); and which in turn claims benefit to priority under 35 USC § 120 as a continuation-in-part of: U.S. patent application Ser. No. 18/379,640, filed Oct. 12, 2023, entitled “Temporal Quantum Assurance User Interface, Sandboxed Distributed Asset Router, and Edge Caching Datastructures Apparatuses, Processes and Systems”, (attorney docket no. WarpDrive0001US); and which in turn claims benefit to priority under 35 USC § 119 as a non-provisional conversion of: U.S. provisional patent application Ser. No. 63/415,602, filed Oct. 12, 2022, entitled “Temporal Quantum Assurance User Interface, Sandboxed Distributed Asset Router, and Edge Caching Datastructures Apparatuses, Processes and Systems”, (attorney docket no. WarpDrive0001PV).

Applicant hereby claims benefit to priority under 35 USC § 119 as a non-provisional conversion of: U.S. provisional patent application Ser. No. 63/744,355, filed Jan. 12, 2025, entitled “AI-Driven Digital Asset Co-pilot Apparatuses, Mechanisms, Mediums, Processes and Systems”, (attorney docket no. Warpdrive0002PV).

The entire contents of the target sources, e.g., aforementioned applications, are herein expressly incorporated by reference and any and all such incorporations by reference throughout the disclosure are to be considered actual and literal incorporations, in which the literal incorporation is considered to be an actual appending of the target sources en toto (e.g., text, visuals, etc.) into the current disclosure, as if it were typed and/or placed herein, originally, at the time of this disclosure; and such incorporation is instituted with no prejudice or disclaimer of any matter, and no reading into any contrast as to any differences and/or similarity as between the instant disclosure and the target source matter is to be discerned because the incorporated matter is to be considered as literally present herein as part of the instant application at the time of drafting and filing, and no other interpretations are contemplated nor to be considered legitimate.

This application for letters patent disclosure document describes inventive aspects that include various novel innovations (hereinafter “disclosure”) and contains material that is subject to any of: copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address artificial intelligence systems, and more particularly, include AI-Driven Digital Asset Co-pilot Apparatuses, Mechanisms, Mediums, Processes and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. § 112.

### BACKGROUND

Bitcoin is the largest example of a distributed crypto-currency. Bitcoin, a cryptographically secure decentralized peer-to-peer (P2P) electronic payment system provides transactions involving virtual currency in the form of digital tokens. Such digital tokens, e.g., Bitcoin coins (BTCs), employ cryptography to generate the tokens as well as validate related transactions.

### BRIEF DESCRIPTION OF THE DRAWINGS

Appendices and/or drawings illustrating various, non-limiting, example, innovative aspects of the AI-Driven Digital Asset Co-pilot Apparatuses, Mechanisms, Mediums, Processes and Systems (hereinafter “AIDAC”) disclosure, include:

FIGS. 1A-C show non-limiting, example embodiments of a datagraph illustrating data flow(s) for the AIDAC;

FIGS. 2A-B show non-limiting, example embodiments of a datagraph illustrating data flow(s) for the AIDAC;

FIG. 3 shows non-limiting, example embodiments of a screenshot illustrating user interface(s) of the AIDAC;

FIG. 4 shows non-limiting, example embodiments of a screenshot illustrating user interface(s) of the AIDAC;

FIG. 5 shows non-limiting, example embodiments of a screenshot illustrating user interface(s) of the AIDAC;

FIG. 6 shows non-limiting, example embodiments of an architecture for the AIDAC;

FIGS. 7A-B show non-limiting, example embodiments of a datagraph illustrating data flow(s) for the AIDAC;

FIG. 8 shows non-limiting, example embodiments of a logic flow illustrating a temporal quantum limited fill assurance (TQLFA) component for the AIDAC;

FIG. 9 shows non-limiting, example embodiments of a logic flow illustrating a temporal quantum asset value predicting (TQAVP) component for the AIDAC;

FIG. 10 shows non-limiting, example embodiments of a screenshot illustrating user interface(s) of the AIDAC;

FIG. 11 shows non-limiting, example embodiments of a screenshot illustrating user interface(s) of the AIDAC;

FIG. 12 shows non-limiting, example embodiments of a screenshot illustrating user interface(s) of the AIDAC;

FIG. 13 shows non-limiting, example embodiments of a screenshot illustrating user interface(s) of the AIDAC;

FIG. 14 shows non-limiting, example embodiments of a screenshot illustrating user interface(s) of the AIDAC;

FIG. 15 shows non-limiting, example embodiments of a screenshot illustrating user interface(s) of the AIDAC;

FIG. 16 shows non-limiting, example embodiments of a screenshot illustrating user interface(s) of the AIDAC;

FIG. 17 shows non-limiting, example embodiments of a screenshot illustrating user interface(s) of the AIDAC;

FIG. 18 shows non-limiting, example embodiments of a screenshot illustrating user interface(s) of the AIDAC;

FIG. 19 shows non-limiting, example embodiments of a datagraph illustrating data flow(s) for the AIDAC;

FIG. 20 shows non-limiting, example embodiments of a logic flow illustrating a machine learning engine training (MLET) component for the AIDAC;

FIG. 21 shows non-limiting, example embodiments of implementation case(s) for the AIDAC;

FIG. 22 shows non-limiting, example embodiments of an architecture for the AIDAC;

FIGS. 23A-B show non-limiting, example embodiments of a datagraph illustrating data flow(s) for the AIDAC;

FIG. 24 shows non-limiting, example embodiments of a logic flow illustrating an AI task processing (AITP) component for the AIDAC;

FIG. 25 shows non-limiting, example embodiments of a logic flow illustrating an AI data determining (AIDD) component for the AIDAC;

FIG. 26 shows non-limiting, example embodiments of a screenshot illustrating user interface(s) of the AIDAC;

FIG. 27 shows non-limiting, example embodiments of a screenshot illustrating user interface(s) of the AIDAC;

FIG. 28 shows non-limiting, example embodiments of a screenshot illustrating user interface(s) of the AIDAC;

FIG. 29 shows non-limiting, example embodiments of a screenshot illustrating user interface(s) of the AIDAC;

FIG. 30 shows non-limiting, example embodiments of a screenshot illustrating user interface(s) of the AIDAC;

FIG. 31 shows a block diagram illustrating non-limiting, example embodiments of a AIDAC controller.

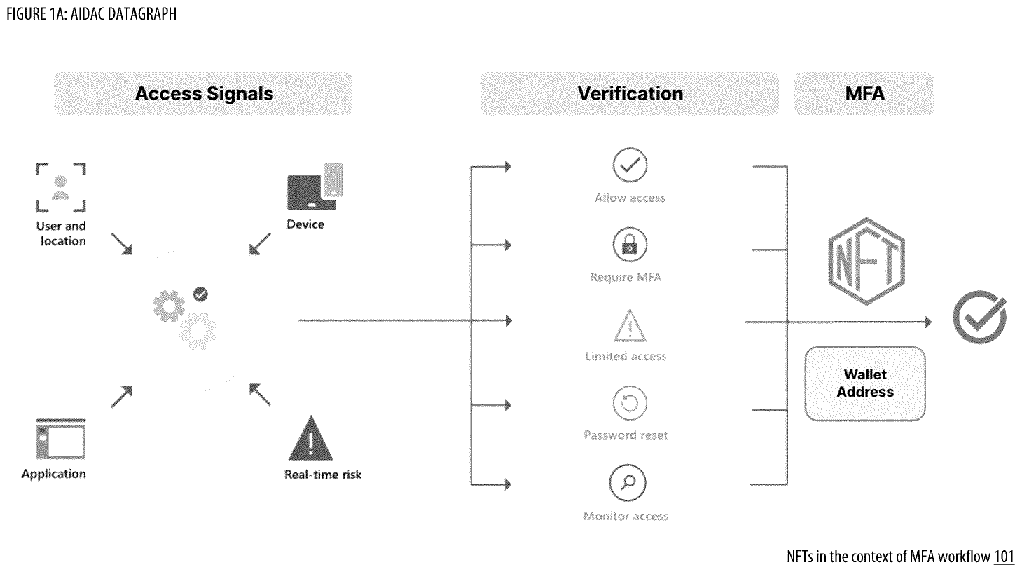

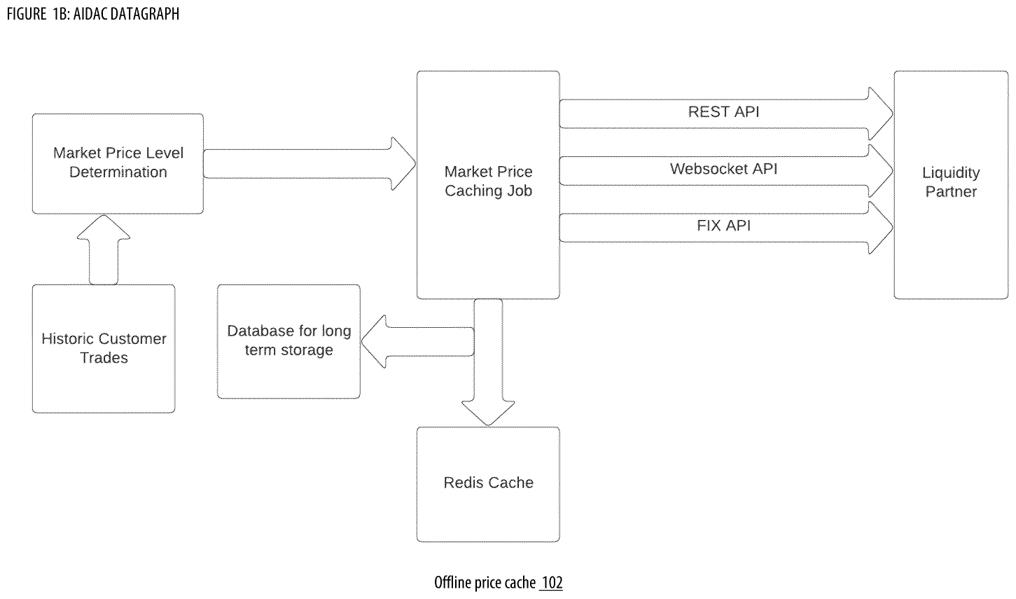

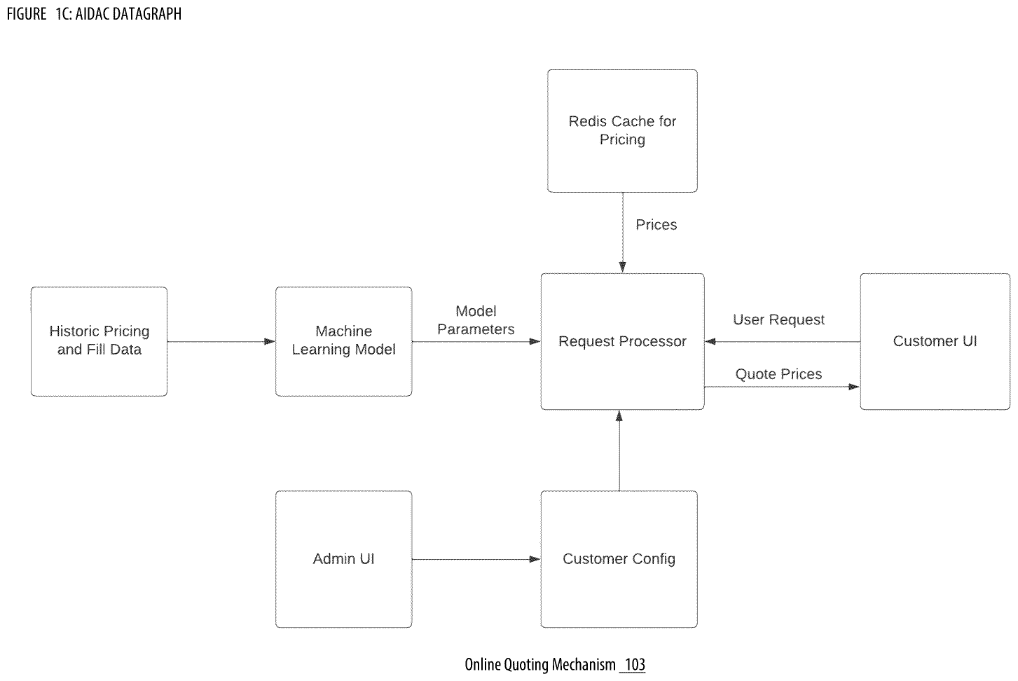

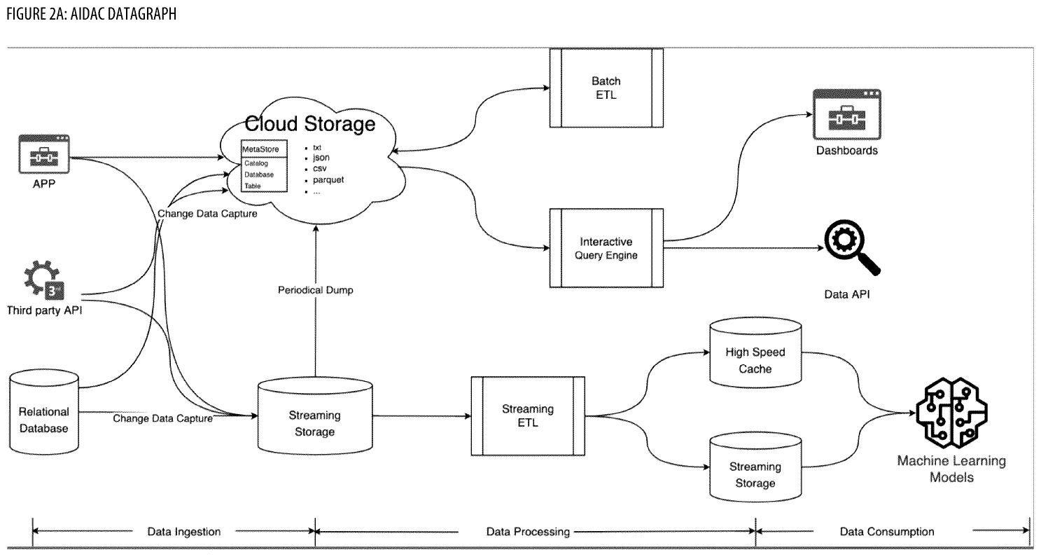

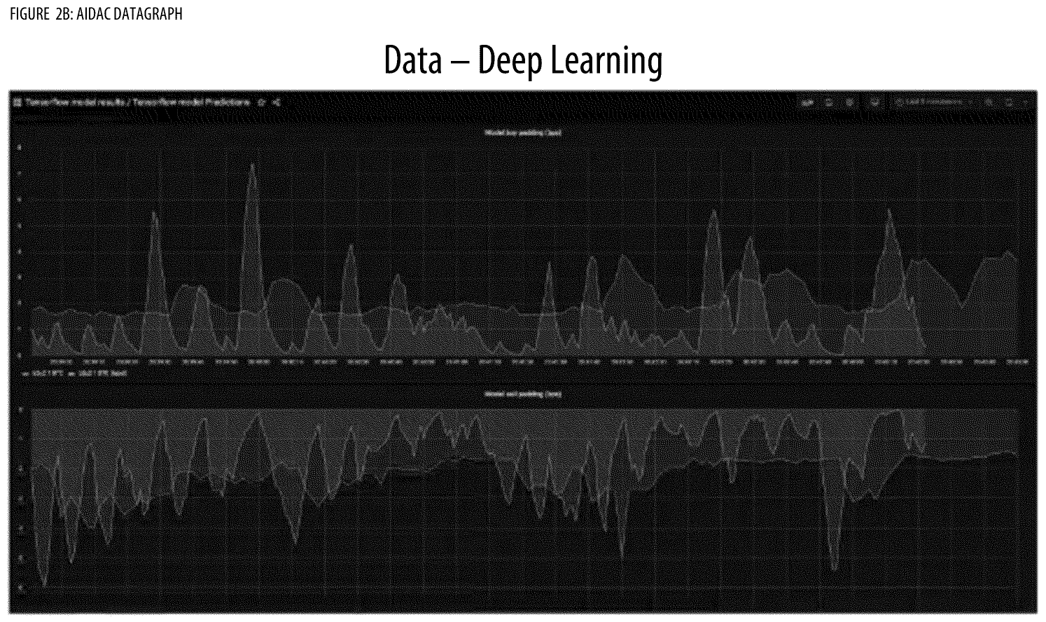

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citations and/or reference numbers are not necessarily sequences but rather just example orders that may be rearranged and other orders are contemplated. Citation number suffixes may indicate that an earlier introduced item has been re-referenced in the context of a later figure and may indicate the same item, evolved/modified version of the earlier introduced item, etc., e.g., server 199 of FIG. 1 may be a similar server 299 of FIG. 2 in the same and/or new context.

### DETAILED DESCRIPTION

The AI-Driven Digital Asset Co-pilot Apparatuses, Mechanisms, Mediums, Processes and Systems (hereinafter “AIDAC”) transforms temporal quantum limited asset value request, temporal quantum limited asset fill request, ML engine training request, AI task processing request datastructure/inputs, via AIDAC components (e.g., TQLFA, TQAVP, MLET, AITP, AIDD, etc. components), into temporal quantum limited asset value response, temporal quantum limited asset fill response, ML engine training response, AI task processing response datastructure/outputs. The AIDAC components, in various embodiments, implement advantageous features as set forth below.

### Introduction

The AIDAC provides unconventional features that were never before available in artificial intelligence systems (e.g., including: obtain an action guarantee temporal-quantum datastructure, in which the action guarantee temporal-quantum datastructure includes a value obtained from an administrative guarantee temporal-quantum user interface and a customer guarantee temporal-quantum preference datastructure; obtain a historic transaction attributes datastructure, in which the historic transaction attributes datastructure structured as including pricing and fill values; provide the historic transaction attributes datastructure to a temporal-fill machine learning engine, in which the fill machine learning engine generates structured temporal-fill parameters datastructures with the historic transaction attributes datastructure; obtain a user temporal-quantum-limited asset request datastructure from a temporal-quantum-limited asset request user interface; obtain temporal-fill parameters datastructures from the temporal-fill machine learning engine; query a quantum-limited asset cache with temporal-quantum-limited asset request datastructure and the temporal-fill parameters datastructures; provide temporal-fill asset datastructure to the temporal-quantum-limited asset request user interface, in which temporal-fill asset datastructure includes an asset identifier, and a temporal-quantum value, in which temporal-fill asset datastructure is structured as including a trigger for the temporal-quantum-limited asset request user interface, in which the temporal-quantum-limited asset request user interface is structured as employing the trigger for temporal-quantum-fill countdown user interface display element; obtain a temporal-fill asset request datastructure from the triggered temporal-quantum-limited asset request user interface, determine if temporal-fill asset request datastructure was obtained prior to expiration of the countdown user interface display element, and if obtainment was prior to the expiration, secure obtainment of an asset identified in the temporal-fill asset request datastructure).

### AIDAC

### DMA: Cloud-based Exchange Proxy Network

This feature provides comprehensive balance loading on behalf of the client. While exchanges limit the number of requests per IP/API key, cloud-based exchange proxy networks allow the client to connect to one proxy and the AIDAC load balance across multiple connections. The feature provides clients with accurate reporting of fees and balances based on internal configurations by replacing the exchange provided values. Shortest path to network.

### DMA: Transfer Network (Withdrawals & Transfers Between Crypto Exchanges/Accounts)

The AIDAC Transfer Network (e.g., Walled Garden) provides a single login to a standardized interface to easily access assets on multiple venues, which independently all have their own credentials, and unique user interfaces (different organization of menus, pages, tabs, etc.) The infrastructure organizes appropriately permissioned API keys (e.g. read, and transfer) in order to translate standard requests into exchange or network-specific requests—facilitating the movement of assets.

Intelligence—based on trading pattern on how money should move

### Fixed Interest Rate & Post-Trade Financing

Clients can execute a guaranteed principal trade and defer settlement for x days in exchange for a fixed interest rate.

Challenges we've solved include:
0048.1. Reduced operational burden—clients can extend the post-trade settlement window to further reduce the burden of settlement and/or complex inventory management.
0048.2. Elastic Credit—clients gain access to elastic credit tied to a guaranteed borrow rate.
0048.3. Simple & Programmatic Workflows—clients can gain the benefit of instant credit and reduced settlement w/a single click workflow, and/or automated opt-in.
0048.4. Example workflow include:
   0048.4.1. Client executes trade
   0048.4.2. Client elects to “flex” settlement with a single click
   0048.4.3. Client settles trade transferring fiat/coin in exchange for fiat/coin and or nets risk to zero via an offsetting transaction.

### Staking: Cross Collateralization of Assets

Clients are able to lend assets to AIDAC (for the purposes of staking+passive yield generation) and can leverage those assets to gain access to credit within the AIDAC One platform ecosystem. AIDAC has integrated (by asset) collateral discount factors that grant real-time credit capacity on the assets which are staked as well as productized risk mitigation and position management controls in-place to ensure clients remain fully collateralized. AIDAC provides clients a single click workflow to lend and gain yield on the assets. Clients are able to instantly leverage the credit extended across the AIDAC Transfer Network to access liquidity spanning the spot, futures, and derivative markets.

Challenges we've solved include:
0050.1. With AIDAC staking, clients are able to hedge their position market risk during periods while the asset is either staked and or is bonding/unbonding.
0050.2. Clients gain capital efficiency and ability to earn passive and active income from a single asset. Clients are able to increase their overall buying power at AIDAC and lever-up strategies while also earning maximum yield on the assets posted as collateral.
0050.3. Example workflow:
   0050.3.1. Lend idle assets (Stake)—via single click workflow
   0050.3.2. Access to Credit—instant access to credit via productized collateral discount factoring
   0050.3.3. Trade—execute a trade on the AIDAC one platform leveraging the staked idle assets to maximize returns.

### Entire Aggregated Liquidity Workstream (how the AIDAC Pieces Together)

Order book consolidation—the AIDAC independently sort bid and ask to produce the best global book of liquidity (this has been done many times already so nothing new, but the AIDAC can make it crypto specific—though the mechanism we're using for this is being done by Deltix for us).

Pre-trade checks are performed against back-office systems (B&R, and tomorrow, Risk Engine) to ensure that the client has sufficient assets to trade. Trade execution is submitted to our trade execution platform for fills, which creates a position in our principal book—and in turn gets hedged out (in part or in whole) to our liquidity venues (exchanges today, and LP's as well tomorrow). All executions are recorded in the Books and Records which in turn updates the client's account positions/balances and the pre-trade checks as a result.

Resulting balances can then be withdrawn/transferred to other AIDAC accounts, or accounts outside of the AIDAC ecosystem

Challenges we've solved include:
0054.1. The AIDAC provide a generic deposit attribution workflow where the AIDAC is able to generate deposit addresses for clients, receive assets, and deploy it within the AIDAC ecosystem.
0054.2. The AIDAC provides inventory management, where deposits are made to us and the AIDAC disseminates it to liquidity sources based on where the AIDAC needs to source liquidity—trading/hedging on omnibus accounts.
0054.3. Reliability in backend (identify fake volume & increase reliability of data visualization)

### Portfolio Margining

Clients are able to maximize capital efficiency and achieve greater buying power by risk-adjusted position netting across assets and venues.

Challenges we've solved include:
0056.1. Diminished exchange liquidation risk—Portfolio Margining minimizes the burden of inventory management of clients needing to move assets between venues to prevent liquidation on offsetting trades.
0056.2. Multi-Coin Collateral—portfolio margining provides clients to post collateral in either fiat or numerous coins via programmatic risk adjusted discount factoring tied to a BTC beta reference.
0056.3. Maximum capital efficiency—Robust risk engine calculates full portfolio risk analysis to determine risk-adjusted buying power across asset classes including futures, options, levered staking, and spot.

Example workflow (simple, offsetting spot trade) include:
0057.1. Client has total buying power of 1M notional $USD
0057.2. Clients executes a long position on venue X for $800 notional $USD
0057.3. Clients executes a short position on venue Y for $300M notional $USD
0057.4. Client now has total buying power of $500M due to position risk netting vs. the gross position total of 1.1M if viewed independently.

### NFT's Use Case in AML/KYC

Non-Transferrable NFT on ERC20 indicates KYC/AML compliance of an on-chain address. Meanwhile, dAPPs may build KYC/AML verified pools using NFT.

The way this use case is structured is: KYC/AML is run by approved network of centralized firms e.g., AIDAC, Coinbase and the NFT is minted and disbursed through 51% approval from the validator network.

### Engineering Example Embodiments

### Time Guarantee Mechanism

The use case is that customers are interested in absolute price level execution with time guarantee to make the decision.

Technical challenges solved include:
0061.1. The AIDAC provides a system and process to do this in a completely riskless way
0061.2. Our system gives 99.99% fill rate with tight spreads using deep learning (e.g., see FIG. 2B for example)
0061.3. Our system runs on both venues with time guarantee and extracts synthetic time guarantee from venues without time guarantee

The AIDAC includes an automated system for providing time guaranteed quotes for digital assets as a riskless principal with high fill rate using deep learning (e.g., see FIG. 2A for example).

One of the order types that can be a problem which is used by traders who come to AIDAC for trading digital assets is the Request For Quote order type. The order flow works the following way:
0063.1. The trader picks an instrument and a quantity and sends AIDAC a request
0063.2. AIDAC responds with a bid/ask price (quote) with a timestamp (expiry timestamp) till which the bid/ask price is valid
0063.3. The trader has the option to request execution on the quote before the expiry timestamp
0063.4. AIDAC then responds with a accept or reject response

There are certain implicit constraints for making this order type usable
0064.1. The bid/ask price cannot be too large (best possible price)
0064.2. The acceptance rate should be high (high fill rate)

Additionally there are certain explicit constraints
0065.1. Traders don't want to face an entity that is taking directional risk i.e. using a dealer model. They prefer a counterparty who doesn't take directional risk. (riskless principal)
0065.2. The system should support multiple instruments and continuous quantities and run with less manual intervention (completely automated)

In one example embodiment the AIDAC considers spot trades in this system, which may avoid toxicity to partners by avoiding splitting a client order into multiple chunks.

### AIDAC Time Guarantee Mechanism Solution

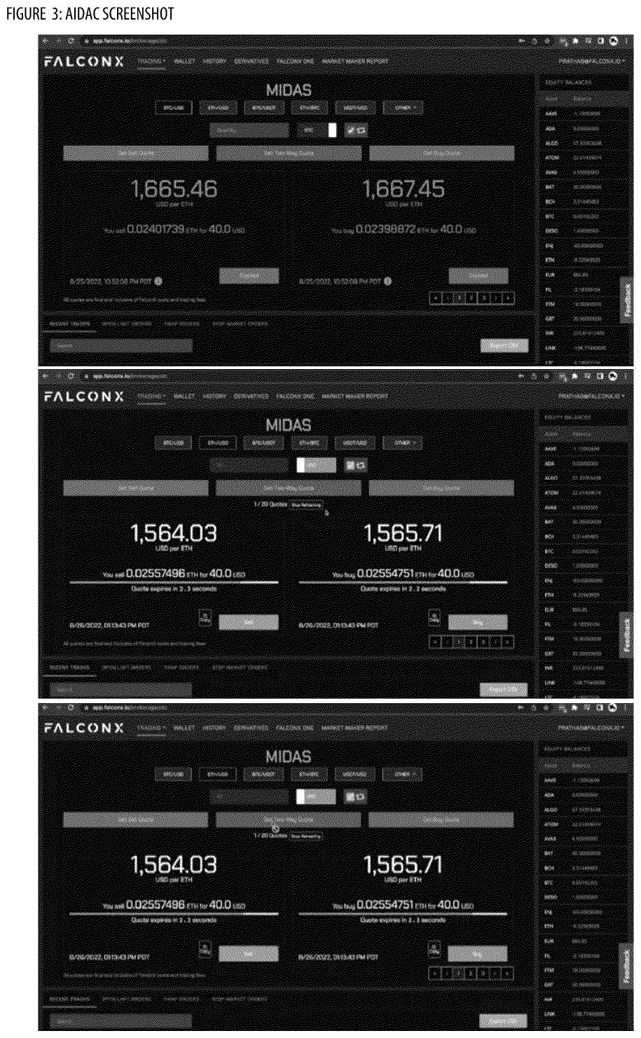

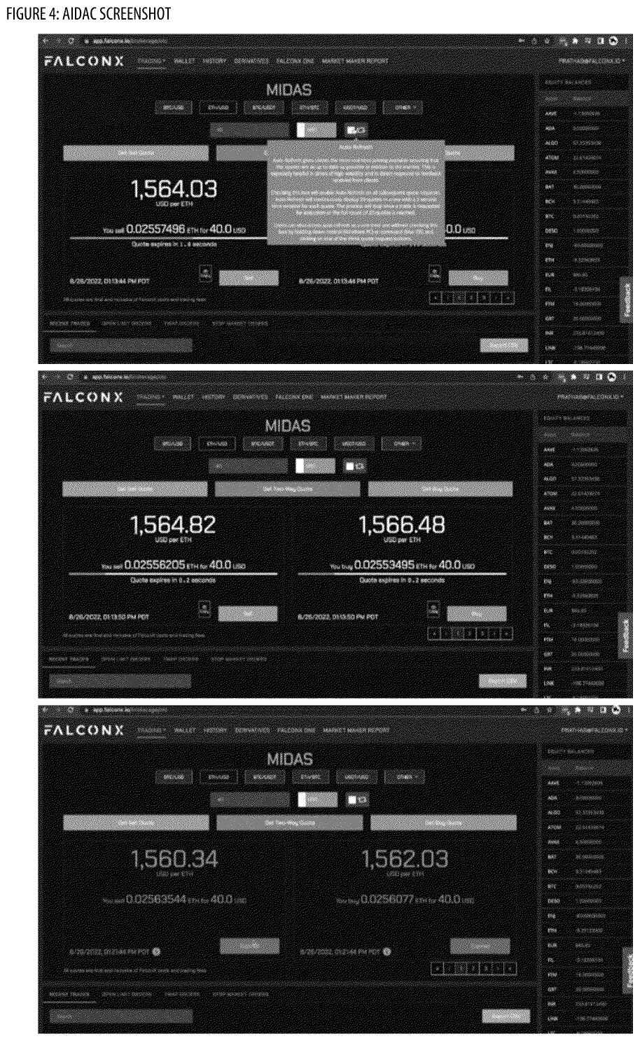

Screenshot Walk thru, e.g., see FIGS. 3-5.

### AIDAC Data Flow

There are two major components (e.g., see 102 and 103 of FIGS. 1B and 1C for example):
0068.1. Offline processes that collect prices and caches (e.g., see 102 of FIG. 1B for example)
0068.2. Online quoting mechanism that uses the price cache to generate a customer specific quote (e.g., see 103 of FIG. 1C for example)

Example historic customer trades are of the format

```
{
  Market:
  ‘BTC/USD’
  Quantity: 5.5,
  Side: ‘sell’,
  Price: 22000
}
```

From the last 90 days of data the AIDAC estimates different price levels to scrap from the liquidity partners.

The market price level determination module does this periodically and gives the levels to the price caching job. This message is of the form:
{‘BTC/USD’: [1, 5, 10, 100], ‘ETH/USD’: [1, 10, 100, 1000] . . . }

Then the market price caching job uses the levels for each market to scrap the prices from the liquidity partners and store in
0072.1. Database for long term storage and analytics
0072.2. Redis (e.g., quantum) cache for consumption by the online pricing system

The caching jobs query the liquidity partner for prices for a quantity with requests of the form:

```
{
  Market: ‘BTC/USD’,
  Quantity: 5
}
```

The liquidity partners in turn respond with the prices for selling and buying from them

```
{
  QuoteId (optional): ‘XYZ’,
  Market: ‘BTC/USD’,
  Quantity: 5,
  SellPrice: 21900,
  BuyPrice: 22000,
  TimeExpiry (optional): <t>
}
```

Some LPs provide a time guarantee for their quotes, e.g., see 103 of FIG. 1C.

### Time Guarantee Mechanism Exemplary Implementation

In one implementation, the AIDAC enables users to request a quote for a crypto token in token units or dollar units. One innovation lies in how we provide a time guarantee with a high fill rate in the RFQ trading system.

### Offline Modeling

The methodology for processing and predicting liquidity venue prices effectively integrates real-time and historical data analysis through the use of advanced neural network architectures. This comprehensive process involves the following structured steps and data formats:

### 1. Data Capture and Storage:

Data is captured and stored in a structured tabular format, for subsequent transformations and analysis:
   |Liquidity Venue Name|Market|Quantity|Price|Time Guarantee (optional)|

This format ensures relevant variables are recorded, e.g., including the liquidity venue name, market, quantity, price, and an optional time guarantee.

### 2. Data Transformation Via Fixed Time Delta Match:

The raw data is transformed using a fixed time delta approach with a sliding window matching technique, resulting in a structured table format that facilitates time-based comparisons:
   |Liquidity Venue Name|Market|Quantity|Fixed Time Delta (seconds)|Price at Time t|Price at Time t+Fixed Time Delta|

This structured format facilitates aligning data points based on specific time intervals.

### 3. Construction of Time-Series Input for RNN:

For training the Recurrent Neural Network (RNN), the last 10 minutes of data are processed to create time-series input, capturing price movements across different quantities:

Time Segment | Liquidity Venue Name | Market | Quantity | Price |
|--------------|----------------------|--------|----------|-------|
| t-599 seconds | Venue A | Market X | Q1 | P1 |
| t-598 seconds | Venue A | Market X | Q2 | P2 |
| ... | ... | ... | ... | ... |
| t-0 seconds | Venue Z | Market Y | On | Pn |

This data format allows the RNN to learn the temporal patterns of price changes effectively.

4. Integration of RNN Output with DNN Input:

The hidden state output from the RNN, representing learned temporal features, is integrated with additional static inputs for the Deep Neural Network (DNN) training:

| RNN Hidden State | Liquidity Venue Name | Market | Quantity |
|------------------|----------------------|--------|----------|
| H1 | Venue C | Market Z | Q5 |

This format includes the RNN's hidden state along with specific details about the liquidity venue.

### 5. DNN Model Training and Prediction:

The DNN uses the combined input to predict future prices at a specified time delta:

| Predicted Price at Time t + Fixed Time Delta |
|-----------------------------------------------|
| Predicted Price |

This final predictive model leverages both the dynamic temporal patterns captured by the RNN and the contextual specifics provided by the additional inputs to make accurate predictions about future price movements in various markets.

This dual-model architecture (RNN and DNN) optimizes the predictive capabilities for financial market analytics, particularly useful in environments with highly dynamic and volatile data streams.

### Online Serving

The online serving component for the neural model predicting liquidity venue prices incorporates several steps to ensure real-time response, accuracy, and user satisfaction. Below is the logic detailing each step in the process:

### 1. User Input

Action: The user enters their desired market and quantity through the interface.

### 2. User Authentication and Rate Limiting

Action: Authenticate the user to verify their identity and permissions.

Check: Perform rate limit checks to ensure that the system's usage is within acceptable parameters, preventing abuse.

### 3. Price Prediction and Selection

Cache Retrieval: Retrieve the current prices for liquidity venues from a cache, ensuring fast access to the most recent data.

Prediction: Use the previously trained neural model to predict necessary price adjustments (padding) for each venue. This model accounts for current market trends and historical data to adjust the raw prices accordingly.

Selection: Apply the predicted padding to each venue's price. Among these adjusted prices, select the venue offering the best price for the user's specified market and quantity.

### 4. User Decision

Display: Present the best-adjusted price to the user.

User Action: Allow the user to decide whether to execute a transaction at the quoted price.

### 5. Transaction Routing and Execution

Execution Attempt: If the user chooses to execute, route the transaction to the liquidity venue offering the best price.

Failure Handling: In case of execution failure at the primary venue (e.g., due to price changes, unavailability), attempt to route the transaction to the second and third best venues, respectively.

Sequential Routing: This process ensures that the user still obtains a competitive price even if the initial venue cannot fulfill the transaction.

### 6. Response to User

Success: On successful execution, confirm the transaction details with the user, including the final execution price and venue.

Failure: If all routing attempts fail, inform the user of the failure and provide options for retrying or modifying their order parameters.

### Edge (System to Reduce Latency) & Virtual Cloud Colocation

The use case is that customers need portfolio margin; however, high frequency traders' portfolios are spread across multiple venues

Technical Challenges solved include:
0129.1. The AIDAC includes a low latency virtually colocated system to give direct access to venues for high frequency traders who need low latency trading
0129.2. The AIDAC includes a real time risk engine/model to provide portfolio margin on top of these virtually colocated direct access venues

### Engineering Example Security Embodiments

### Introduction

Project Falcon is an ongoing initiative to institutionalize the use of NFTs in the crypto brokerage industry. This project allows for additional client trading data, KPIs and product engagement to be tracked while providing a new client facing mechanism to incentivize continued volume and product exposure. In one embodiment, these NFTs may be used for Multi-Factor-Authentication during the login and address whitelisting processes.

Each NFT may be minted free of charge when a new client parent entity joins AIDAC. Client NFTs may be a 1:1 reflection of their trading volume and engagement with our product stack, this may in turn make the NFT's held by high volume, high pnl clients more rare by nature. As a general rule, all clients may have one NFT at the parent account level, this may take into account all sub-account activity.

Upon onboarding users may be asked to sign a transaction that may verify their log-in wallet address. Once an NFT is minted it may be sent to their verified address. Upon logging in, a user's NFT may be verified as well as their login address. If both pass verification the user may be granted access, this may in turn function as a stand-in for current MFA procedures for logins.

The NFT may effectively exist in place of the random code generated by an MFA app while the verified address may function as a stand-in for the onboarding QR code scan used by apps today. Together they create a streamlined unique ID that does not require any random codes to be generated or any 3rd party apps to be used for authentication.

### Security Mechanisms and Use Case: MFA Protocol

In general, NFTs can function as identifiers for their owners as they are unique, non-fungible and rather difficult to replicate. Blockchain ledgers record both the genesis event in which the NFT is created as well as its entire transaction history; in turn bad actors using an identical copy of an NFT would not be providing sufficient proof of ownership. Regarding MFA, NFTs can be used to function as (a) unique user identifiers and (b) a secure communication of ownership and identity. By vetting both the wallet the NFT is stored in as well as the NFT itself by tracing its transaction history back to the genesis event, our application may be able to not only identify the user attempting to gain access but do so in a much more streamlined manner than what is currently industry standard.

The login process would follow these steps given NFTs as an MFA screen (as seen in FIG. 1A).
0135.1. User attempts access
   0135.1.1. User credentials and location is vetted against the norm
   0135.1.2. Device is vetted against the norm
   0135.1.3. Application used for access is vetted against the norm
0135.2. If above 1-3 user access attempts do not raise any risk flags the user may be granted access if MFA is not required
0135.3. If MFA is required a pop up to trigger a wallet connection may be initiated (all major providers may be supported including hard wallets)
0135.4. Once a wallet is connected, the wallet address may be vetted against an internal database of public addresses
0135.5. Once the address has cleared verification a search for the users mapped NFT may initiate
0135.6. Once the NFT is found, the user may be granted access to their account/product feature secured by this protocol.

If a client requires an NFT transfer they may do so only if the transfer wallet has been whitelisted and included in our internal wallet database. Users may also need to sign a transaction to onboard the new wallet, complete an email verification of the wallet transfer and undergo a video chat to verify identity while initiating this transfer, e.g., see 101 of FIG. 1A NFTs in the context of MFA workflow.

### Minting and Logistics

Each NFT may be minted to a AIDAC owned wallet via a bespoke smart contract. This contract may only mint a new NFT when a new parent organization onboards as a net new client. Once the client account has been provided, trading agreement signed, and NFT deposit wallet whitelisted, their NFT may be sent to them and reflected in their account.

Churned client NFTs may be burned after a predetermined period of time. If a churned client were to return a new NFT would need to be minted.

All clients may have one single NFT at the parent account level. This may take into account all sub-account activity. This rule may only be overwritten in the case of a high volume client with many high volume and or distinct entities.

Each NFT may be unique and may thus also allow for use within all external client communication as an anti-phishing mechanism i.e., clients may recognize their NFTs included in all email communications in which logging in or MFA is required. If their NFTs are not included the client can assume the communication is a phishing attempt.

### AIDAC Transfer Network

The Transfer Network is the internal system through which the AIDAC transfers funds within the AIDAC ecosystem. This allows customers to take control of their assets in a secure and self-serve manner.

These clients may want:
0142.1. To move their assets between exchanges.
0142.2. To move their assets between AIDAC products.
0142.3. To have instant borrows, deposits and transfers.

They don't want:
0143.1. To whitelist addresses per location, token and network.
0143.2. To onboard and integrate with each location they want to transfer assets to.
0143.3. To wait to receive their assets (aka lag time for on-chain transfers and whitelisting).

The AIDAC offers exchange to exchange transfers which allows customers to skip the difficulty of whitelisting and leverage our account network to transfer funds between one exchange and another. The AIDAC currently does not charge for this.

Current example embodiments include:

Support for Binance via the UI. Okex, FTX and Huobi are available via API, but require integration with MIDAS API.

Support for USDT, ETH, SOL, USDC, BTC

Still an on-chain transfer.

This provides opportunity to address growing customer needs.

Opportunities for this product include, but aren't limited to:

Fluid self-serve transfer functionality within AIDAC, e.g., move funds from MIDAS to Edge, from Edge to Staking.

Instant borrows on exchanges.

Support settlement and transfers with other brokers on the customer's behalf.

AIDAC transfer system: any entity the AIDAC has KYC'ed and onboarded can transfer assets between them without additional onboarding.

The AIDAC wants them to use this instead of:

### Clearloop by Copper

Fireblocks Network by Fireblocks

AIDAC supports connecting the products within our ecosystem, moving us towards the one-stop shop prime brokerage.

### AIDAC Transfer Network—Vision

Money management is difficult and cumbersome in the crypto ecosystem; this hinders AIDAC customers and the growing institutional presence in engaging with this space. Institutions struggle with:
0156.1. Securely moving assets between accounts and counterparties
0156.2. Effectively managing risk in volatile market conditions given slow and sometimes unpredictable transfer times
0156.3. Dealing with the operational burden onboarding to multiple venues and managing fragmented wallets

This matters because the AIDAC can achieve capital efficiency and further the one-stop-shop experience by providing scalable connectivity within its suite of products and all counterparties its customer interacts with.

AIDAC customers and internal teams use a mix of Fireblocks Network, Copper Clearloop and bespoke API connections to manage money transfers which still remains painful and slow. Consolidating these needs into a singular transfer network:
0158.1. Solves current pain points
0158.2. Unlocks valuable revenue streams like instant transfers, liquidation management (via instant borrows/deposits)
0158.3. Builds connectivity with crypto counterparties bringing AIDAC to parity with TradFi and above Crypto prime brokers

AIDAC, in one embodiment, has an opportunity (internal transfers tool) that can be leveraged to provide a solution Transfer Network. Transfer Network may act as the centralized platform to facilitate the communications (incoming and outgoing) between AIDAC, our customers and external venues with respect to cash flows and inventory movements.

### Baseline: Remove Existing Friction in Money Movement

Revenue opportunity: Of 218 active customers, only 45 (20%) use more than 1 product. There is a clear gap in revenue capture internally.

Feature 1: Transfers within products (exchange to exchange on Edge, collateral to equity wallet on Midas)
0161.1. Customer Benefit: Speed to access increased, unlocks exchange arbitrage strategies, trade volume to funds on exchange ratio increases, capital efficiency
0161.2. AIDAC Benefit: More revenue on existing AUM and increased stickiness

Feature 2: Transfers between products (e.g. Aggregated Liquidity to Edge)
0162.1. Customer Benefit: Capital efficiency
0162.2. AIDAC Benefit: Same products, higher usage, partiality to AIDAC products

### Engineering:

0163.1. It provides a complete and automated transfer mechanisms between
   0163.1.1. Equity Wallet (RFQ/RFS), Fusion, Exchanges, Staking, Collateral
0163.2. Tracking and documentation on Books and Records and Treasury

### Be the Crypto Transfer Network: Bridge Current Gaps in Money Management and Simplify Access to Growingly Complex Clients

Feature 1: AIDAC Acts as Prime Broker for Settlement and Transactions with Other Brokers

Customer Benefit: Manage all crypto transactions through AIDAC, at parity with traditional prime brokers

AIDAC Benefit: Data on all customer transactions and key insights on product performance+optimization.

### Direct Revenue Opportunity:

| | |
|---|---|
| YTD Trading Volume (bn) | $35 |
| Monthly Growth Assumption | 30% |
| Transfer Pricing (Bitgo current price) | $0.0001 |
| Competitor Flow Capture as a % of AIDAC trading | 40% |
| volume Assumption | |
| Total Revenue | $6,757,532.60 |

Feature 2: Money management network—allow customers to interact with each other. Customers can access anyone KYC'ed with AIDAC. This may be compatible to Clearloop by Copper and Fireblocks Network.

Customer Benefit: Crypto payment barriers dropped, no KYC, no whitelisting

AIDAC Benefit: Monetization of network effects

### Revenue Opportunity:

| | |
|---|---|
| SEN Quarterly Volume/Customer | $0.16 |
| Signet Quarterly Volume/Customer | $0.21 |
| AIDAC Active Customer/Quarter | 217 |
| AIDAC Transfer Volume | $40.15 |
| AIDAC Quarterly Revenue Opportunity | $4,014,500.00 |

### Unlock High Value Features Reliant on a Strong Transfer Platform

Feature 1: Instant lending, (the AIDAC needs the right currency in the right place at the right time to facilitate this)

Feature 2: Liquidation management on Exchange

Feature 3: Instant deposit availability

Feature 4: Support multi-asset manager persona when accessing AIDAC products
0175.1. Integration with books and records allowing for granular permissioning, and complex client structures

### Unlock Scalability at AIDAC

Benefit 1: Programmatic treasury management

Benefit 2: Reduce operational burden and manual processes allowing for higher throughput of customer requests.

Benefit 3: Rich data on customer behavior and needs

### Additional Comments:

This layer includes services that bundle all integrations into a convenient coordination layer, including:

Holds and exposes to other internal services the source of truth for transfer provides corridors (exchanges, LPs, banks)

Provides Product to plan, control and execute transfers safely and compliantly

Holds the workflows that provides whitelisting of addresses in the network

Originate, schedule and submit transfers between AIDAC and external parties

Ingesting, reading and interpretation of data from external parties that provides a suite of repeating experiences

Fundamentally, Transfer Network acts as a mechanism for the connectivity network for the AIDAC ecosystem at the surface allowing customers to move with ease, at the mid-level allow AIDAC for treasury management, and the low level powering transaction functionality across all nodes.

### Roadmap

Transfer funds between all wallets associated with Edge, RFQ/RFS, Aggregated Liquidity with limited or no manual intervention

Exchange to exchange transfer functionality (spill over for Q2)

Fireblocks wallets to exchange transfers

Support Instant Borrows and efficient treasury management

| | | TO | | |
|---|---|---|---|---|
| | | EDGE | RFQ/RFS | Agg Liq |
| FROM | EDGE | Onchain: WG, BR, T | WG, T, BR | WG, T, BR |
| | | Off-chain/Instant: | | |
| | | T, BR | | |
| | RFQ/RFS | WG, T, BR | BR | BR, T |
| | Agg Liq | WG, T, BR | BR, T | BR |

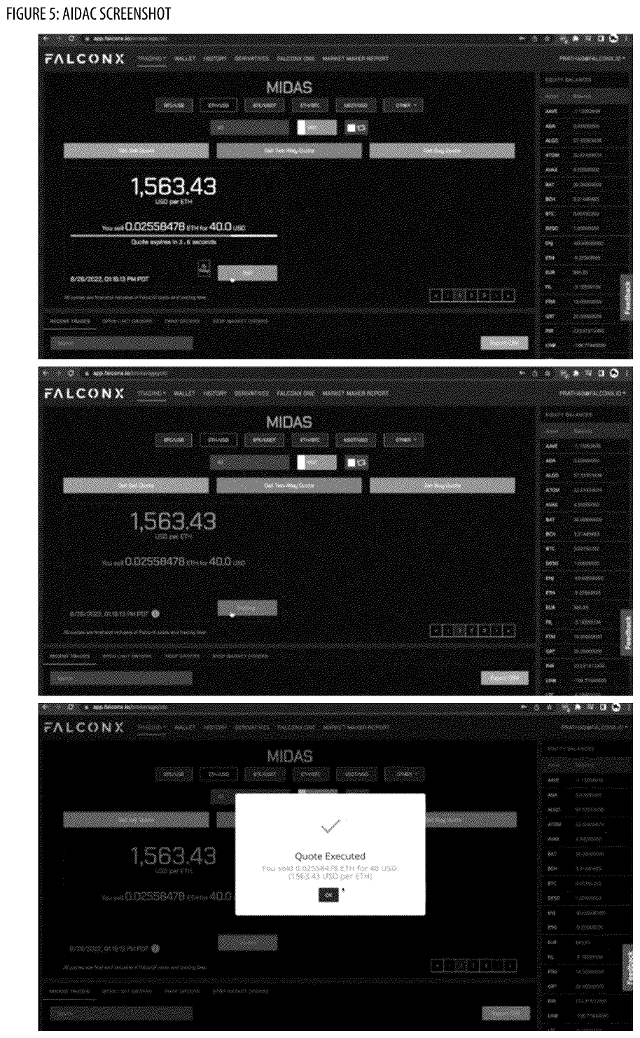

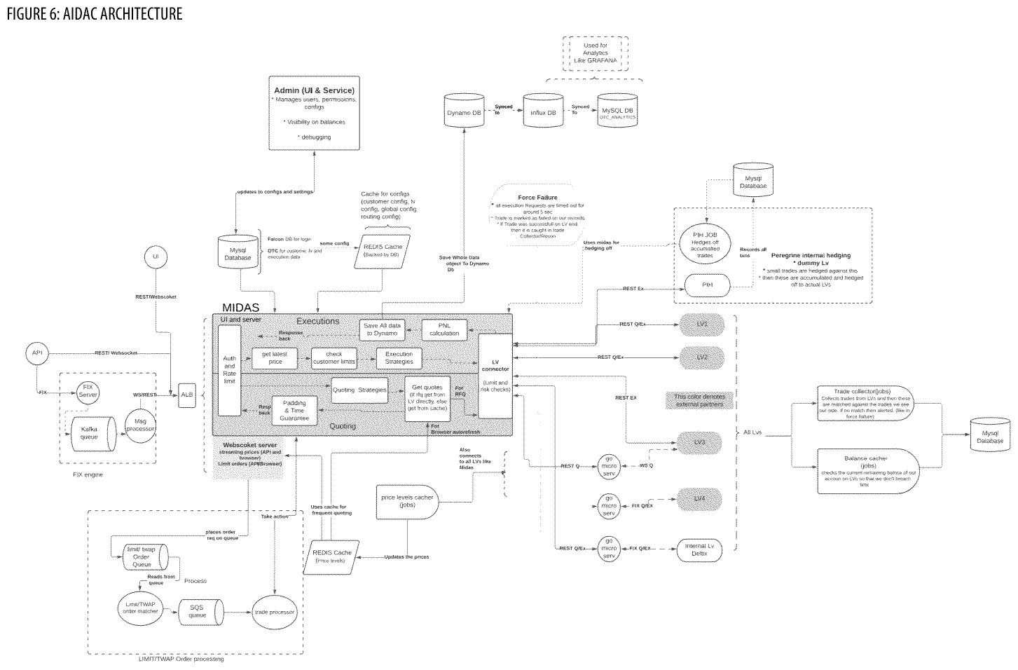

FIG. 6 shows non-limiting, example embodiments of an architecture for the AIDAC. In FIG. 6, an embodiment of how various components may be utilized to facilitate AIDAC operation is illustrated. A liquidity venue (LV) connector component may be utilized to obtain quotes from various liquidity venues (e.g., LV1-LV4) using a variety of protocol layers (e.g., REST, web sockets, FIX). In one implementation, the LV connector may convert price data from various LVs to a common format. A user may utilize a UI or an API (e.g., REST, web sockets, FIX) to submit a request (e.g., an RFQ request). In one implementation, the request may be handled by an application load balancer (ALB), and the user may be authenticated and/or rate limited (e.g., to prevent overuse of system resources). In one embodiment, a quoting component may utilize quoting strategies rules and/or the quotes data to determine price padding and/or time guarantee to use for a quote that is provided to the user. In some implementations, a cache (e.g., a REDIS cache) may be used for frequent quoting. In some implementations, limit orders and/or TWAP orders may be processed (e.g., in a periodic fashion via a queue). In one embodiment, an executions component may be utilized to execute orders placed by the user. In some implementations, executions data may be synchronized to a database (e.g., Dynamo DB) and/or utilized for analytics. In some implementations, an admin UI and/or service may be utilized to configure the AIDAC. For example, an LV, a market, a market for an LV, and/or the like may be turned on or off. In another example, a routing configuration for orders of various sizes among various LVs may be specified. In some implementations, an internal hedging module may be utilized to collect small size trades until a threshold quantity is reached, at which point an order may be placed with an LV.

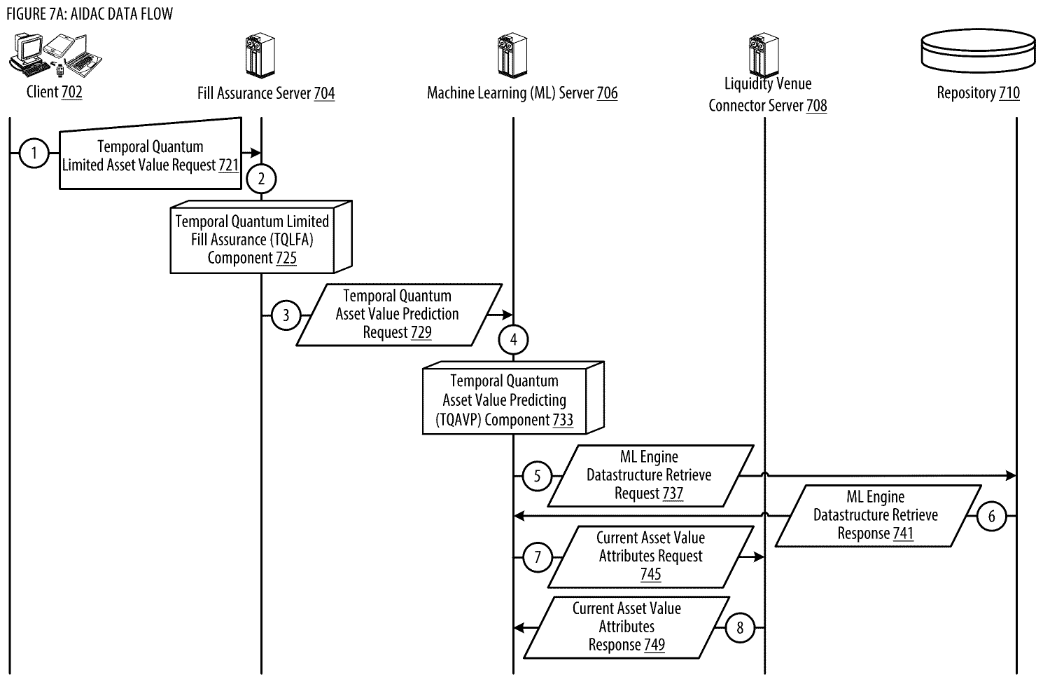

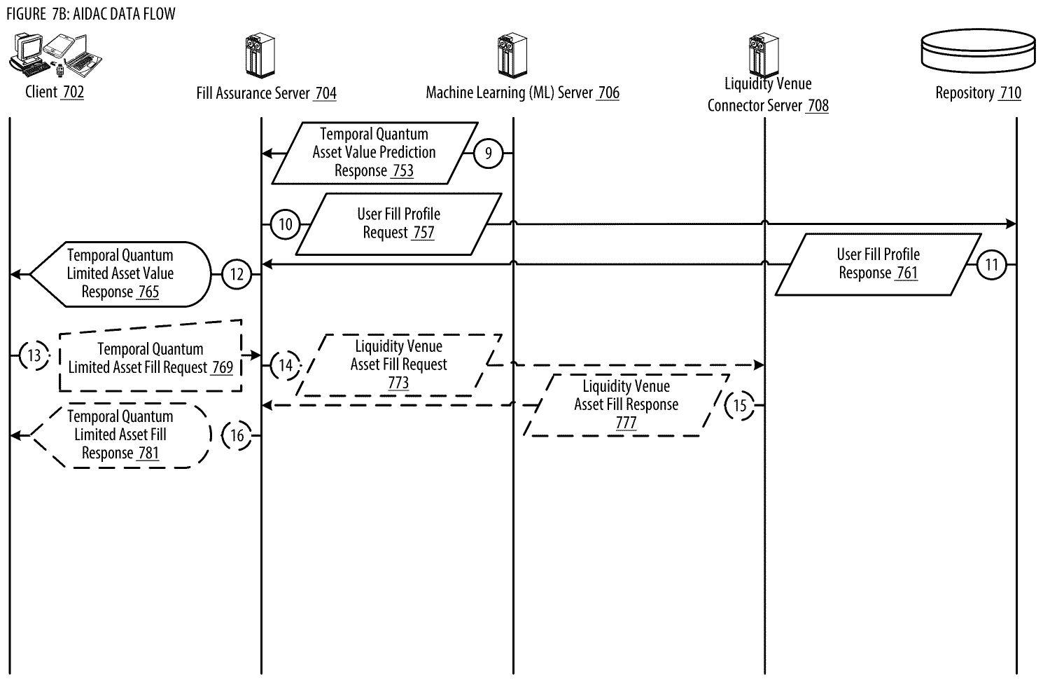

FIGS. 7A-B show non-limiting, example embodiments of a datagraph illustrating data flow(s) for the AIDAC. In FIGS. 7A-B, dashed lines indicate data flow elements that may be more likely to be optional. In FIGS. 7A-B, a client 702 (e.g., of a user) may send a temporal quantum limited asset value request 721 to a fill assurance server 704 to facilitate obtaining a temporal quantum limited asset value (e.g., a quote for buying and/or selling 0.001 Ethereum for US dollars (e.g., that is valid for a limited duration, such as 3.7 seconds)). For example, the client may be a desktop, a laptop, a tablet, a smartphone, a smartwatch, and/or the like that is executing a client application. In one implementation, the temporal quantum limited asset value request may include data such as a request identifier, a user identifier, asset parameters, a primary asset quantity, an order type, and/or the like. In one embodiment, the client may provide the following example temporal quantum limited asset value request, substantially in the form of a (Secure) Hypertext Transfer Protocol (“HTTP(S)”) POST message including eXtensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
      <user_account_credentials>
        <user_name>JohnDaDoeDoeDoooe@gmail.com</user_name>
        <password>abc123</password>
        //OPTIONAL <cookie>cookieID</cookie>
        //OPTIONAL <digital_cert_link>www.mydigitalcertificate.com/
JohnDoeDaDoeDoe@gmail.com/mycertifcate.dc</digital_cert_link>
        //OPTIONAL <digital_certificate>_DATA_</digital_certificate>
      </user_account_credentials>
  </user_accounts_details>
  <client_details> //iOS Client with App and Webkit
        //it should be noted that although several client details
        //sections are provided to show example variants of client
        //sources, further messages may include only one to save
        //space
      <client_IP>10.0.0.123</client_IP>
      <user_agent_string>Mozilla/5.0 (iPhone; CPU iPhone OS 7_1_1 like Mac OS
X) AppleWebKit/537.51.2 (KHTML, like Gecko) Version/7.0 Mobile/11D201
Safari/9537.53</user_agent_string>
      <client_product_type>iPhone6,1</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>app with webkit</client_app_type>
      <app_installed_flag>true</app_installed_flag>
      <app_name>AIDAC.app</app_name>
      <app_version>1.0 </app_version>
      <app_webkit_name>Mobile Safari</client_webkit_name>
      <client_version>537.51.2</client_version>
  </client_details>
  <client_details> //iOS Client with Webbrowser
      <client_IP>10.0.0.123</client_IP>
      <user_agent_string>Mozilla/5.0 (iPhone; CPU iPhone OS 7_1_1 like Mac OS
X) AppleWebKit/537.51.2 (KHTML, like Gecko) Version/7.0 Mobile/11D201
Safari/9537.53</user_agent_string>
      <client_product_type>iPhone6,1</client_product_type>
      <client_serial_number>DNXXX1X1XXXX</client_serial_number>
      <client_UDID>3XXXXXXXXXXXXXXXXXXXXXXXXXXD</client_UDID>
      <client_OS>iOS</client_OS>
      <client_OS_version>7.1.1</client_OS_version>
      <client_app_type>web browser</client_app_type>
      <client_name>Mobile Safari</client_name>
      <client_version>9537.53</client_version>
  </client_details>
  <client_details> //Android Client with Webbrowser
      <client_IP>10.0.0.123</client_IP>
      <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
      <client_product_type>Nexus S</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Android</client_OS>
      <client_OS_version>4.0.4</client_OS_version>
      <client_app_type>web browser</client_app_type>
      <client_name>Mobile Safari</client_name>
      <client_version>534.30</client_version>
  </client_details>
  <client_details> //Mac Desktop with Webbrowser
      <client_IP>10.0.0.123</client_IP>
      <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
      <client_product_type>MacPro5,1</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Mac OS X</client_OS>
      <client_OS_version>10.9.3</client_OS_version>
      <client_app_type>web browser</client_app_type>
      <client_name>Mobile Safari</client_name>
      <client_version>537.75.14</client_version>
  </client_details>
  <temporal_quantum_limited_asset_value_request>
    <request_identifier>ID_request_1</request_identifier>
    <user_identifier>ID_user_1</user_identifier>
    <asset_parameters>
      <asset_primary>ETH</asset_primary>
      <asset_secondary>USD</asset_secondary>
    </asset_parameters>
    <asset_primary_quantity>0.001</asset_primary_quantity>
    <order_type>TYPE_MARKET</order_type>
  </temporal_quantum_limited_asset_value_request>
</auth_request>
```

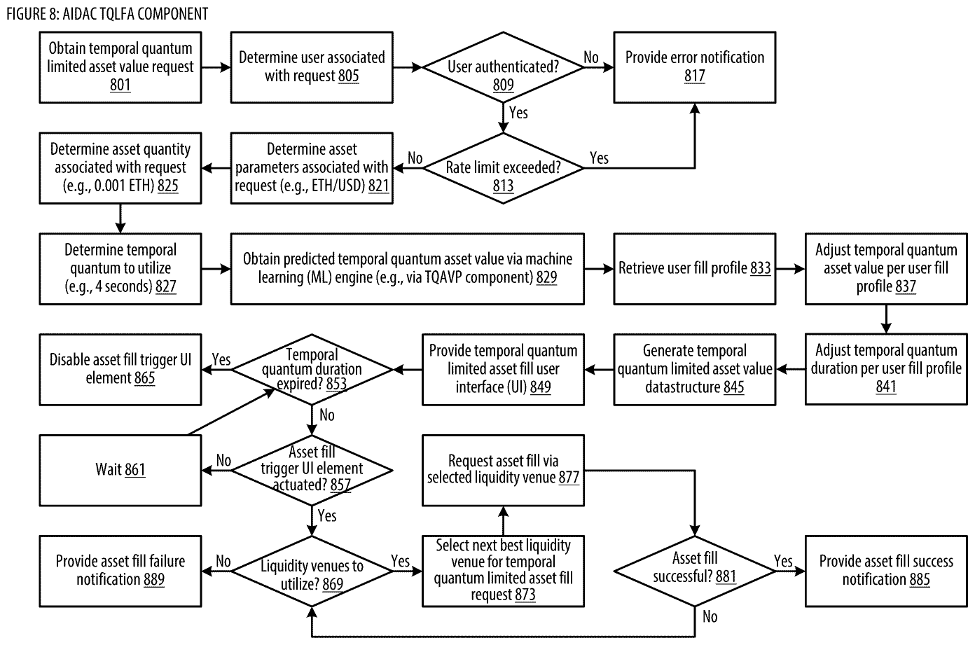

A temporal quantum limited fill assurance (TQLFA) component 725 may utilize data provided in the temporal quantum limited asset value request to provide a temporal quantum limited asset value and/or to facilitate asset fill transaction execution. See FIG. 8 for additional details regarding the TQLFA component.

The fill assurance server 704 may send a temporal quantum asset value prediction request 729 to a machine learning (ML) server 706 to facilitate determining a predicted temporal quantum asset value. In one implementation, the temporal quantum asset value prediction request may include data such as a request identifier, asset parameters, a primary asset quantity, a temporal quantum, and/or the like. In one embodiment, the fill assurance server may provide the following example temporal quantum asset value prediction request, substantially in the form of a HTTP(S) POST message including XML-formatted data, as provided below:

```
POST /temporal_quantum_asset_value_prediction_request.php HTTP/1.1
Host: www.server.com
Content-Type: Application/XML
Content-Length: 667
<?XML version = “1.0” encoding = “UTF-8”?>
<temporal_quantum_asset_value_prediction_request>
  <request_identifier>ID_request_2</request_identifier>
  <asset_parameters>
    <asset_primary>ETH</asset_primary>
    <asset_secondary>USD</asset_secondary>
  </asset_parameters>
  <asset_primary_quantity>0.001</asset_primary_quantity>
  <temporal_quantum>4 seconds</temporal_quantum>
</temporal_quantum_asset_value_prediction_request>
```

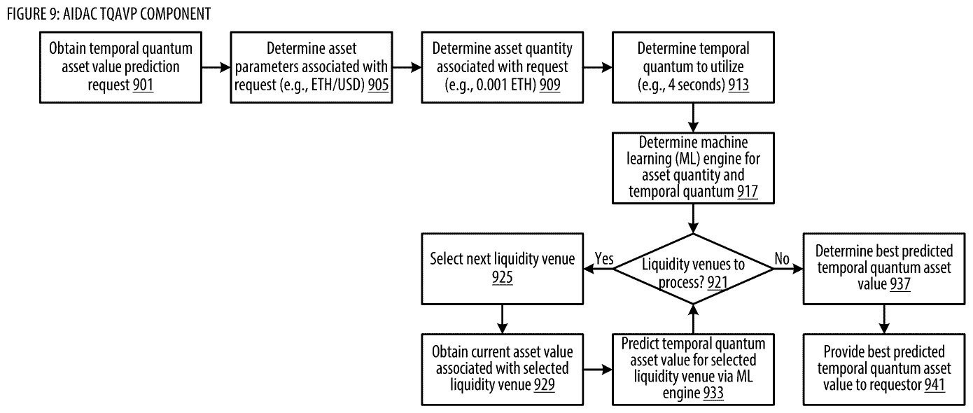

A temporal quantum asset value predicting (TQAVP) component 733 may utilize data provided in the temporal quantum asset value prediction request to determine a predicted temporal quantum asset value via an ML engine. See FIG. 9 for additional details regarding the TQAVP component.

The ML server 706 may send an ML engine datastructure retrieve request 737 to a repository 710 to retrieve an ML engine corresponding to specified temporal quantum asset value prediction request parameters. In one implementation, the ML engine datastructure retrieve request may include data such as a request identifier, an ML engine identifier, and/or the like. In one embodiment, the ML server may provide the following example ML engine datastructure retrieve request, substantially in the form of a HTTP(S) POST message including XML-formatted data, as provided below:

```
POST /ML_engine_datastructure_retrieve_request.php HTTP/1.1
Host: www.server.com
Content-Type: Application/XML
Content-Length: 667
<?XML version = “1.0” encoding = “UTF-8”?>
<ML_engine_datastructure_retrieve_request>
  <request_identifier>ID_request_3</request_identifier>
  <ML_engine_identifier>ID_ML_Engine_1</ML_engine_identifier>
</ML_engine_datastructure_retrieve_request>
```

The repository 710 may send an ML engine datastructure retrieve response 741 to the ML server 706 with an ML engine datastructure corresponding to the requested ML engine. In one implementation, the ML engine datastructure retrieve response may include data such as a response identifier, the ML engine datastructure, and/or the like. In one embodiment, the repository may provide the following example ML engine datastructure retrieve response, substantially in the form of a HTTP(S) POST message including XML-formatted data, as provided below:

```
POST /ML_engine_datastructure_retrieve_response.php HTTP/1.1
Host: www.server.com
Content-Type: Application/XML
Content-Length: 667
<?XML version = “1.0” encoding = “UTF-8”?>
<ML_engine_datastructure_retrieve_response>
  <response_identifier>ID_response_3</response_identifier>
  <ML_engine_datastructure>ML prediction logic data
structure</ML_engine_datastructure>
</ML_engine_datastructure_retrieve_response>
```

The ML server 706 may send a current asset value attributes request 745 to a liquidity venue connector server 708 to obtain current asset value attributes corresponding to specified temporal quantum asset value prediction request parameters for an LV. It is to be understood that, in various implementations, one current asset value attributes request may be sent to obtain current asset value attributes for available LVs, a separate current asset value attributes request may be sent to obtain current asset value attributes for each available LV, and/or the like. In one implementation, the current asset value attributes request may include data such as a request identifier, an LV identifier, asset parameters, a primary asset quantity, and/or the like. In one embodiment, the ML server may provide the following example current asset value attributes request, substantially in the form of a HTTP(S) POST message including XML-formatted data, as provided below:

```
POST /current_asset_value_attributes_request.php HTTP/1.1
Host: www.server.com
Content-Type: Application/XML
Content-Length: 667
<?XML version = “1.0” encoding = “UTF-8”?>
<current_asset_value_attributes_request>
  <request_identifier>ID_request_4</request_identifier>
  <LV_identifier>ID_liquidity_venue_1</LV_identifier>
  <asset_parameters>
    <asset_primary>ETH</asset_primary>
    <asset_secondary>USD</asset_secondary>
  </asset_parameters>
  <asset_primary_quantity>0.001</asset_primary_quantity>
</current_asset_value_attributes_request>
```

The liquidity venue connector server 708 may send a current asset value attributes response 749 to the ML server 706 with the requested current asset value attributes data for the LV. In one implementation, the current asset value attributes response may include data such as a response identifier, the requested current asset value attributes data (e.g., current asset value for the LV), and/or the like. In one embodiment, the liquidity venue connector server may provide the following example current asset value attributes response, substantially in the form of a HTTP(S) POST message including XML-formatted data, as provided below:

```
POST /current_asset_value_attributes_response.php HTTP/1.1
Host: www.server.com
Content-Type: Application/XML
Content-Length: 667
<?XML version = “1.0” encoding = “UTF-8”?>
<current_asset_value_attributes_response>
  <response_identifier>ID_response_4</response_identifier>
  <LV_identifier>ID_liquidity_venue_1</LV_identifier>
  <current_asset_value_buy>2962.55 (e.g., USD per
ETH)</current_asset_value_buy>
  <current_asset_value_sell>2961.92 (e.g., USD per
ETH)</current_asset_value_sell>
</current_asset_value_attributes_response>
```

The ML server 706 may send a temporal quantum asset value prediction response 753 to the fill assurance server 704 with the predicted temporal quantum asset value data. In one implementation, the temporal quantum asset value prediction response may include data such as a response identifier, the predicted temporal quantum asset value data (e.g., best predicted asset value in 4 seconds), liquidity venue data, and/or the like. In one embodiment, the ML server may provide the following example temporal quantum asset value prediction response, substantially in the form of a HTTP(S) POST message including XML-formatted data, as provided below:

```
POST /temporal_quantum_asset_value_prediction_response.php HTTP/1.1
Host: www.server.com
Content-Type: Application/XML
Content-Length: 667
<?XML version = “1.0” encoding = “UTF-8”?>
<temporal_quantum_asset_value_prediction_response>
  <response_identifier>ID_response_2</response_identifier>
  <best_LV_identifier>ID_liquidity_venue_1</best_LV_identifier>
  <predicted_asset_value_buy>2962.52 (e.g., USD per
ETH)</predicted_asset_value_buy>
  <predicted_asset_value_sell>2961.89 (e.g., USD per
ETH)</predicted_asset_value_sell>
  <temporal_quantum>4 seconds</temporal_quantum>
</temporal_quantum_asset_value_prediction_response>
```

The fill assurance server 704 may send a user fill profile request 757 to the repository 710 to obtain a user fill profile associated with the user. In one implementation, the user fill profile request may include data such as a request identifier, a user identifier, and/or the like. In one embodiment, the fill assurance server may provide the following example user fill profile request, substantially in the form of a HTTP(S) POST message including XML-formatted data, as provided below:

```
POST /user_fill_profile_request.php HTTP/1.1
Host: www.server.com
Content-Type: Application/XML
Content-Length: 667
<?XML version = “1.0” encoding = “UTF-8”?>
<user_fill_profile_request>
  <request_identifier>ID_request_5</request_identifier>
  <user_identifier>ID_user_1</user_identifier>
</user_fill_profile_request>
```

The repository 710 may send a user fill profile response 761 to the fill assurance server 704 with the requested user fill profile data. In one implementation, the user fill profile response may include data such as a response identifier, the requested user fill profile data, and/or the like. In one embodiment, the repository may provide the following example user fill profile response, substantially in the form of a HTTP(S) POST message including XML-formatted data, as provided below:

```
POST /user_fill_profile_response.php HTTP/1.1
Host: www.server.com
Content-Type: Application/XML
Content-Length: 667
<?XML version = “1.0” encoding = “UTF-8”?>
<user_fill_profile_response>
  <response_identifier>ID_response_5</response_identifier>
  <user_fill_profile>
    <price_sensitivity>LOW</price_sensitivity>
    <order_fill_rate_sensitivity>HIGH</order_fill_rate_sensitivity>
    <frequency_of_use>MEDIUM</frequency_of_use>
  </user_fill_profile>
</user_fill_profile_response>
```

The fill assurance server 704 may send a temporal quantum limited asset value response 765 to the client 702 to provide a temporal quantum limited asset value. In one implementation, the temporal quantum limited asset value response may include data such as a response identifier, the temporal quantum limited asset value data (e.g., a quote comprising the (adjusted) best predicted asset value valid for the (adjusted) temporal quantum duration), and/or the like. In one embodiment, the fill assurance server may provide the following example temporal quantum limited asset value response, substantially in the form of a HTTP(S) POST message including XML-formatted data, as provided below:

```
POST /temporal_quantum_limited_asset_value_response.php HTTP/1.1
Host: www.server.com
Content-Type: Application/XML
Content-Length: 667
<?XML version = “1.0” encoding = “UTF-8”?>
<temporal_quantum_limited_asset_value_response>
  <response_identifier>ID_response_1</response_identifier>
  <temporal_quantum_limited_asset_value_datastructure>
    <adjusted_asset_value_buy>2962.58 (e.g., USD per
ETH)</adjusted_asset_value_buy>
    <adjusted_asset_value_sell>2961.83 (e.g., USD per
ETH)</adjusted_asset_value_sell>
    <temporal_quantum>3.7 seconds</temporal_quantum>
  </temporal_quantum_limited_asset_value_datastructure>
</temporal_quantum_limited_asset_value_response>
```

The client 702 may send a temporal quantum limited asset fill request 769 to the fill assurance server 704 to request execution of an asset fill transaction at the provided temporal quantum limited asset value. In one implementation, the temporal quantum limited asset fill request may include data such as a request identifier, asset fill transaction data, and/or the like. In one embodiment, the client may provide the following example temporal quantum limited asset fill request, substantially in the form of a HTTP(S) POST message including XML-formatted data, as provided below:

```
POST /temporal_quantum_limited_asset_fill_request.php HTTP/1.1
Host: www.server.com
Content-Type: Application/XML
Content-Length: 667
<?XML version = “1.0” encoding = “UTF-8”?>
<temporal_quantum_limited_asset_fill_request>
  <request_identifier>ID_request_6</request_identifier>
  <user_identifier>ID_user_1</user_identifier>
  <asset_parameters>
    <asset_primary>ETH</asset_primary>
    <asset_secondary>USD</asset_secondary>
  </asset_parameters>
  <asset_primary_quantity>0.001</asset_primary_quantity>
  <asset_value>2962.58 (e.g., USD per ETH)</asset_value>
  <transaction_side>SIDE_BUY</transaction_side>
</temporal_quantum_limited_asset_fill_request>
```

The fill assurance server 704 may send a liquidity venue asset fill request 773 to the liquidity venue connector server 708 to facilitate execution of the asset fill transaction. It is to be understood that, in some implementations, the liquidity venue asset fill request may be sent directly to an LV instead. In one implementation, the liquidity venue asset fill request may include data such as a request identifier, asset fill transaction data, and/or the like. In one embodiment, the fill assurance server may provide the following example liquidity venue asset fill request, substantially in the form of a HTTP(S) POST message including XML-formatted data, as provided below:

```
POST /liquidity_venue_asset_fill_request.php HTTP/1.1
Host: www.server.com
Content-Type: Application/XML
Content-Length: 667
<?XML version = “1.0” encoding = “UTF-8”?>
<liquidity_venue_asset_fill_request>
  <request_identifier>ID_request_7</request_identifier>
  <user_identifier>ID_user_1</user_identifier>
  <asset_parameters>
    <asset_primary>ETH</asset_primary>
    <asset_secondary>USD</asset_secondary>
  </asset_parameters>
  <asset_primary_quantity>0.001</asset_primary_quantity>
  <asset_value>2962.58 (e.g., USD per ETH)</asset_value>
  <transaction_side>SIDE_BUY</transaction_side>
</liquidity_venue_asset_fill_request>
```

The liquidity venue connector server 708 may send a liquidity venue asset fill response 777 to the fill assurance server 704 to inform the fill assurance server whether the asset fill transaction was executed successfully by an LV. In one implementation, the liquidity venue asset fill response may include data such as a response identifier, a status, and/or the like. In one embodiment, the liquidity venue connector server may provide the following example liquidity venue asset fill response, substantially in the form of a HTTP(S) POST message including XML-formatted data, as provided below:

```
POST /liquidity_venue_asset_fill_response.php HTTP/1.1
Host: www.server.com
Content-Type: Application/XML
Content-Length: 667
<?XML version = “1.0” encoding = “UTF-8”?>
<liquidity_venue_asset_fill_response>
  <response_identifier>ID_response_7</response_identifier>
  <status>OK</status>
</liquidity_venue_asset_fill_response>
```

The fill assurance server 704 may send a temporal quantum limited asset fill response 781 to the client 702 to inform the user whether the asset fill transaction was executed successfully. In one implementation, the temporal quantum limited asset fill response may include data such as a response identifier, a status, and/or the like. In one embodiment, the fill assurance server may provide the following example temporal quantum limited asset fill response, substantially in the form of a HTTP(S) POST message including XML-formatted data, as provided below:

```
POST /temporal_quantum_limited_asset_fill_response.php HTTP/1.1
Host: www.server.com
Content-Type: Application/XML
Content-Length: 667
<?XML version = “1.0” encoding = “UTF-8”?>
<temporal_quantum_limited_asset_fill_response>
  <response_identifier>ID_response_6</response_identifier>
  <status>OK</status>
</temporal_quantum_limited_asset_fill_response>
```

FIG. 8 shows non-limiting, example embodiments of a logic flow illustrating a temporal quantum limited fill assurance (TQLFA) component for the AIDAC. In FIG. 8, a temporal quantum limited asset value request may be obtained at 801. For example, the temporal quantum limited asset value request may be obtained as a result of a request from a user to obtain a temporal quantum limited asset value (e.g., a quote for buying and/or selling 0.001 Ethereum for US dollars (e.g., that is valid for a limited duration, such as 3.7 seconds)).

A user associated with the temporal quantum limited asset value request may be determined at 805. For example, the user's user identifier may be determined. In one implementation, the temporal quantum limited asset value request may be parsed (e.g., using PUP commands) to identify the user (e.g., based on the value of the user_identifier field).

A determination may be made at 809 whether the user was authenticated successfully. For example, the user's identity and/or permissions (e.g., primary assets and/or secondary assets that the user is allowed to exchange, asset quantities that the user is allowed to exchange) may be verified as part of user authentication. If the user was not authenticated successfully, an error notification may be provided at 817. For example, the error notification may inform the user that the user was not authenticated successfully and that the user should retry entering the user's username and/or password.

If the user was authenticated successfully, a determination may be made at 813 whether a rate limit for the user was exceeded. For example, the number of requests that the user may make during a specified time period may be limited to prevent overuse of system resources. If the rate limit for the user was exceeded, an error notification may be provided at 817. For example, the error notification may inform the user that the rate limit for the user was exceeded and that the user should wait before making additional requests.

If the rate limit for the user was not exceeded, asset parameters associated with the temporal quantum limited asset value request may be determined at 821. In one embodiment, asset parameters may comprise a primary asset (e.g., an asset to buy (or sell)) and/or a secondary asset (e.g., an asset provided (or obtained) in return). For example, a primary asset (e.g., ETH) and/or a secondary asset (e.g., USD) may be specified. In another example, a market (e.g. ETH/USD) may be specified. In one implementation, the temporal quantum limited asset value request may be parsed (e.g., using PUP commands) to determine the asset parameters (e.g., based on the value of the asset_parameters field).

An asset quantity associated with the temporal quantum limited asset value request may be determined at 825. In one embodiment, the asset quantity may specify the amount of the primary asset (e.g., 0.001 ETH) to buy and/or sell. In one implementation, the temporal quantum limited asset value request may be parsed (e.g., using PUP commands) to determine the asset quantity (e.g., based on the value of the asset_primary_quantity field).

A temporal quantum to utilize may be determined at 827. In one embodiment, the temporal quantum may specify a duration for which to predict an asset value of the primary asset (e.g., an exchange rate in terms of the secondary asset). For example, the temporal quantum to utilize may be 4 seconds. In one implementation, the temporal quantum to utilize may be determined based on one or more of the following: identifiers of the primary asset and/or of the secondary asset (e.g., a longer temporal quantum may be utilized for major assets with high liquidity), the asset quantity (e.g., a longer temporal quantum may be utilized for smaller quantities), a current exchange rate volatility measure (e.g., a longer temporal quantum may be utilized during periods of low volatility), and/or the like. In another implementation, the temporal quantum to utilize may be fixed.

A predicted temporal quantum asset value may be determined via a machine learning (ML) engine at 829. In one embodiment, a best (e.g., among LVs) predicted asset value of the primary asset (e.g., an exchange rate in terms of the secondary asset) after the temporal quantum (e.g., after 4 seconds) may be determined. In one implementation, a TQAVP component may be utilized to determine a predicted temporal quantum asset value (e.g., via a temporal quantum asset value prediction request and/or a corresponding temporal quantum asset value prediction response). It is to be understood that, in some implementations, the predicted temporal quantum asset value may comprise a predicted temporal quantum asset value to buy and/or a predicted temporal quantum asset value to sell. For example, the TQAVP component may predict that the asset value of the primary asset (e.g., ETH) after 4 seconds will be 2962.52 (e.g., USD per ETH) to buy and 2961.89 (e.g., USD per ETH) to sell.

A user fill profile associated with the user may be retrieved at 833. In one embodiment, the user fill profile may specify the user's asset fill preferences (e.g., price sensitivity, order fill rate sensitivity, frequency of use, and/or the like). In one implementation, the user fill profile associated with the user may be retrieved based on the user's identifier from a repository. For example, the user fill profile may be retrieved via a MySQL database command similar to the following:
SELECT userPreferences
FROM Users
WHERE userID=ID_user_1;

The predicted temporal quantum asset value may be adjusted per the user fill profile at 837. For example, if the user is sensitive to order fill rate, the predicted temporal quantum asset value to buy may be increased (e.g., to 2962.58 (e.g., USD per ETH)) and/or the predicted temporal quantum asset value to sell may be decreased (e.g., to 2961.83 (e.g., USD per ETH)) to improve the chance that an asset fill request from the user would be executed successfully. In one implementation, an adjustment amount for the predicted temporal quantum asset value may be determined via a set of rules that specify an adjustment amount based on user fill profile parameters (e.g., if order fill rate sensitivity=HIGH, adjust (e.g., increase to buy and/or decrease to sell) the predicted temporal quantum asset value by 0.002%).

The duration of the temporal quantum may be adjusted per the user fill profile at 841. For example, if the user is sensitive to order fill rate, the duration of the temporal quantum may be decreased (e.g., to 3.7 seconds) to improve the chance that an asset fill request from the user would be executed successfully. In one implementation, an adjustment amount for the duration of the temporal quantum may be determined via a set of rules that specify an adjustment amount based on user fill profile parameters (e.g., if order fill rate sensitivity=HIGH, decrease the duration of the temporal quantum by 0.3 seconds).

A temporal quantum limited asset value datastructure may be generated at 845. In one embodiment, the temporal quantum limited asset value datastructure may be structured to specify configuration settings for a temporal quantum limited asset fill user interface. In one implementation, the temporal quantum limited asset value datastructure may be structured to specify the (adjusted) predicted temporal quantum asset value to buy, the (adjusted) predicted temporal quantum asset value to sell, the (adjusted) temporal quantum duration, and/or the like.

A temporal quantum limited asset fill user interface (UI) may be provided for the user via the user's client at 849. In one embodiment, the temporal quantum limited asset fill UI may be structured to facilitate obtaining a temporal quantum limited asset fill request (e.g., a buy request, a sell request) for the primary asset at the (adjusted) predicted temporal quantum asset value for the (adjusted) temporal quantum duration via an asset fill trigger UI element (e.g., a buy button, a sell button, and/or the like). See FIGS. 10-18 for examples of the temporal quantum limited asset fill UI.

A determination may be made at 853 whether the (adjusted) temporal quantum duration has expired. If the (adjusted) temporal quantum duration has expired, any asset fill trigger UI elements may be disabled at 865. For example, any buy buttons, sell buttons, execute buttons, and/or the like may be disabled.

If the (adjusted) temporal quantum duration has not expired, a determination may be made at 857 whether an asset fill trigger UI element was actuated. For example, a determination may be made whether the user clicked on any enabled buy buttons, sell buttons, execute buttons, and/or the like to request execution of an asset fill transaction at the (adjusted) predicted temporal quantum asset value, in which case a temporal quantum limited asset fill request may be generated.

If an asset fill trigger UI element was not actuated, the AIDAC may wait at 861. In one implementation, the AIDAC may wait a specified period of time (e.g., 0.01 seconds). In another implementation, the AIDAC may wait (e.g. nonblocking) until it is notified via an event that an asset fill trigger UI element was actuated.

If an asset fill trigger UI element was actuated (e.g., a temporal quantum limited asset fill request is obtained), a determination may be made at 869 whether there remain liquidity venues to utilize. In one implementation, each of the available liquidity venues (e.g., three best LVs) may be analyzed. If there remain liquidity venues to utilize, the next best liquidity venue for the temporal quantum limited asset fill request may be selected at 873. In one implementation, the next best liquidity venue for the temporal quantum limited asset fill request may be determined based on the predicted temporal quantum asset values for the available LVs. For example, LVs with better predicted temporal quantum asset values may be selected before LVs with worse predicted temporal quantum asset values. In another implementation, the next best liquidity venue for the temporal quantum limited asset fill request may be determined based on asset values for the available LVs at the time the temporal quantum limited asset fill request is received. For example, the available LVs may be queried to determine current asset values (e.g., quotes), and/or the LVs with better current asset values may be selected before LVs with worse current asset values.

An asset fill may be requested via the selected liquidity venue at 877. In one implementation, a liquidity venue asset fill request may be sent to the selected liquidity venue (e.g., directly, via a liquidity venue connector server, and/or the like). For example, the liquidity venue asset fill request may specify that the user wishes to execute a buy transaction for 0.001 ETH at the (adjusted) predicted temporal quantum asset value of 2962.58 (e.g., USD per ETH).

A determination may be made at 881 whether the asset fill requested via the selected liquidity venue was executed successfully. In one implementation, a liquidity venue asset fill response corresponding to the liquidity venue asset fill request may be parsed (e.g., using PUP commands) to determine whether the asset fill requested via the selected liquidity venue was executed successfully (e.g., based on the value of the status field).

If the asset fill requested via the selected liquidity venue was executed successfully, an asset fill success notification may be provided for the user (e.g., via the user's client) at 885. For example, the asset fill success notification may inform the user that the user's temporal quantum limited asset fill request was executed successfully.

If the asset fill requested via the selected liquidity venue was not executed successfully (e.g., due to price changes, unavailability), the next best liquidity venue for the temporal quantum limited asset fill request may be selected at 873 if available. If there do not remain liquidity venues to utilize, an asset fill failure notification may be provided for the user (e.g., via the user's client) at 889. For example, the asset fill failure notification may inform the user that the user's temporal quantum limited asset fill request was not executed successfully.

FIG. 9 shows non-limiting, example embodiments of a logic flow illustrating a temporal quantum asset value predicting (TQAVP) component for the AIDAC. In FIG. 9, a temporal quantum asset value prediction request may be obtained from a requestor at 901. For example, the temporal quantum asset value prediction request may be obtained as a result of a request from a TQLFA component to determine a predicted temporal quantum asset value.

Asset parameters associated with the temporal quantum asset value prediction request may be determined at 905. In one embodiment, asset parameters may comprise a primary asset (e.g., an asset to buy (or sell)) and/or a secondary asset (e.g., an asset provided (or obtained) in return). For example, a primary asset (e.g., ETH) and/or a secondary asset (e.g., USD) may be specified. In another example, a market (e.g. ETH/USD) may be specified. In one implementation, the temporal quantum asset value prediction request may be parsed (e.g., using PHP commands) to determine the asset parameters (e.g., based on the value of the asset_parameters field).

An asset quantity associated with the temporal quantum asset value prediction request may be determined at 909. In one embodiment, the asset quantity may specify the amount of the primary asset (e.g., 0.001 ETH) to buy and/or sell. In one implementation, the temporal quantum asset value prediction request may be parsed (e.g., using PHP commands) to determine the asset quantity (e.g., based on the value of the asset_primary_quantity field).

A temporal quantum to utilize may be determined at 913. In one embodiment, the temporal quantum may specify a duration (e.g., 4 seconds) for which to predict an asset value of the primary asset (e.g., an exchange rate in terms of the secondary asset). In one implementation, the temporal quantum asset value prediction request may be parsed (e.g., using PUP commands) to determine the temporal quantum to utilize (e.g., based on the value of the temporal_quantum field).

A machine learning (ML) engine to utilize to predict temporal quantum asset values for available liquidity venues may be determined at 917. In one embodiment, one ML, engine may be utilized to predict temporal quantum asset values. In various alternative embodiments, different ML engines may be utilized depending on one or more of: primary asset identifier, secondary asset identifier, asset quantity level, temporal quantum duration, liquidity venue identifier, transaction side (e.g., buy and/or sell), and/or the like. In one implementation, the ML engine to utilize to predict temporal quantum asset values for available liquidity venues may be retrieved via an ML engine datastructure retrieve request and/or a corresponding ML engine datastructure retrieve response. In another implementation, the ML engine to utilize to predict temporal quantum asset values for available liquidity venues may be previously loaded (e.g., at startup) and cached in memory.

A determination may be made at 921 whether there remain liquidity venues to process. In one implementation, each of the available liquidity venues (e.g., LVs that exchange the primary asset for the secondary asset) may be processed. If there remain liquidity venues to process, the next liquidity venue may be selected for processing at 925.

A current asset value of the primary asset associated with the selected liquidity venue may be obtained at 929. For example, a quote of an exchange rate of the primary asset in terms of the secondary asset for the asset quantity may be obtained from the selected liquidity venue (e.g., directly, via a liquidity venue connector server, via a cache, and/or the like). In one implementation, the current asset value of the primary asset associated with the selected liquidity venue may be obtained via a current asset value attributes request and/or a corresponding current asset value attributes response.

A temporal quantum asset value for the selected liquidity venue may be predicted via the ML engine at 933. In one embodiment, the ML engine may be structured to predict an asset value of the primary asset in terms of the secondary asset after the temporal quantum duration (e.g., in 4 seconds) for the asset quantity for the selected liquidity venue, and may be structured to take into account current market trends and/or historical market trends. In one implementation, the ML prediction logic datastructure (e.g., model) may be queried (e.g., via an API call) to determine the predicted temporal quantum asset value for the selected liquidity venue. For example, an identifier of the primary asset, an identifier of the secondary asset, the asset quantity, the temporal quantum duration, an identifier of the selected liquidity venue, a transaction side (e.g., buy and/or sell), and/or the like may be provided as components of an input vector, and a predicted temporal quantum asset value to buy for the selected liquidity venue, a predicted temporal quantum asset value to sell for the selected liquidity venue, and/or the like may be obtained as components of an output vector.

A best predicted temporal quantum asset value may be determined at 937. In one embodiment, the best predicted temporal quantum asset value may comprise a best predicted temporal quantum asset value to buy and/or a best predicted temporal quantum asset value to sell. In one implementation, the predicted temporal quantum asset values for different available liquidity venues may be compared (e.g., sorted) to determine the best predicted temporal quantum asset value (e.g., the lowest predicted temporal quantum asset value to buy and/or the highest predicted temporal quantum asset value to sell). It is to be understood that, in some embodiments, different components of the best predicted temporal quantum asset value may correspond to different liquidity venues (e.g., the best predicted temporal quantum asset value to buy may correspond to a first LV, while the best predicted temporal quantum asset value to sell may correspond to a second LV).

The best predicted temporal quantum asset value may be provided to the requestor at 941. In one embodiment, the best predicted temporal quantum asset value to buy and/or the best predicted temporal quantum asset value to sell may be provided. In some embodiments, liquidity venue data (e.g., LV associated with the best predicted temporal quantum asset value to buy, LV associated with the best predicted temporal quantum asset value to sell, list(s) of LVs sorted (e.g., from best to worst) with regard to predicted temporal quantum asset values) may also be provided. In one implementation, the best predicted temporal quantum asset value may be provided via a temporal quantum asset value prediction response.

FIG. 10 shows non-limiting, example embodiments of a screenshot illustrating user interface(s) of the AIDAC. In FIG. 10, an exemplary user interface (e.g., for a mobile device, for a website) for facilitating execution of a temporal quantum limited asset fill transaction is illustrated. Screen 1001 shows that a user may provide the user's email and password to authenticate the user's identity.

FIG. 11 shows non-limiting, example embodiments of a screenshot illustrating user interface(s) of the AIDAC. In FIG. 11, an exemplary user interface (e.g., for a mobile device, for a website) for facilitating execution of a temporal quantum limited asset fill transaction is illustrated. Screen 1101 shows that the user may utilize an asset selection widget 1105 to select an asset (e.g., a market). For example, the user may select the ETH/USD asset.

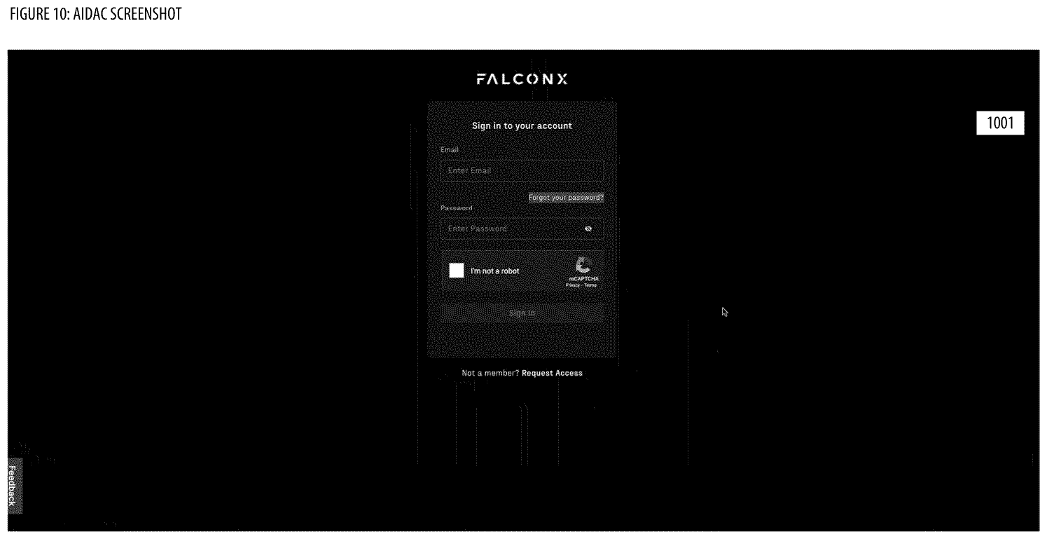

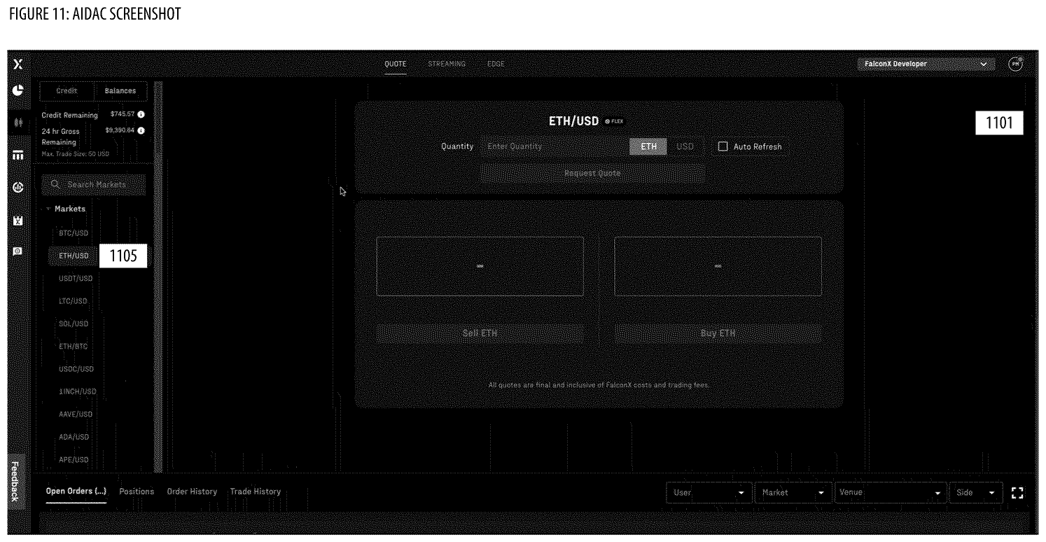

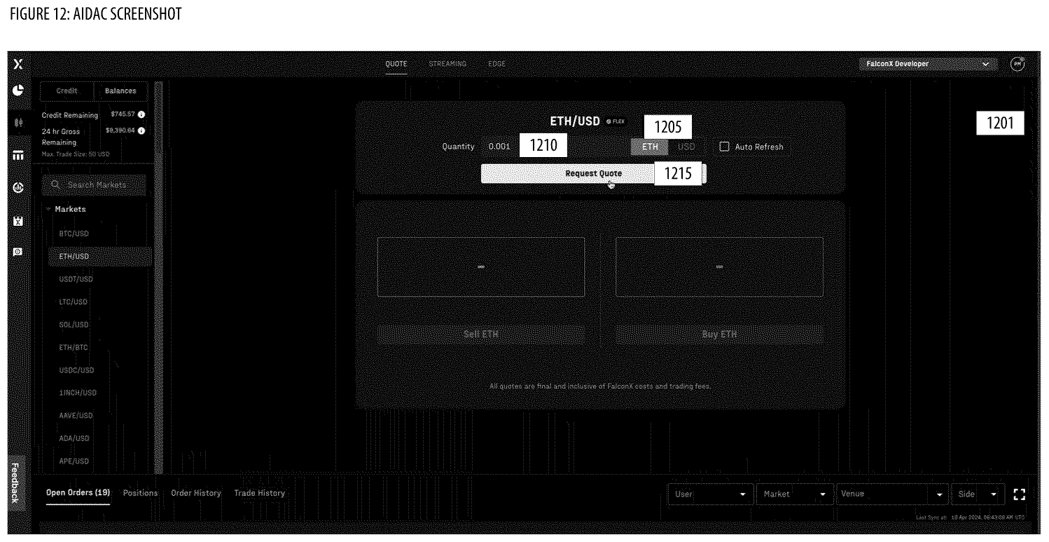

FIG. 12 shows non-limiting, example embodiments of a screenshot illustrating user interface(s) of the AIDAC. In FIG. 12, an exemplary user interface (e.g., for a mobile device, for a website) for facilitating execution of a temporal quantum limited asset fill transaction is illustrated. Screen 1201 shows that the user may utilize a primary asset selection widget 1205 to specify a primary asset (e.g., ETH) and/or a secondary asset (e.g., USD), a quantity selection widget 1210 to specify an asset quantity (e.g., 0.001) associated with the primary asset, and a request quote widget 1215 to facilitate sending a temporal quantum limited asset value request.

FIG. 13 shows non-limiting, example embodiments of a screenshot illustrating user interface(s) of the AIDAC. In FIG. 13, an exemplary user interface (e.g., for a mobile device, for a website) for facilitating execution of a temporal quantum limited asset fill transaction is illustrated. Screen 1301 shows that the user may utilize an asset value to sell widget 1305 to view a temporal quantum asset value to sell, an asset value to buy widget 1310 to view a temporal quantum asset value to buy, and a temporal quantum expiration widget 1315 (e.g., a temporal quantum duration progress bar retreating from right to left) to view the time until the temporal quantum asset value to sell and/or the temporal quantum asset value to buy expire (e.g., the time until quote expiration).

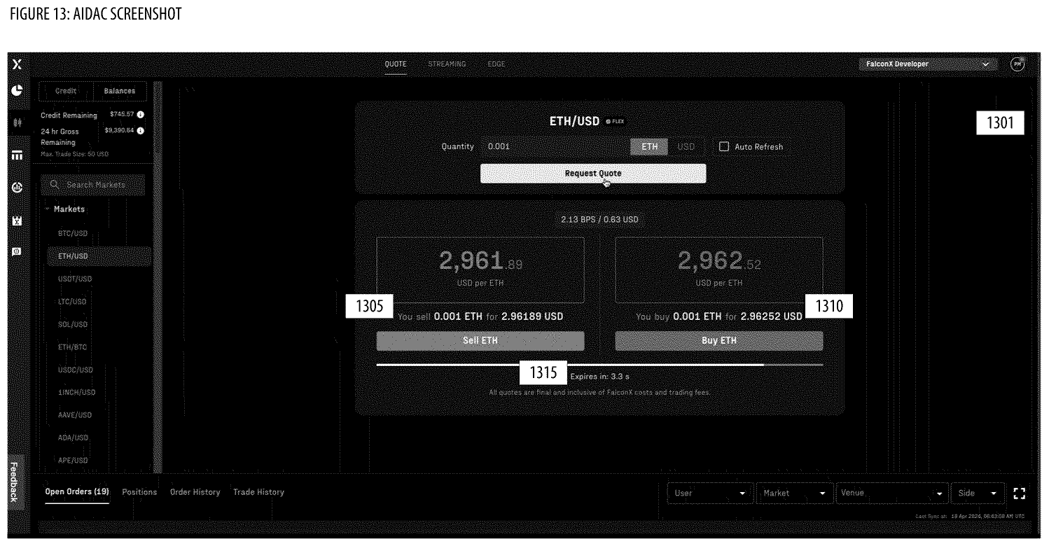

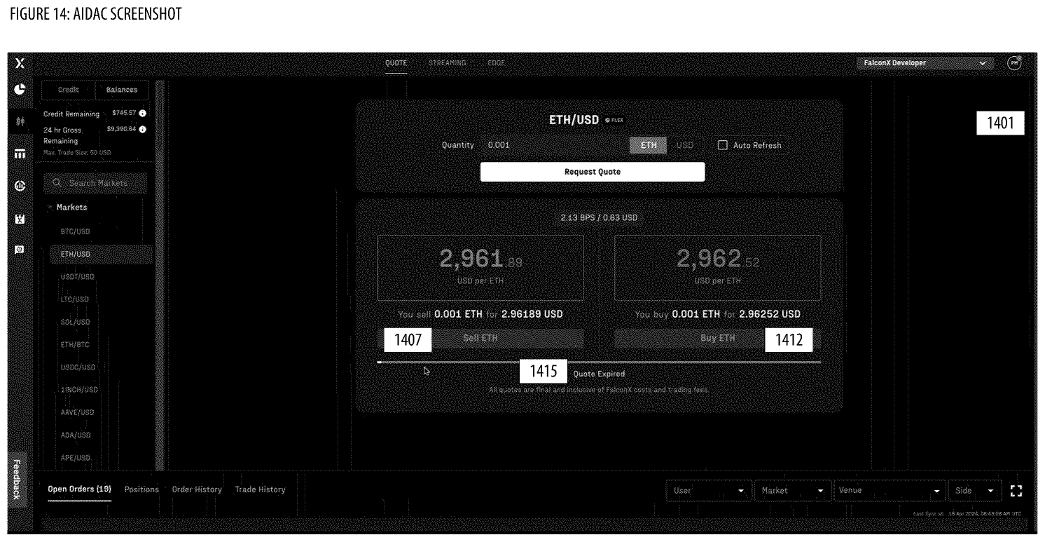

FIG. 14 shows non-limiting, example embodiments of a screenshot illustrating user interface(s) of the AIDAC. In FIG. 14, an exemplary user interface (e.g., for a mobile device, for a website) for facilitating execution of a temporal quantum limited asset fill transaction is illustrated. Screen 1401 shows that an asset fill sell trigger widget 1407 and an asset fill buy trigger widget 1412 are disabled once the temporal quantum duration expires as shown by the temporal quantum expiration widget 1415.

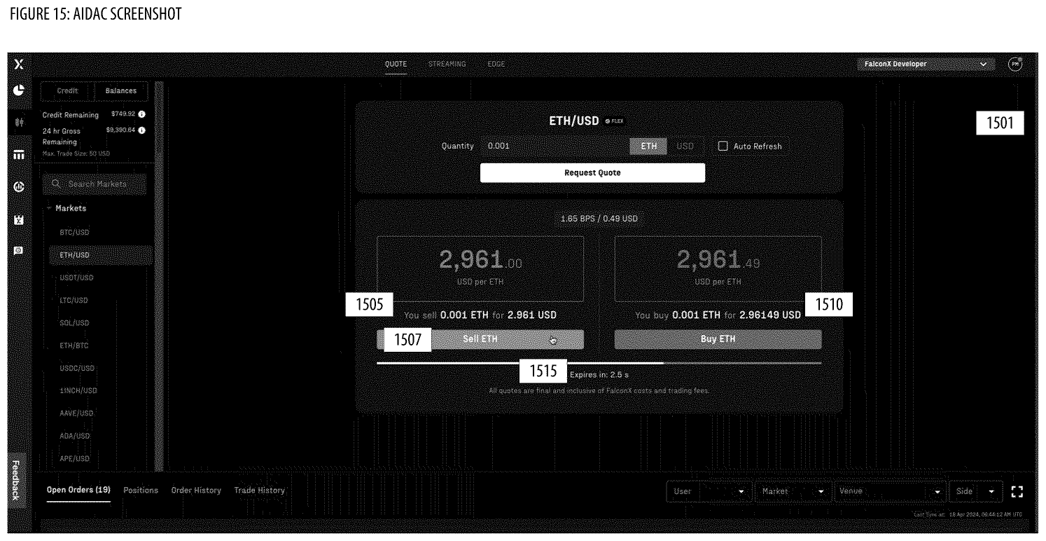

FIG. 15 shows non-limiting, example embodiments of a screenshot illustrating user interface(s) of the AIDAC. In FIG. 15, an exemplary user interface (e.g., for a mobile device, for a website) for facilitating execution of a temporal quantum limited asset fill transaction is illustrated. Screen 1501 shows that the user may utilize an asset value to sell widget 1505 to view an updated temporal quantum asset value to sell, an asset value to buy widget 1510 to view an updated temporal quantum asset value to buy, and may utilize an asset fill sell trigger widget 1507 to request execution of a temporal quantum limited asset fill transaction to sell the primary asset at the indicated updated temporal quantum asset value to sell since the temporal quantum duration did not expire yet as shown by the temporal quantum expiration widget 1515.

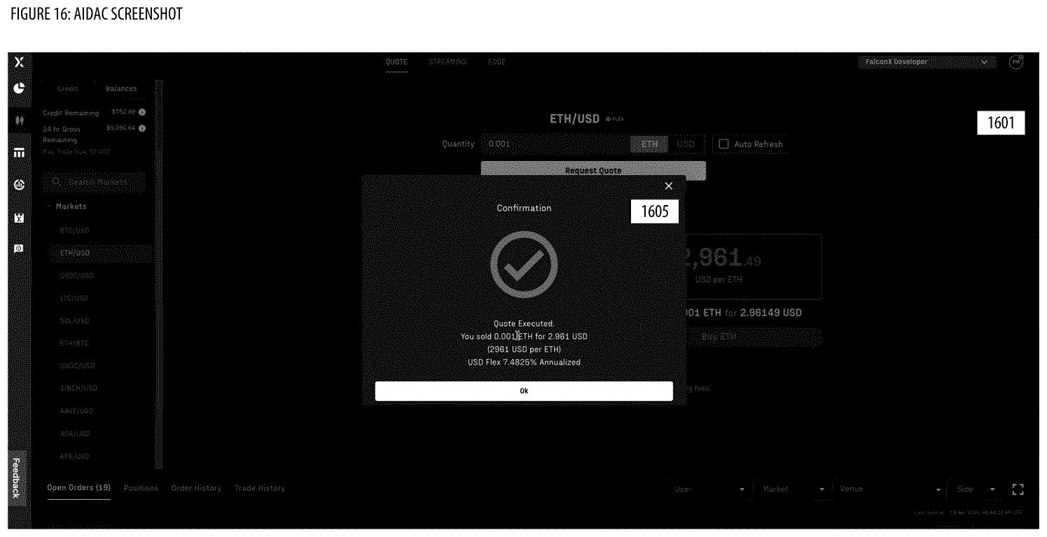

FIG. 16 shows non-limiting, example embodiments of a screenshot illustrating user interface(s) of the AIDAC. In FIG. 16, an exemplary user interface (e.g., for a mobile device, for a website) for facilitating execution of a temporal quantum limited asset fill transaction is illustrated. Screen 1601 shows an asset fill success notification widget 1605 that may be provided to the user to confirm execution of the temporal quantum limited asset fill transaction to sell the primary asset.

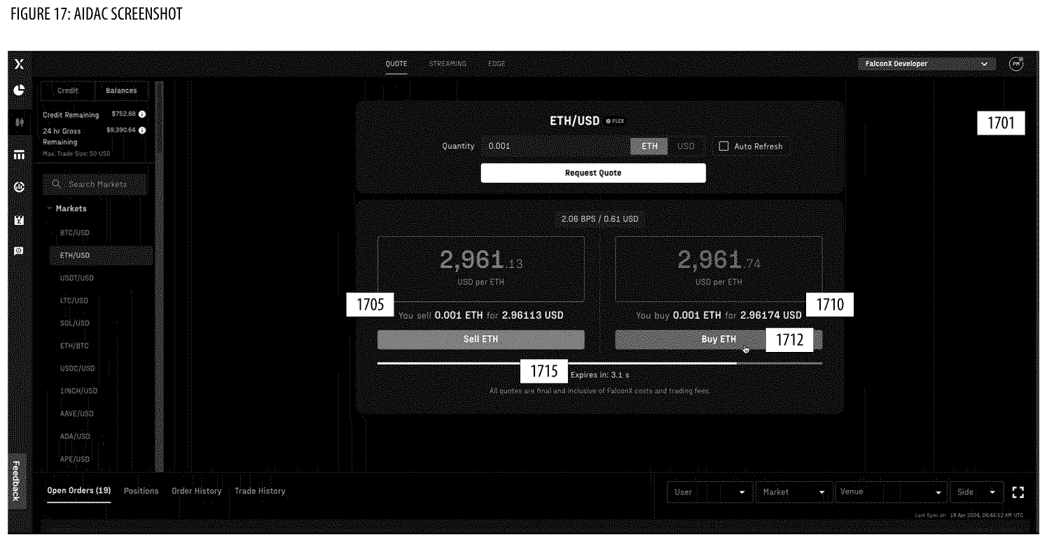

FIG. 17 shows non-limiting, example embodiments of a screenshot illustrating user interface(s) of the AIDAC. In FIG. 17, an exemplary user interface (e.g., for a mobile device, for a website) for facilitating execution of a temporal quantum limited asset fill transaction is illustrated. Screen 1701 shows that the user may utilize an asset value to sell widget 1705 to view another updated temporal quantum asset value to sell, an asset value to buy widget 1710 to view another updated temporal quantum asset value to buy, and may utilize an asset fill buy trigger widget 1712 to request execution of a temporal quantum limited asset fill transaction to buy the primary asset at the indicated updated temporal quantum asset value to buy since the temporal quantum duration did not expire yet as shown by the temporal quantum expiration widget 1715.

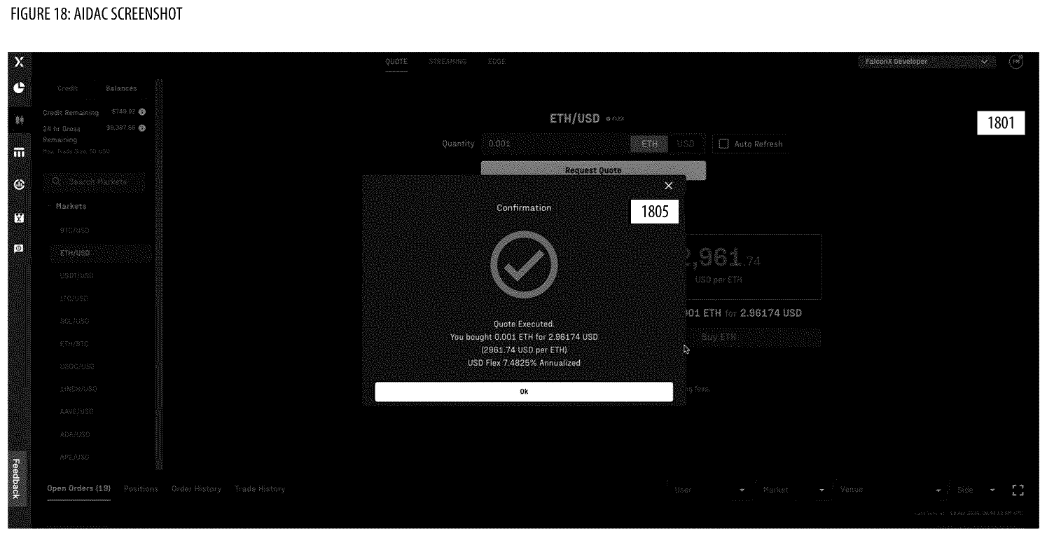

FIG. 18 shows non-limiting, example embodiments of a screenshot illustrating user interface(s) of the AIDAC. In FIG. 18, an exemplary user interface (e.g., for a mobile device, for a website) for facilitating execution of a temporal quantum limited asset fill transaction is illustrated. Screen 1801 shows an asset fill success notification widget 1805 that may be provided to the user to confirm execution of the temporal quantum limited asset fill transaction to buy the primary asset.

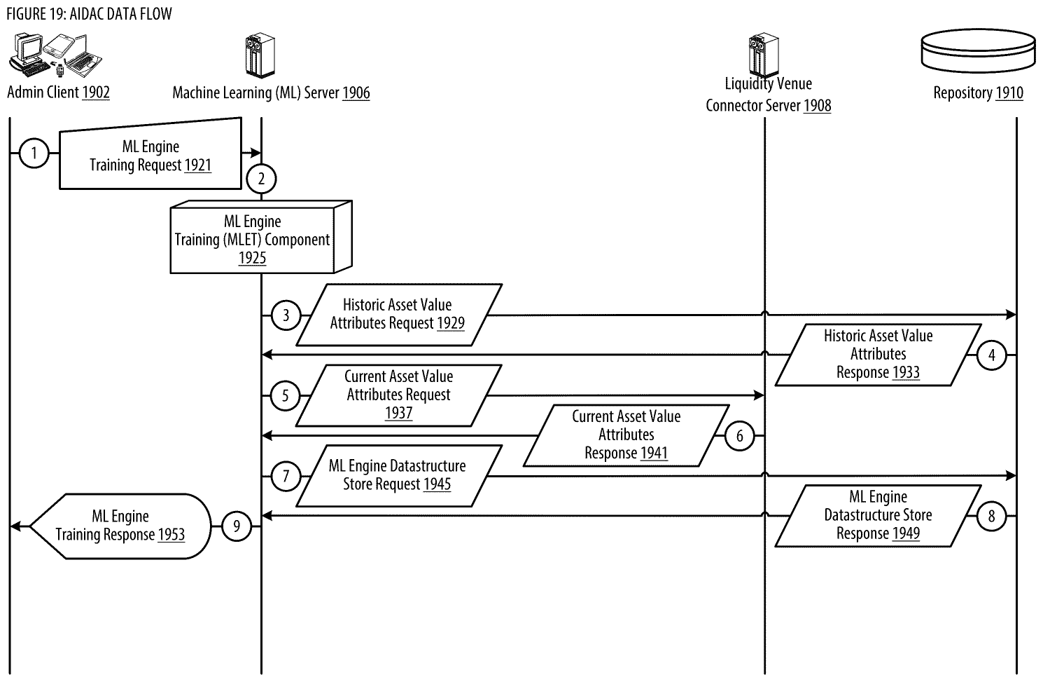

FIG. 19 shows non-limiting, example embodiments of a datagraph illustrating data flow(s) for the AIDAC. In FIG. 19, an admin client 1902 (e.g., of an administrative user) may send a ML engine training request 1921 to a machine learning (ML) server 1906 to facilitate training of an ML engine that predicts temporal quantum asset values. For example, the admin client may be a desktop, a laptop, a tablet, a smartphone, a smartwatch, and/or the like that is executing a client application. In one implementation, the ML engine training request may include data such as a request identifier, an ML engine identifier, training parameters (e.g., specified assets (e.g., specified markets (e.g., ETH/USD, BTC/USD, etc.)) that the ML engine should be trained to predict), and/or the like. In one embodiment, the admin client may provide the following example ML engine training request, substantially in the form of a HTTP(S) POST message including XML-formatted data, as provided below:

```
POST /ML_engine_training_request.php HTTP/1.1
Host: www.server.com
Content-Type: Application/XML
Content-Length: 667
<?XML version = “1.0” encoding = “UTF-8”?>
<ML_engine_training_request>
  <request_identifier>ID_request_11</request_identifier>
  <ML_engine_identifier>ID_ML_Engine_1</ML_engine_identifier>
  <training_parameters>
    <market_parameters>
      <asset_parameters>
        <asset_primary>ETH</asset_primary>
        <asset_secondary>USD</asset_secondary>
      </asset_parameters>
      <temporal_quantum>4 seconds</temporal_quantum>
    </market_parameters>
    <market_parameters>
      <asset_parameters>
        <asset_primary>BTC</asset_primary>
        <asset_secondary>USD</asset_secondary>
      </asset_parameters>
      <temporal_quantum>5 seconds</temporal_quantum>
    </market_parameters>
    ...
  </training_parameters>
</ML_engine_training_request>
```

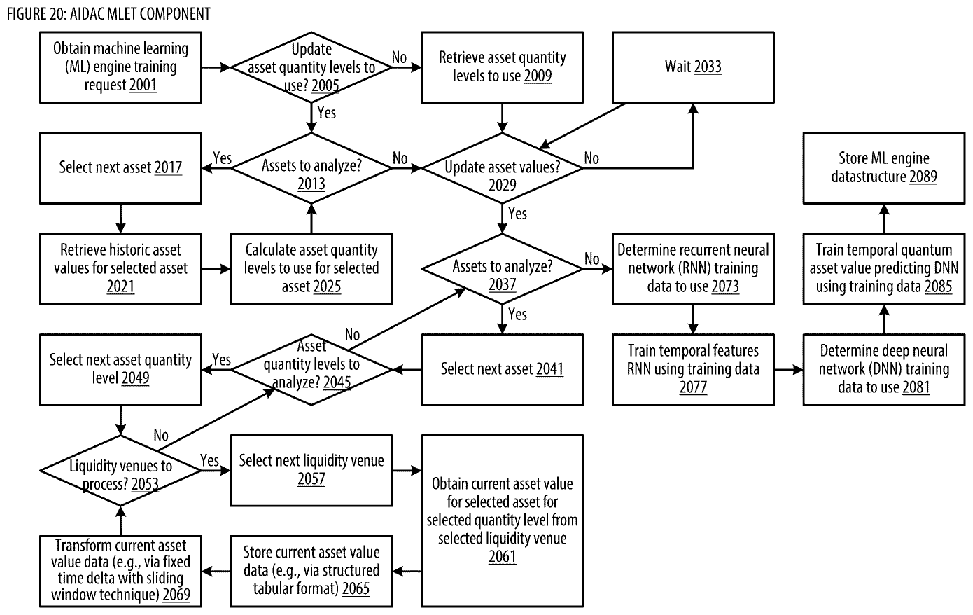

An ML engine training (MLET) component 1925 may utilize data provided in the ML engine training request to train the ML engine to predict temporal quantum asset values. See FIG. 20 for additional details regarding the MLET component.

The ML server 1906 may send a historic asset value attributes request 1929 to a repository 1910 to obtain historic trades data for the specified markets (e.g., historic customer trades for the last 90 days). It is to be understood that, in various implementations, one historic asset value attributes request may be sent to obtain historic trades data for available LVs for the specified markets, a separate historic asset value attributes request may be sent to obtain historic trades data for each available LV and/or specified market, and/or the like. In one implementation, the historic asset value attributes request may include data such as a request identifier, asset parameters, a date range, an LV identifier, and/or the like. In one embodiment, the ML server may provide the following example historic asset value attributes request, substantially in the form of a HTTP(S) POST message including XML-formatted data, as provided below:

```
POST /historic_asset_value_attributes_request.php HTTP/1.1
Host: www.server.com
Content-Type: Application/XML
Content-Length: 667
<?XML version = “1.0” encoding = “UTF-8”?>
<historic_asset_value_attributes_request>
  <request_identifier>ID_request_12</request_identifier>
  <asset_parameters>
    <asset_primary>ETH</asset_primary>
    <asset_secondary>USD</asset_secondary>
  </asset_parameters>
  <asset_parameters>
    <asset_primary>BTC</asset_primary>
    <asset_secondary>USD</asset_secondary>
  </asset_parameters>
  ...
  <date_range>Last 90 days</date_range>
</historic_asset_value_attributes_request>
```

The repository 1910 may send a historic asset value attributes response 1933 to the ML server 1906 with the requested historic trades data. In one implementation, the historic asset value attributes response may include data such as a response identifier, the requested historic trades data, and/or the like. In one embodiment, the repository may provide the following example historic asset value attributes response, substantially in the form of a HTTP(S) POST message including XML-formatted data, as provided below:

```
POST /historic_asset_value_attributes_response.php HTTP/1.1
Host: www.server.com
Content-Type: Application/XML
Content-Length: 667
<?XML version = “1.0” encoding = “UTF-8”?>
<historic_asset_value_attributes_response>
  <response_identifier>ID_response_12</response_identifier>
  <trade>
    <market>ETH/USD</market>
    <quantity>50</quantity>
    <side>buy</side>
    <price>2960</price>
  </trade>
  ...
  <trade>
    <market>BTC/USD</market>
    <quantity>5.5</quantity>
    <side>sell</side>
    <price>22000</price>
  </trade>
  ...
</historic_asset_value_attributes_response>
```

The ML server 1906 may send a current asset value attributes request 1937 to a liquidity venue connector server 1908 to obtain current asset value attributes for the specified markets at determined (e.g., using the requested historic trades data) asset quantity levels (e.g., quotes may be obtained periodically (e.g., every second) and those for the last 10 minutes may be utilized for training the ML engine). It is to be understood that, in various implementations, one current asset value attributes request may be sent to obtain current asset value attributes for available LVs for the specified markets at the determined asset quantity levels, a separate current asset value attributes request may be sent to obtain current asset value attributes for each available LV and/or specified market and/or determined asset quantity level, and/or the like. In one implementation, the current asset value attributes request may include data such as a request identifier, market parameters, an LV identifier, and/or the like. In one embodiment, the ML server may provide the following example current asset value attributes request, substantially in the form of a HTTP(S) POST message including XML-formatted data, as provided below:

```
POST /current_asset_value_attributes_request.php HTTP/1.1
Host: www.server.com
Content-Type: Application/XML
Content-Length: 667
<?XML version = “1.0” encoding = “UTF-8”?>
<current_asset_value_attributes_request>
  <request_identifier>ID_request_13</request_identifier>
  <LV_identifier>ID_liquidity_venue_1</LV_identifier>
  <market_parameters>
    <market>ETH/USD</market>
    <asset_quantity_levels>[1, 10, 100, 1000]</asset_quantity_levels>
  </market_parameters>
  <market_parameters>
    <market>BTC/USD</market>
    <asset_quantity_levels>[1, 5, 10, 100]</asset_quantity_levels>
  </market_parameters>
  ...
</current_asset_value_attributes_request>
```

The liquidity venue connector server 1908 may send a current asset value attributes response 1941 to the ML server 1906 with the requested current asset value attributes data. In one implementation, the current asset value attributes response may include data such as a response identifier, the requested current asset value attributes data, and/or the like. In one embodiment, the liquidity venue connector server may provide the following example current asset value attributes response, substantially in the form of a HTTP(S) POST message including XML-formatted data, as provided below:

```
POST /current_asset_value_attributes_response.php HTTP/1.1
Host: www.server.com
Content-Type: Application/XML
Content-Length: 667
<?XML version = “1.0” encoding = “UTF-8”?>
<current_asset_value_attributes_response>
  <response_identifier>ID_response_13</response_identifier>
  ...
  </quote>
    <market>ETH/USD</market>
    <quantity>10</quantity>
    <current_asset_value_buy>2960.40 (e.g., USD per
ETH)</current_asset_value_buy>
    <current_asset_value_sell>2960.20 (e.g., USD per
ETH)</current_asset_value_sell>
  </quote>
  ...
  <quote>
    <market>ETH/USD</market>
    <quantity>5</quantity>
    <current_asset_value_buy>22000 (e.g., USD per
BTC)</current_asset_value_buy>
    <current_asset_value_sell>21900 (e.g., USD per
BTC)</current_asset_value_sell>
  </quote>
  ...
</current_asset_value_attributes_response>
```

The ML server 1906 may send an ML engine datastructure store request 1945 to the repository 1910 to store an ML prediction logic data structure corresponding to the trained ML engine. In one implementation, the ML engine datastructure store request may include data such as a request identifier, an ML engine identifier, an ML engine datastructure, and/or the like. In one embodiment, the ML server may provide the following example ML engine datastructure store request, substantially in the form of a HTTP(S) POST message including XML-formatted data, as provided below.

```
POST /ML_engine_datastructure_store_request.php HTTP/1.1
Host: www.server.com
Content-Type: Application/XML
Content-Length: 667
<?XML version = “1.0” encoding = “UTF-8”?>
<ML_engine_datastructure_store_request>
  <request_identifier>ID_request_14</request_identifier>
  <ML_engine_identifier>ID_ML_Engine_1</ML_engine_identifier>
  <ML_engine_datastructure>ML prediction logic data
structure</ML_engine_datastructure>
</ML_engine_datastructure_store_request>
```

The repository 1910 may send an ML engine datastructure store response 1949 to the ML server 1906 to confirm whether the ML prediction logic data structure corresponding to the trained ML engine was stored successfully. In one implementation, the ML engine datastructure store response may include data such as a response identifier, a status, and/or the like. In one embodiment, the repository may provide the following example ML engine datastructure store response, substantially in the form of a HTTP(S) POST message including XML-formatted data, as provided below:

```
POST /ML_engine_datastructure_store_response.php HTTP/1.1
Host: www.server.com
Content-Type: Application/XML
Content-Length: 667
<?XML version = “1.0” encoding = “UTF-8”?>
<ML_engine_datastructure_store_response>
  <response_identifier>ID_response_14</response_identifier>
  <status>OK</status>
</ML_engine_datastructure_store_response>
```

The ML server 1906 may send a ML engine training response 1953 to the admin client 1902 to inform the administrative user whether training of the ML engine was completed successfully. In one implementation, the ML engine training response may include data such as a response identifier, a status, and/or the like. In one embodiment, the ML server may provide the following example ML engine training response, substantially in the form of a HTTP(S) POST message including XML-formatted data, as provided below:

```
POST /ML_engine_training_response.php HTTP/1.1
Host: www.server.com
Content-Type: Application/XML
Content-Length: 667
<?XML version = “1.0” encoding = “UTF-8”?>
<ML_engine_training_response>
  <response_identifier>ID_response_11</response_identifier>
  <status>OK</status>
</ML_engine_training_response>
```

FIG. 20 shows non-limiting, example embodiments of a logic flow illustrating a machine learning engine training (MLET) component for the AIDAC. In FIG. 20, a machine learning (ML) engine training request may be obtained at 2001. For example, the machine ML engine training request may be obtained as a result of a request from an administrative user to train an ML engine to predict temporal quantum asset values.

A determination may be made at 2005 whether to update asset quantity levels to use. In one implementation, the asset quantity levels to use may be updated periodically (e.g., daily, weekly, monthly, quarterly) and the determination may be made based on whether the time period between updates has elapsed (e.g., via a timer).

If the asset quantity levels to use should not be updated yet, asset quantity levels to use may be retrieved at 2009. In one embodiment, asset quantity levels to use calculated during the last update may be retrieved. In various implementations, the asset quantity levels to use may be retrieved from a cache, from a repository, and/or the like. For example, the retrieved asset quantity levels may have the following format:
{market: [asset quantity levels], market: [asset quantity levels], . . . }
{‘BTC/USD’: [1, 5, 10, 100], ‘ETH/USD’: [1, 10, 100, 1000] . . . }

If the asset quantity levels to use should be updated, a determination may be made at 2013 whether there remain assets (e.g., markets) to analyze. In one implementation, each of the specified assets (e.g., specified markets (e.g., ETH/USD, BTC/USD, etc.)) that the ML engine should be trained to predict may be analyzed. If there remain assets to analyze, the next asset may be selected for analysis at 2017.

Historic asset values for the selected asset (e.g., market) may be retrieved at 2021. For example, historic customer trades for the selected asset for the last 90 days may be retrieved. In one implementation, the historic asset values for the selected asset may be retrieved via a historic asset value attributes request and/or a corresponding historic asset value attributes response. For example, the historic asset values for the selected asset may have the following format:

```
{
  Market: ‘BTC/USD’
  Quantity: 5.5,
  Side: ‘sell’,
  Price: 22000
}
```

Asset quantity levels to use for the selected asset (e.g., market) may be calculated at 2025. In one embodiment, the number of asset quantity levels to use may be selected to improve predictive performance of the ML engine. For example, 5 asset quantity levels may be used. In one implementation, the asset quantity levels to use may be determined by analyzing the historic asset values for the selected asset. For example, the asset quantity levels to use for the selected asset may be calculated as follows:

### For 5 Asset Quantity Levels

Take the historic asset values (e.g., 90 days of trade data) and sort them
Remove outliers (e.g., remove the top and bottom 1.5% of trade data)
Divide data into specified number of (e.g., equal sized) buckets (e.g., take 0^{th} to 20^{th} percentile, 20^{th} to 40^{th} percentile, 40^{th} to 60^{th} percentile, 60^{th} to 80^{th} percentile and 80^{th} to 100^{th} percentile of the data to create 5 buckets)
In each bucket, use the median as the representative asset quantity level. Alternatively, the mean, the mode, and/or the like measure of central tendency may be utilized.
In some embodiments, a smoothing step to round the representative asset quantity level to the nearest multiple (e.g., of 1, of 0.5, of 0.25) to get round values for quoting levels may be utilized

A determination may be made at 2029 whether to update asset (e.g., market) values. In one implementation, the asset values may be updated periodically (e.g., every second) and the determination may be made based on whether the time period between updates has elapsed (e.g., via a timer).

If asset values should not be updated yet, the AIDAC may wait at 2033. In one implementation, the AIDAC may wait a specified period of time (e.g., 1 second). In another implementation, the AIDAC may wait until it is notified by a timer that it is time to update asset values. It is to be understood that, in some implementations, the asset values may be updated via a separate component (e.g., process) that periodically updates asset values of various available assets (e.g., independent of whether an ML engine is being trained via the MLET component).

If asset values should be updated, a determination may be made at 2037 whether there remain assets (e.g., markets) to analyze. In one implementation, each of the specified assets (e.g., specified markets (e.g., ETH/USD, BTC/USD, etc.)) that the ML engine should be trained to predict may be analyzed. If there remain assets to analyze, the next asset may be selected for analysis at 2041.

A determination may be made at 2045 whether there remain asset quantity levels to analyze for the selected asset (e.g., market). In one implementation, each of the asset quantity levels for the selected asset may be analyzed. If there remain asset quantity levels to analyze, the next asset quantity level may be selected for analysis at 2049.

A determination may be made at 2053 whether there remain liquidity venues to process. In one implementation, each of the available liquidity venues for the selected asset (e.g., BTC/USD market) may be processed (e.g., LVs that exchange a primary asset (e.g., BTC) associated with the market for a secondary asset (e.g., USD) associated with the market). If there remain liquidity venues to process, the next liquidity venue may be selected for processing at 2057.

A current asset value for the selected asset (e.g., BTC/USD market) for the selected quantity level may be obtained from the selected liquidity venue at 2061. In one implementation, the current asset value (e.g., a quote of an exchange rate of a primary asset (e.g., BTC) associated with the market in terms of a secondary asset (e.g., USD) associated with the market) for the selected asset for the selected quantity level may be obtained from the selected liquidity venue via a current asset value attributes request and/or a corresponding current asset value attributes response. For example, a request to obtain the current asset value for the selected asset for the selected quantity level from the selected liquidity venue may have the following format:

```
{
  Market: ‘BTC/USD’,
  Quantity: 5
}
```

For example, a response from the selected liquidity venue with the current asset value for the selected asset for the selected quantity level may have the following format:

```
{
  QuoteId (optional): ‘XYZ’,
  Market: ‘BTC/USD’,
  Quantity: 5,
  SellPrice: 21900,
  BuyPrice: 22000,
  TimeExpiry (optional): <t>
}
```

Current asset value data corresponding to the obtained current asset value may be stored at 2065. In one implementation, the current asset value data may be stored via a structured tabular format that ensures that relevant variables are recorded. For example, the current asset value data may be stored via a structured tabular format similar to the following:

| | | | | Time |
|---|---|---|---|---|
| | Mar- | Quan- | | Guarantee |
| Liquidity Venue Name | ket | tity | Price | (optional) |
| ID_liquidity_venue_1 | BTC/ | 5 | SellPrice: 21900, | <t> |
| | USD | | BuyPrice: 22000 | |

The current asset value data may be transformed to facilitate time-based comparisons at 2069. In one implementation, the current asset value data may be transformed via a fixed time delta approach with a sliding window matching technique, resulting in a structured table format that facilitates aligning data points based on specific time intervals. For example, the current asset value data may be transformed into a structured table format similar to the following:

| | | | | Price at | Price at |
|---|---|---|---|---|---|
| | | | Temporal | Time t | Time t + |
| Liquidity | Mar- | Quan- | Quantum | (e.g., 5 | Temporal |
| Venue Name | ket | tity | (seconds) | seconds ago) | Quantum |
| ID_liquidity_{—} | BTC/ | 5 | 5 | SellPrice: | SellPrice: |
| venue_1 | USD | | | 21920, | 21900, |
| | | | | BuyPrice: | BuyPrice: |
| | | | | 22020 | 22000 |

A recurrent neural network (RNN) training data to use may be determined at 2073. In one implementation, the RNN training data may comprise a time series input vector capturing price movements across different quantities for a specified set of data (e.g., the last 10 minutes of the current asset value data sampled at 1 second intervals) that allows an RNN to learn the temporal patterns of price changes effectively. For example, the RNN training data may comprise a timeseries input vector in a format similar to the following:

| Time | Liquidity | | Quan- | |
|---|---|---|---|---|
| Segment | Venue Name | Market | tity | Price |
| t-599 | ID_liquidity_{—} | BTC/ | 1 | SellPrice: 21950, |
| seconds | venue_1 | USD | | BuyPrice: 22050 |
| t-598 | ID_liquidity_{—} | BTC/ | 5 | SellPrice: 21949, |
| seconds | venue_1 | USD | | BuyPrice: 22051 |
| . . . | . . . | . . . | . . . | . . . |
| t-0 | ID_liquidity_{—} | ETH/ | 1000 | SellPrice: 2960.20, |
| seconds | venue_99 | USD | | BuyPrice: 2960.40 |

A temporal features RNN may be trained using the RNN training data at 2077. In one implementation, a Long Short-Term Memory (LSTM) temporal features RNN may be trained using TensorFlow machine learning library/platform. For example, the temporal features RNN may be trained using the RNN training data as follows:

### Using the Last 10 Minutes of the Current Asset Value Data Sampled at 1 Second Intervals

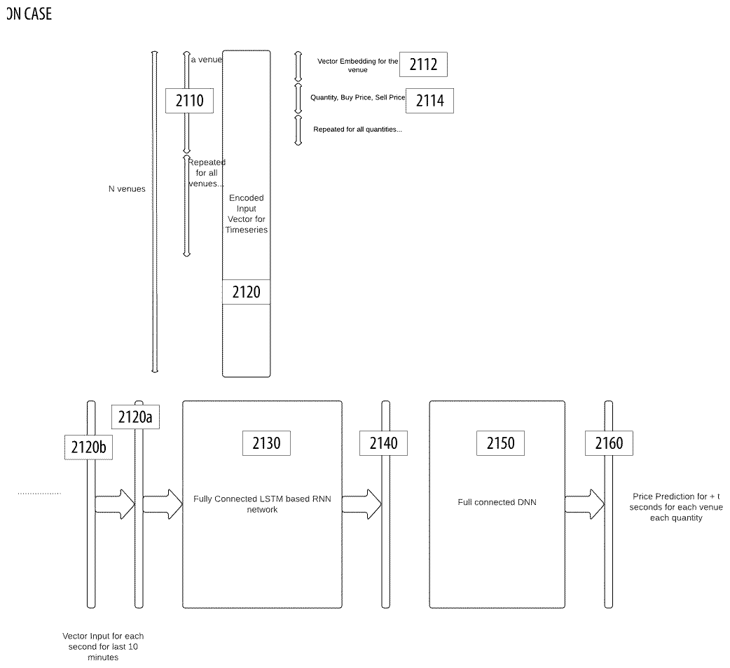

Encode the last 10 minutes of data as a timeseries input vector
Each second sample P prices (e.g., for P markets) from each of N available liquidity venues and concatenate a learned embedding vector for the liquidity venue, the size of the lot, the buy and sell prices. If the learned embedding vector for the liquidity venue is of size V then for each second we get a vector of size N(V+3P)
These time series vectors are passed into LSTM based RNN with a specified number (e.g., 3) fully connected layers resulting in a single encoded vector of size L which is connected to a Deep Neural Network (DNN) of a specified size (e.g., 3) predicting the price levels on the venues at T+t where t is typically the temporal quantum. Accordingly, the final output of the DNN is of size 2NP.
   See FIG. 21 for additional exemplary implementation details of the RNN.

Deep neural network (DNN) training data to use may be determined at 2081. In one implementation, the DNN training data may comprise the hidden state output vector from the RNN, representing learned temporal features, integrated with additional static inputs (e.g., with specific details about a liquidity venue). For example, the DNN training data may comprise an input vector in a format similar to the following:

| RNN Hidden State | Liquidity Venue Name | Market | Quantity |
|---|---|---|---|
| H1 | ID_liquidity_venue_1 | BTC/USD | 1 |

A temporal quantum asset value predicting DNN may be trained using the DNN training data at 2085. In one implementation, the temporal quantum asset value predicting DNN may be trained using TensorFlow machine learning library/platform. For example, the temporal quantum asset value predicting DNN may be trained using the DNN training data as follows:
The DNN is trained (e.g., using backpropagation) to predict prices after a specified temporal quantum for different markets for different quantity levels for different liquidity venues using the DNN training data (e.g., the encoded vector of size L) as an input vector
Accordingly, the DNN may have a fully connected output layer with N*P*2 outputs
   i. N is number of venues
   ii. P is average price levels per venue
   iii. 2 is to account for buy and sell prices
      See FIG. 21 for additional exemplary implementation details of the DNN.

An ML engine datastructure corresponding to the trained ML engine may be stored at 2089. In one implementation, ML prediction logic data structure corresponding to the temporal quantum asset value predicting DNN may be stored via an ML engine datastructure store request and/or a corresponding ML engine datastructure store response.

FIG. 21 shows non-limiting, example embodiments of implementation case(s) for the AIDAC. In FIG. 21, an exemplary implementation case to facilitate training of a machine learning (IL) engine is illustrated. In one implementation, a liquidity venue input vector 2110 may be generated for a liquidity venue (LV) each time data is sampled (e.g., every second). In one implementation, the liquidity venue input vector may comprise a vector embedding for the LV 2112, and, for each asset (e.g., market), the quantity, the buy price and the sell price 2114. Liquidity venue input vectors for available LVs may be combined to generate an input vector 2120. Such input vectors (e.g., 2120a, 2120b, etc.) may be generated for each sample interval (e.g., second) of a specified sample duration (e.g., for the last 10 minutes). A temporal features recurrent neural network (RNN) 2130 may be trained using the input vectors. The temporal features RNN may be trained to generate a hidden state output vector 2140. The hidden state output vector may be integrated with additional static inputs (e.g., with specific details about a liquidity venue) and used as an input vector to train a temporal quantum asset value predicting deep neural network (DNN) 2150. The temporal quantum asset value predicting DNN may be trained to predict prices 2160 after a specified temporal quantum (e.g., t seconds) for different markets for different quantity levels for different liquidity venues.

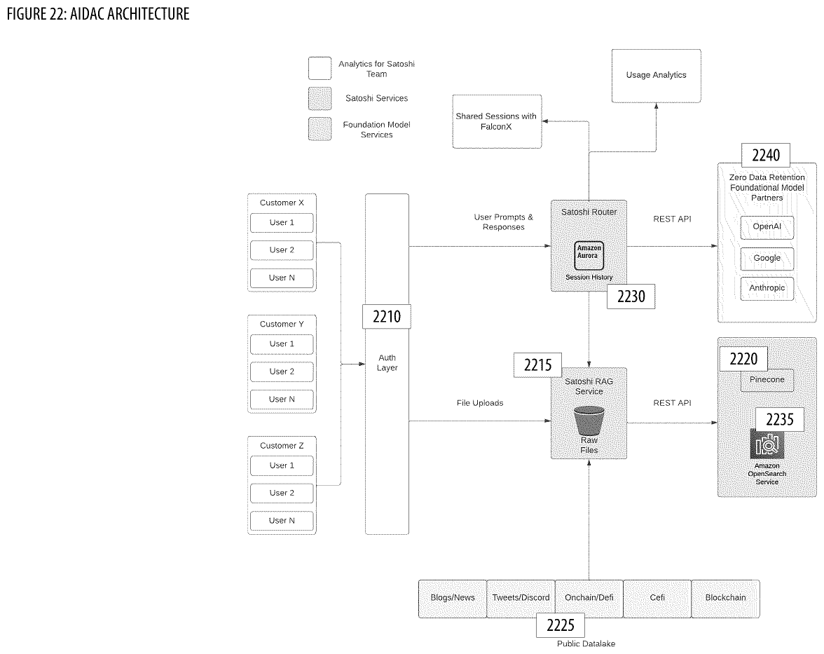

FIG. 22 shows non-limiting, example embodiments of an architecture for the AIDAC. In FIG. 22, an embodiment of how AIDAC components may be structured to facilitate data security is illustrated. When a user provides entity data (e.g., via file uploads) associated with an entity (e.g., Customer X, Customer Y, Customer Z), an authorization layer 2210 may be utilized to ensure that the user's data is appropriately siloed (e.g., accessible to the user, accessible to other permitted users associated with the user's entity). The entity data may be processed by a Retrieval-Augmented Generation (RAG) service 2215. In one implementation, the RAG service may convert the provided entity data into embeddings (e.g., for use by a large language model (LLM)) and/or may store the embeddings in a vector database 2220 (e.g., Pinecone) to facilitate efficient retrievals. Shared data may be obtained from a variety of shared data providers (e.g., blogs, news, Tweets, Discord data, onchain data, defi data, cefi data, blockchain data, etc.). A data provider may be an entity (e.g., Discord), a dataset (e.g., onchain data for ETH), and/or the like. In one implementation, the shared data may be stored in a public datalake 2225, maintaining user data segregation and/or may be processed by the RAG service. Session data for a user's session (e.g., comprising a set of prompts from the user and corresponding responses from the AIDAC) may be routed through a session router 2230 (e.g., implemented via Amazon Aurora) to provide secure session history management. In one implementation, the authorization layer may be utilized to ensure that the user's session data is appropriately siloed (e.g., accessible to the user, accessible to other permitted users associated with the user's entity, shared with a specified third party (e.g., for support and/or analytics)). When a user provides a prompt (e.g., during a session), relevant shared data (e.g., embeddings) and/or the relevant entity data (e.g., embeddings) for the prompt may be determined and/or retrieved via a search service 2235 (e.g., Amazon OpenSearch Service). In one implementation, the user's prompt (e.g., a task) may be augmented (e.g., augmented to utilize the relevant data (e.g., to include the relevant data and/or to specify that the user's request should be processed in accordance with the relevant data), broken down into subtasks, transformed into API call(s) corresponding to the task and/or the subtasks, and/or the like) and/or may be provided to an AI service provider 2240 (e.g., OpenAI, Google, Anthropic) to be processed by an AI service (e.g., an LLM, a Foundation Model, etc.). In one embodiment, zero data retention (ZDR) AI service providers may be utilized to ensure that a user's entity data is not stored by the ZDR AI service providers and/or that the user's session data with the ZDR AI service providers are ephemeral.

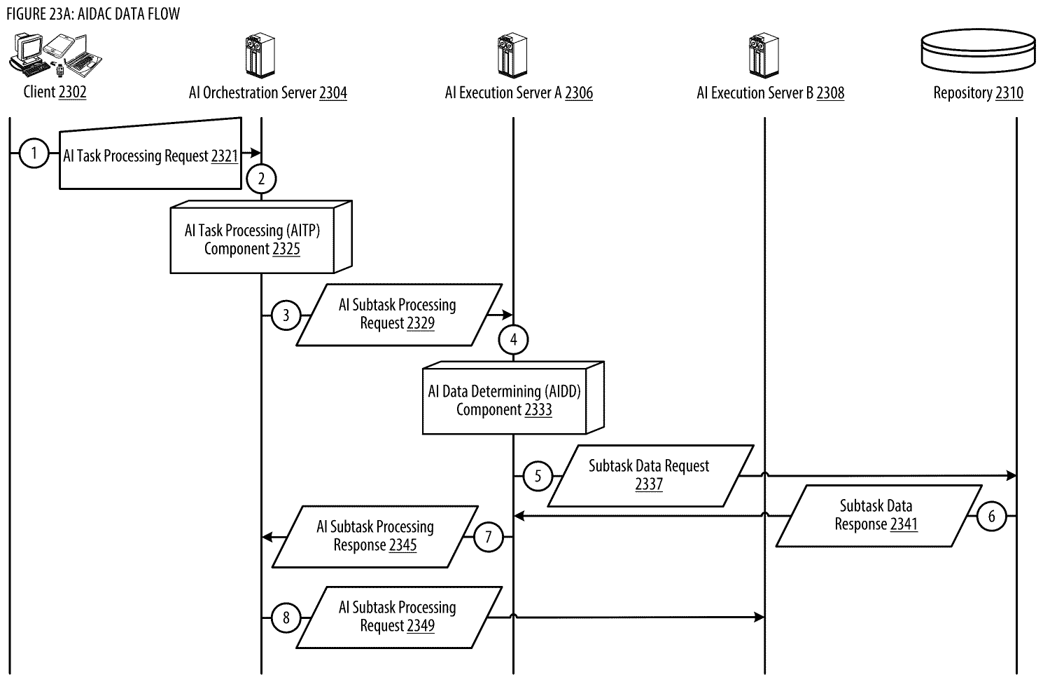

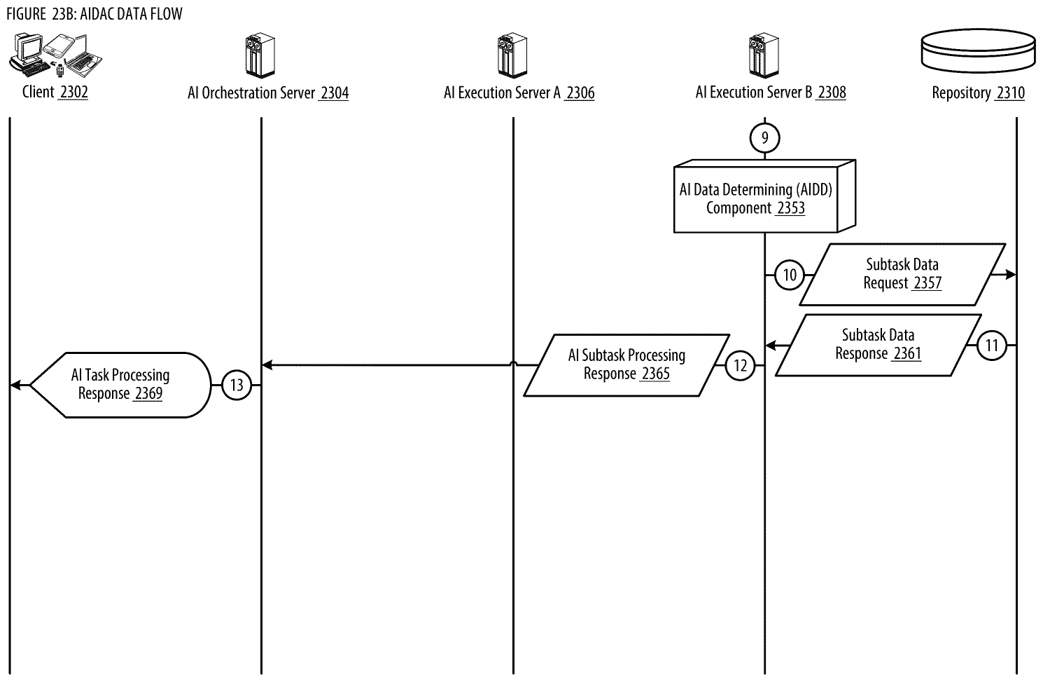

FIGS. 23A-B show non-limiting, example embodiments of a datagraph illustrating data flow(s) for the AIDAC. In FIG. 23, a client 2302 (e.g., of a user) may send an AI task processing request 2321 to an AI orchestration server 2304 to facilitate execution of a task via AI. For example, the client may be a desktop, a laptop, a tablet, a smartphone, a smartwatch, and/or the like that is executing a client application. In one implementation, the AI task processing request may include data such as a request identifier, a user identifier, an entity identifier, task details, and/or the like. In one embodiment, the client may provide the following example AI task processing request, substantially in the form of a (Secure) Hypertext Transfer Protocol (“HTTP(S)”) POST message including eXtensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
      <user_account_credentials>
        <user_name>JohnDaDoeDoeDoooe@gmail.com</user_name>
        <password>abc123</password>
        //OPTIONAL <cookie>cookieID</cookie>
        //OPTIONAL <digital_cert_link>www.mydigitalcertificate.com/
JohnDoeDaDoeDoe@gmail.com/mycertifcate.dc</digital_cert_link>
        //OPTIONAL <digital_certificate>_DATA_</digital_certificate>
      </user_account_credentials>
  </user_accounts_details>
  <client_details> //iOS Client with App and Webkit
        //it should be noted that although several client details
        //sections are provided to show example variants of client
        //sources, further messages may include only one to save
        //space
      <client_IP>10.0.0.123</client_IP>
      <user_agent_string>Mozilla/5.0 (iPhone; CPU iPhone OS 7_1_1 like Mac OS
X) AppleWebKit/537.51.2 (KHTML, like Gecko) Version/7.0 Mobile/11D201
Safari/9537.53</user_agent_string>
      <client_product_type>iPhone6,1</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>app with webkit</client_app_type>
      <app_installed_flag>true</app_installed_flag>
      <app_name>AIDAC.app</app_name>
      <app_version>1.0 </app_version>
      <app_webkit_name>Mobile Safari</client_webkit_name>
      <client_version>537.51.2</client_version>
  </client_details>
  <client_details> //iOS Client with Webbrowser
      <client_IP>10.0.0.123</client_IP>
      <user_agent_string>Mozilla/5.0 (iPhone; CPU iPhone OS 7_1_1 like Mac OS
X) AppleWebKit/537.51.2 (KHTML, like Gecko) Version/7.0 Mobile/11D201
Safari/9537.53</user_agent_string>
      <client_product_type>iPhone6,1</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>web browser</client_app_type>
      <client_name>Mobile Safari</client_name>
      <client_version>9537.53</client_version>
  </client_details>
  <client_details> //Android Client with Webbrowser
      <client_IP>10.0.0.123</client_IP>
      <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
      <client_product_type>Nexus S</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Android</client_OS>
      <client_OS_version>4.0.4</client_OS_version>
      <client_app_type>web browser</client_app_type>
      <client_name>Mobile Safari</client_name>
      <client_version>534.30</client_version>
  </client_details>
  <client_details> //Mac Desktop with Webbrowser
      <client_IP>10.0.0.123</client_IP>
      <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
      <client_product_type>MacPro5,1</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Mac OS X</client_OS>
      <client_OS_version>10.9.3</client_OS_version>
      <client_app_type>web browser</client_app_type>
      <client_name>Mobile Safari</client_name>
      <client_version>537.75.14</client_version>
  </client_details>
  <AI_task_processing_request>
    <request_identifier>ID_request_21</request_identifier>
    <user_identifier>ID_user_1</user_identifier>
    <entity_identifier>ID_entity_1</entity_identifier>
    <task_details>
      <task_identifier>ID_task_1</task_identifier>
      <task_instructions>Tell me latest news about ETH</task_instructions>
    </task_details>
  </AI_task_processing_request>
</auth_request>
```

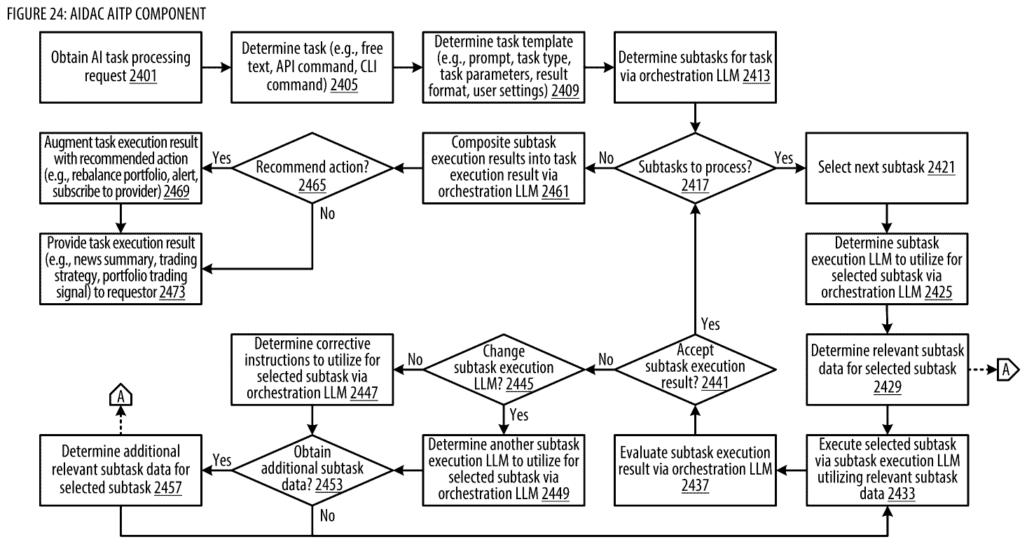

An AI task processing (AITP) component 2325 may utilize data provided in the AI task processing request to execute the task via AI. In one implementation, the AITP component may determine relevant subtasks for the task and/or may utilize subtask execution results to generate a task execution result (e.g., which may include a recommended action). See FIG. 24 for additional details regarding the AITP component.

The AI orchestration server 2304 may send a first AI subtask processing request 2329 to a first AI execution server A 2306 to facilitate execution of a first subtask relevant for the task. In one implementation, the AI subtask processing request may include data such as a request identifier, a user identifier, an entity identifier, subtask details, and/or the like. In one embodiment, the AI orchestration server may provide the following example AI subtask processing request, substantially in the form of a HTTP(S) POST message including XML-formatted data, as provided below:

```
POST /AI_subtask_processing_request.php HTTP/ 1. 1
Host: www.server.com
Content-Type: Application/XML
Content-Length: 667
<?XML version = “1.0” encoding = “UTF-8”?>
<AI_subtask_processing_request>
  <request_identifier>ID_request_22</request_identifier>
  <user_identifier>ID_user_1</user_identifier>
  <entity_identifier>ID_entity_1</entity_identifier>
  <subtask_details>
    <subtask_identifier>ID_subtask_1</subtask_identifier>
    <subtask_type>TYPE_SUMMARIZE</subtask_type>
    <subtask_instructions>Summarize news about ETH from last 24
hours</subtask_instructions>
  <execution_engine_identifier>ID_execution_LLM_1</execution_engine_identifier
>
  </subtask_details>
</AI_subtask_processing_request>
```

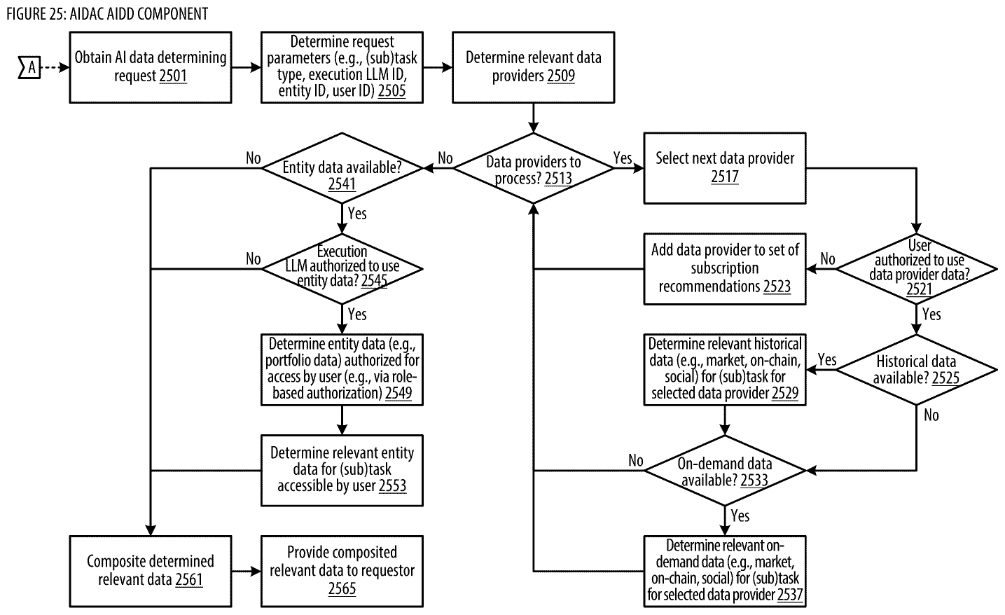

An AI data determining (AIDD) component 2333 may utilize data provided in the first AI subtask processing request to determine relevant data (e.g., data providers' data, entity data) to utilize to execute the first subtask relevant for the task. See FIG. 25 for additional details regarding the AIDD component.

The AI execution server A 2306 may send a subtask data request 2337 to a repository 2310 to retrieve the relevant data for the first subtask. It is to be understood that, in some alternative embodiments, the relevant data for the first subtask may instead be retrieved by the AI orchestration server 2304 (e.g., via the AITP component and/or provided to the AI execution server A via the first AI subtask processing request). In one implementation, the subtask data request may include data such as a request identifier, query parameters, and/or the like. In one embodiment, the AI execution server A may provide the following example subtask data request, substantially in the form of a HTTP(S) POST message including XML-formatted data, as provided below:

```
POST /subtask_data_request.php HTTP/1. 1
Host: www.server.com
Content-Type: Application/XML
Content-Length: 667
<?XML version = “1.0” encoding = “UTF-8”?>
<subtask_data_request>
  <request_identifier>ID_request_23</request_identifier>
  <query_parameters>
    <search_data_type>DATA_PROVIDER_NEWS_DATA</search_data_type>
    <data_provider>ID_news_data_provider_1</data_provider>
    <search_terms>ETH</search_terms>
    <search_filter>Last 24 hours</search_filter>
  </query_parameters>
</subtask_data_request>
```

The repository 2310 may send a subtask data response 2341 to the AI execution server A 2306 with the requested relevant data for the first subtask. In one implementation, the subtask data response may include data such as a response identifier, the requested relevant data for the first subtask, and/or the like. In one embodiment, the repository may provide the following example subtask data response, substantially in the form of a HTTP(S) POST message including XML-formatted data, as provided below:

```
POST /subtask_data_response.php HTTP/ 1. 1
Host: www.server.com
Content-Type: Application/XML
Content-Length: 667
<?XML version = “1.0” encoding = “UTF-8”?>
<subtask_data_response>
  <response_identifier>ID_response_23</response_identifier>
  <query_response>ETH news datastructure (e.g., news article, podcast,
large block trades info)</query_response>
</subtask_data_response>
```

The AI execution server A 2306 may send a first AI subtask processing response 2345 to the AI orchestration server 2304 with execution result data for the first subtask relevant for the task. In one implementation, the AI subtask processing response may include data such as a response identifier, execution result data for the first subtask, and/or the like. In one embodiment, the AI execution server A may provide the following example AI subtask processing response, substantially in the form of a HTTP(S) POST message including XML-formatted data, as provided below:

```
POST /AI_subtask_processing_response.php HTTP/ 1. 1
Host: www.server.com
Content-Type: Application/XML
Content-Length: 667
<?XML version = “1.0” encoding = “UTF-8”?>
<AI_subtask_processing_response>
  <response_identifier>ID_response_22</response_identifier>
  <subtask_execution_result>News summary for ETH</subtask_execution_result>
</AI_subtask_processing_response>
```

The AI orchestration server 2304 may send a second AI subtask processing request 2349 to a second AI execution server B 2308 to facilitate execution of a second subtask relevant for the task. In one implementation, the AI subtask processing request may include data such as a request identifier, a user identifier, an entity identifier, subtask details, and/or the like. In one embodiment, the AI orchestration server may provide the following example AI subtask processing request, substantially in the form of a HTTP(S) POST message including XML-formatted data, as provided below:

```
POST /AI_subtask_processing_request.php HTTP/ 1. 1
Host: www.server.com
Content-Type: Application/XML
Content-Length: 667
<?XML version = “1.0” encoding = “UTF-8”?>
<AI_subtask_processing_request>
  <request_identifier>ID_request_24</request_identifier>
  <user_identifier>ID_user_1</user_identifier>
  <entity_identifier>ID_entity_1</entity_identifier>
  <subtask_details>
    <subtask_identifier>ID_subtask_2</subtask_identifier>
    <subtask_type>TYPE_RECOMMEND_TRADING_ACTION</subtask_type>
    <subtask_instructions>Recommend trading action using news summary for
ETH</subtask_instructions>
  <execution_engine_identifier>ID_execution_LLM_2</execution_engine_identifier
>
  </subtask_details>
</AI_subtask_processing_request>
```

An AI data determining (AIDD) component 2353 may utilize data provided in the second AI subtask processing request to determine relevant data (e.g., data providers' data, entity data) to utilize to execute the second subtask relevant for the task. See FIG. 25 for additional details regarding the AIDD component.

The AI execution server B 2308 may send a subtask data request 2357 to the repository 2310 to retrieve the relevant data for the second subtask. It is to be understood that, in some alternative embodiments, the relevant data for the second subtask may instead be retrieved by the AI orchestration server 2304 (e.g., via the AITP component and/or provided to the AI execution server B via the second AI subtask processing request). In one implementation, the subtask data request may include data such as a request identifier, query parameters, and/or the like. In one embodiment, the AI execution server B may provide the following example subtask data request, substantially in the form of a HTTP(S) POST message including XML-formatted data, as provided below:

```
POST /subtask_data_request.php HTTP/1. 1
Host: www.server.com
Content-Type: Application/XML
Content-Length: 667
<?XML version = “1.0” encoding = “UTF-8”?>
<subtask_data_request>
  <request_identifier>ID_request_25</request_identifier>
  <query_parameters>
    <search_data_type>ENTITY_PORTFOLIO_DATA</search_data_type>
    <entity_identifier>ID_entity_1</entity_identifier>
    <search_terms>ETH</search_terms>
  </query_parameters>
</subtask_data_request>
```

The repository 2310 may send a subtask data response 2361 to the AI execution server B 2308 with the requested relevant data for the second subtask. In one implementation, the subtask data response may include data such as a response identifier, the requested relevant data for the second subtask, and/or the like. In one embodiment, the repository may provide the following example subtask data response, substantially in the form of a HTTP(S) POST message including XML-formatted data, as provided below:

```
POST /subtask_data_response.php HTTP/ 1. 1
Host: www.server.com
Content-Type: Application/XML
Content-Length: 667
<?XML version = “1.0” encoding = “UTF-8” ?>
<subtask_data_response>
  <response_identifier>ID_response_25</response_identifier>
  <query_response>Portfolio data datastructure (e.g., ETH positions,
related assets positions)</query_response>
</subtask_data_response>
```

The AI execution server B 2308 may send a second AI subtask processing response 2365 to the AI orchestration server 2304 with execution result data for the second subtask relevant for the task. In one implementation, the AI subtask processing response may include data such as a response identifier, execution result data for the second subtask, and/or the like. In one embodiment, the AI execution server B may provide the following example AI subtask processing response, substantially in the form of a HTTP(S) POST message including XML-formatted data, as provided below:

```
POST /AI_subtask_processing_response.php HTTP/ 1. 1
Host: www.server.com
Content-Type: Application/XML
Content-Length: 667
<?XML version = “1.0” encoding = “UTF-8”?>
<AI_subtask_processing_response>
  <response_identifier>ID_response_24</response_identifier>
  <subtask_execution_result>Recommended trading action for entity's
portfolio</subtask_execution_result>
</AI_subtask_processing_response>
```

The AI orchestration server 2304 may send an AI task processing response 2369 to the client 2302 to provide the user with execution result data for the task. In one implementation, the AI task processing response may include data such as a response identifier, execution result data for the task, and/or the like. In one embodiment, the AI orchestration server may provide the following example AI task processing response, substantially in the form of a HTTP(S) POST message including XML-formatted data, as provided below:

```
POST /AI_task_processing_response.php HTTP/ 1. 1
Host: www.server.com
Content-Type: Application/XML
Content-Length: 667
<?XML version = “1.0” encoding = “UTF-8”?>
<AI_task_processing_response>
  <response_identifier>ID_response_21</response_identifier>
  <task_execution_result>
    News summary for ETH
    Based on the latest news about ETH, we recommend that you take the following
actions:
    Recommended trading action for entity's portfolio
  </task_execution_result>
</AI_task_processing_response>
```

FIG. 24 shows non-limiting, example embodiments of a logic flow illustrating an AI task processing (AITP) component for the AIDAC. In FIG. 24, an AI task processing request may be obtained at 2401. For example, the AI task processing request may be obtained as a result of a request from a user to execute a task via AI.

A task specified via the AI task processing request may be determined at 2405. For example, a task may comprise providing real-time news summaries, insights, and/or research, performing portfolio analytics, trading strategy development, and/or the like implementing a variety of pre-trade, at-trade, and/or post-trade features associated with digital assets. In various embodiments, the user may specify the task via a user prompt (e.g., a free text user prompt), a GUI command, a command-line interface (CLI) command, an API command, and/or the like. In one implementation, the AI task processing request may be parsed (e.g., using PUP commands) to determine the specified task (e.g., based on the value of the task_details field).

In some embodiments, a task template associated with the specified task may be determined at 2409. For example, task templates may be specified for frequently used tasks to improve execution speed and/or accuracy. In one implementation, a task template may comprise a datastructure specifying data fields such as a prompt (e.g., a set of matching free text user prompts), a description, a task type, a command to utilize (e.g., a function used to orchestrate task execution (e.g., specifying how to utilize task parameters, subtasks to execute, functions to utilize to execute subtasks, data providers to utilize, task execution result format, and/or the like)), task parameters (e.g., utilized by the command during execution), user settings (e.g., to check during task execution (e.g., a setting specifying portfolio accounts to analyze)), and/or the like. For example, task templates may be specified as follows:

### Example Task Template Datastructures

| | |
|---|---|
| 1. | **Prompt**: Tell me latest news |
| | - **Command**: ‘/LatestNews' |
| | - **Parameters**: |
| | - Topic (mandatory): keyword on which you want latest news |
| | - **Description**: Fetches the latest news articles related to the keyword |
| 2. | **Prompt**: Can you analyze a smart contract for me? |
| | - **Command**: ‘/AnalyzeContract’ |
| | - **Parameters**: |
| | - ‘contractAddress' (mandatory): The address of the smart contract to analyze. |
| | - **Description**: Analyzes the code and functionality of a specified smart |

contract and call out any security issues.

| | |
|---|---|
| 3. | **Prompt**: Can you analyze a document for me? |
| | - **Command**: ‘/AnalyzeUrl’ |
| | - **Parameters**: |
| | - ‘webURL’ (mandatory): The URL to analyze. |
| | - **Description**: Performs an analysis of the content within a provided |

document.

| | |
|---|---|
| 4. | **Prompt**: Can you analyze a YouTube conversation for me? |
| | - **Command**: ‘/AnalyzeYouTube’ |
| | - **Parameters**: |
| | - ‘YouTubeUrl’ (mandatory): The URL of YouTube video to analyze. |
| | - **Description**: Analyzes the conversation in the specified YouTube video. |
| 5. | **Prompt**: What are the latest regulatory or legal developments affecting |

cryptocurrencies?

```
  - **Command**: ‘/CryptoRegNews'
  - **Description**: Retrieves the latest news on regulatory or legal
```

developments in the cryptocurrency space.

| | |
|---|---|
| 6. | **Prompt**: Show me the inflow and outflow of funds for Bitcoin ETFs. |
| | -**Prompt**: What were the asset flows for Bitcoin ETFs last week? |
| | -**Prompt**: How much Bitcoin has flowed into spot ETFs recently? |
| | -**Prompt**: Which ETF had the largest inflow and outflow over the last week? |
| | - **Command**: ‘/ETFFlow’ |
| | - **Parameters**: |
| | - ‘ETF Ticker’ (optional): The ETF Ticker to analyze. |
| | - ‘Start Date’ (optional): Start date from which to analyze. |
| | - ‘End Date’ (optional): End date to which to analyze. |
| | - **Description**: Shows ETF flows |

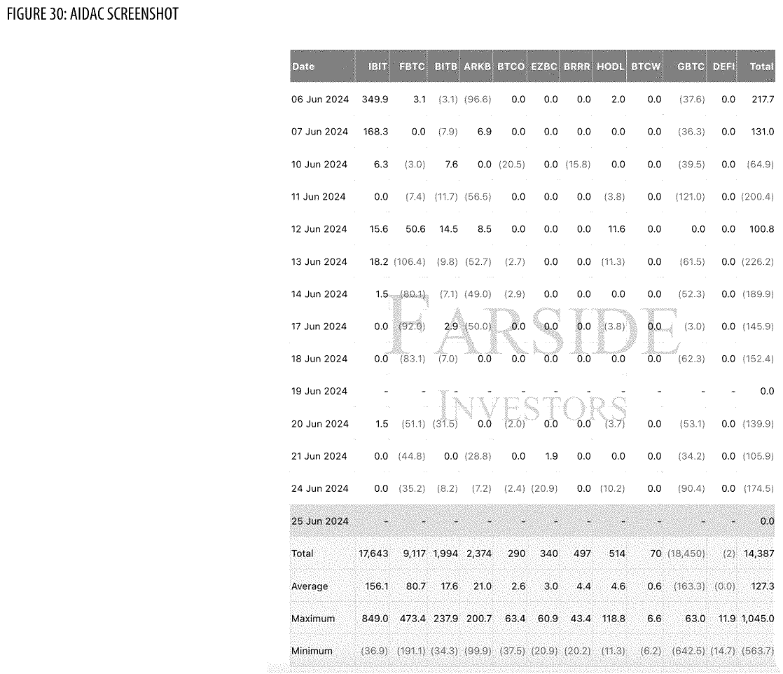

For example, a command may be specified as follows (e.g., see FIG. 30 for an example ETF Flow command output):

### Example Command (E.g., A Function Used to Orchestrate Task Execution)

```
  - **Command**: ‘/ ETFFlow’
  - **Parameters**:
    - ‘ETF Ticker’ (optional): The ETF Ticker to analyze.
    - ‘Start Date’ (optional): Start date from which to analyze.
    - ‘End Date’ (optional): End date to which to analyze.
  - **Orchestration Prompt**:
  Scrape web data via API : “https://open-api-
v3.coinglass.com/api/bitcoin/etf/flow-history” //web_scraper (url: API)
    If ETF ticker is provided, filter by ETF ticker.
    If start date is provided, show from start date until latest date.
    If end date is provided, show last 30 days before end date
    If no dates are provided, show full history.
    Show date as rows and ticker as columns.
    Calculate rows/column total and also column average.
    Ignore the price/close price info.
```

In one implementation, the task template associated with the specified task may be determined by matching the specified user prompt to prompt, description, task type, and/or the like data fields of available task templates to determine a matching task template or to determine that no matching task template exists. In another implementation, a command used to specify the task may be linked (e.g., via a configuration setting, via a data field) to a task template.

Subtasks for the task may be determined via an orchestration generative AI engine (e.g., an orchestration LLM) at 2413. For example, an orchestration generative AI engine implemented via GPT, Bard, Claude, Llama, and/or the like may be utilized. In one embodiment, the orchestration generative AI engine may determine the subtasks for the task via dynamic reasoning about task execution. In one implementation, the orchestration generative AI engine may utilize a structured approach to subtask determination, utilizing a predefined (e.g., JSON) schema function-calling framework. For example, this schema may define a set of functions that perform a variety of subtasks (e.g., fetch data from a webpage, perform a specific calculation, analyze code for security issues, analyze content to generate a summary). This schema may be incorporated into the execution context of the orchestration generative AI engine, enabling the orchestration generative AI engine to dynamically determine subtasks for the task and/or to map the subtasks for the task to available functions. In one implementation, the orchestration generative AI engine may analyze names, descriptions, parameters, and/or the like of functions to determine a function of the JSON schema that best matches a subtask. For instance, if a subtask involves fetching data from a webpage, the orchestration generative AI engine may reference a corresponding function definition embedded within the JSON schema. For example, a function in such a schema may be specified as follows.

```
Web scraping function
{
  “type”: “function”,
  “function”: {
    “name”: “web_scraper”,
    “description”: “Retrieves and downloads content from specified
    web URLs,
including YouTube videos.”,
    “parameters”: {
      “type”: “object”,
      “properties”: {
        “url”: {
          “type”: “string”,
          “description”: “The public URL to be scraped or
          downloaded.”
        }
      },
      “required”: [“url”]
    }
  }
}
```

The orchestration generative AI engine may determine, based on contextual input (e.g., task instructions) and/or AI reasoning, whether and/or when to invoke such a function to facilitate executing a subtask. Accordingly, the orchestration generative AI engine may dynamically evaluate the task requirements and may execute appropriate functions as determined, thereby enabling flexible and adaptive orchestration of subtasks. It is to be understood that, in some embodiments, the task may comprise a single subtask equivalent to the task.

In another embodiment, the orchestration generative AI engine may determine the subtasks for the task by analyzing the determined task template. In one implementation, the task template may specify subtasks to execute (e.g., via a command) and the orchestration generative AI engine may utilize provided task parameter values to facilitate execution of the subtasks via available functions of the JSON schema.

A determination may be made at 2417 whether there remain subtasks to process. In one implementation, each of the determined subtasks for the task may be processed. If there remain subtasks to process, the next subtask may be selected for processing at 2421.

A subtask execution generative AI engine (e.g., a subtask execution LLM) to utilize for the selected subtask may be determined via the orchestration generative AI engine at 2425. For example, a subtask execution generative AI engine implemented via GPT, Bard, Claude, Llama, and/or the like may be utilized. In one embodiment, the best performing subtask execution generative AI engine may be selected from available subtask execution generative AI engines for the selected subtask. For example, a map may associate each respective function with a best performing subtask execution generative AI engine for the respective function. In one implementation, the selection of a best performing subtask execution generative AI engine for a given subtask may be based on an offline evaluation process conducted against a predefined test dataset. This evaluation may be carried out periodically to ensure optimal performance. For example, if a subtask involves performing mathematical computations, a benchmark dataset containing various mathematical operations may be created. Multiple available LLMs may be tested against this dataset to assess their accuracy, efficiency, reliability, and/or the like. Based on these evaluations, the most suitable LLM for the subtask may be selected for execution during serving. This evaluation process may be conducted at regular intervals across different subtasks to account for improvements in model capabilities, ensuring that the best-performing LLM is used for each specific subtask.

In another embodiment, a plurality of subtask execution generative AI engines may be selected for the selected subtask. In one implementation, multiple subtask execution generative AI engines may be utilized to break down a large subtask into multiple smaller subtasks (e.g., to parallelize processing and/or improve execution speed). In another implementation, multiple subtask execution generative AI engines may be utilized to execute the same subtask (e.g., in parallel), and the orchestration generative AI engine may evaluate subtask execution results from the utilized subtask execution generative AI engines to select the best subtask execution result.

Relevant subtask data for the selected subtask may be determined at 2429. In one embodiment, relevant data from available data providers and/or relevant entity data of an entity associated with the user may be determined and/or obtained (e.g., retrieved from a database (e.g., embeddings), scraped from a website (e.g., converted into embeddings via a RAG service)). In some embodiments, data providers that may have relevant subtask data and which the user is not authorized to use (e.g., the user does not have a subscription to the data provider) may also be determined. In one implementation, an AIDD component may be utilized to determine relevant subtask data for the selected subtask (e.g., by the orchestration generative AI engine, by the subtask execution generative AI engine).

The selected subtask may be executed via the determined subtask execution generative AI engine utilizing the relevant subtask data at 2433. In one embodiment, the relevant subtask data may be included in the execution context provided to the subtask execution generative AI engine to ensure that the subtask execution generative AI engine operates with the most appropriate and/or up-to-date data. In one implementation, an API call comprising subtask execution instructions (e.g., specified via a function in the schema function-calling framework, generated via the orchestration generative AI engine) may be generated (e.g., by an AI orchestration server, by an AI execution server) to the subtask execution generative AI engine to obtain a subtask execution result. For example, subtask execution instructions may comprise prompt instructions similar to the following:

### Prompt Instructions to Generate an SEC Filing Summary

### Relevant Subtask Data

Filings that have been submitted to the SEC within the last 24 hours.
Documents relevant to publicly traded companies in the cryptocurrency space

### Execution Prompt

I would like a summary of the most recent [Filing Type] for [Company Name]. Please provide the summary in the following format:
   Filing Type: [Specify the type of SEC filing]
   Company Name: [Name of the company]
   Summary of Key Points:
      [First key point from the filing]
      [Second key point from the filing]
      [Third key point from the filing]
   Potential Impact:
      [Assessment of potential impact on stock price or investor sentiment]
      [Assessment of potential impact on the broader market]

### Summary Structure

Filing Type: The specific type of SEC filing (e.g., Form 10-K, Form 10-Q, Form 8-K, S-1, etc.).
Company Name: The name of the company that made the filing.
Summary of Key Points: A brief overview highlighting the most critical information contained in the filing, including financial updates, management discussion, and any material events or changes. Maximum of 5 sentences.
Potential Impact: An assessment of how the filing could potentially impact the company's stock price, investor sentiment, or the broader cryptocurrency market. Maximum of 2 sentences.
Hyperlink: A direct link to a detailed AIDAC session for further analysis.

The subtask execution result may be evaluated via the orchestration generative AI engine at 2437. In one embodiment, the orchestration generative AI engine may evaluate the acceptability of the subtask execution result from the subtask execution generative AI engine using one or more of AI reasoning, validation mechanisms, structured checks, and/or the like. In one implementation, one or more of the following methods may be utilized:

### 1. LLM Reasoning and Self-Verification:

0301.1. The orchestration generative AI engine applies its own reasoning capabilities to assess whether the subtask execution result logically aligns with the subtask requirements.
0301.2. The orchestration generative AI engine may perform self-consistency checks, analyzing the subtask execution result in relation to the original input and expected patterns.
0301.3. In cases of ambiguity, the orchestration generative AI engine may generate hypotheses about potential errors and request refinements or additional computations.

### 2. Schema Compliance Checking:

0302.1. The orchestration generative AI engine ensures that the subtask execution generative AI engine's output conforms to a predefined schema or expected format.
0302.2. If the output is improperly structured, the orchestration generative AI engine may request a reattempt or correction.

### 3. Confidence Scoring and Thresholding:

0303.1. If the subtask execution generative AI engine provides confidence scores, the orchestration generative AI engine compares them against predefined thresholds to determine if the subtask execution result is reliable.
0303.2. If confidence is low, the subtask execution generative AI engine may invoke additional validation steps.

### 4. Rule-Based and Heuristic Validation:

0304.1. For structured tasks like calculations, the orchestration generative AI engine may apply known formulas or reference models to verify correctness.
0304.2. Heuristic checks (e.g., verifying that a summary does not contradict key facts) are applied to ensure coherence.

In one embodiment, by leveraging AI reasoning, structured validation, and/or fallback mechanisms, the orchestration generative AI engine ensures that subtask execution generative AI engine outputs are logical, accurate, and suitable for downstream tasks. In some embodiments, subtask execution results from multiple subtask execution generative AI engines may be evaluated to select the best (e.g., based on a confidence score, based on AI reasoning) subtask execution result.

A determination may be made at 2441 whether to accept the subtask execution result. If the evaluation of the subtask execution result indicates that the subtask execution result is not acceptable, a determination may be made at 2445 regarding corrective measures to utilize to obtain a better subtask execution result. In one embodiment, corrective instructions may be provided to the subtask execution generative AI engine to obtain a better subtask execution result. In another embodiment, another subtask execution generative AI engine may be utilized to obtain a better subtask execution result. In some embodiments, additional relevant subtask data for the selected subtask may be utilized to obtain a better subtask execution result.

If the subtask execution generative AI engine should not be changed, corrective instructions to utilize for the selected subtask may be determined via the orchestration generative AI engine at 2447. In one embodiment, the corrective instructions to utilize for the selected subtask may comprise instructions to perform refinements and/or additional computations. In one implementation, the orchestration generative AI engine may utilize AI reasoning to generate hypotheses about potential errors and/or to determine corrective instructions that address potential errors. In another embodiment, the corrective instructions to utilize for the selected subtask may comprise instructions to correct improperly structured output and/or to reattempt subtask execution (e.g., using additional instruction details and/or additional relevant subtask data). In one implementation, the orchestration generative AI engine may utilize AI reasoning to determine corrective instructions that address improperly structured output.

If the subtask execution generative AI engine should be changed (e.g., corrective instructions were not used or did not produce desired subtask execution result), another subtask execution LLM to utilize for the selected subtask may be determined via the orchestration LLM at 2449. In one embodiment, the next best performing subtask execution generative AI engine may be selected from available subtask execution generative AI engines for the selected subtask.

A determination may be made at 2453 whether to obtain additional subtask data for the selected subtask. For example, additional subtask data for the selected subtask may be specified by the corrective instructions to utilize for the selected subtask. If additional subtask data should be obtained, additional relevant subtask data for the selected subtask may be determined at 2457. In one embodiment, additional relevant data from available data providers and/or additional relevant entity data of an entity associated with the user may be determined and/or obtained (e.g., retrieved from a database (e.g., embeddings), scraped from a website (e.g., converted into embeddings via a RAG service)). In some embodiments, data providers that may have additional relevant subtask data and which the user is not authorized to use (e.g., the user does not have a subscription to the data provider) may also be determined. In one implementation, an AIDD component may be utilized to determine additional relevant subtask data for the selected subtask (e.g., by the orchestration generative AI engine, by the subtask execution generative AI engine).

The selected subtask may be executed again using the corrective instructions, the next best performing subtask execution generative AI engine, the additional relevant subtask data, and/or the like corrective measures in a similar manner as discussed with regard to 2433.

Once acceptable subtask execution results are obtained for the subtasks for the task, subtask execution results may be composited into a task execution result via the orchestration LLM at 2461. In one embodiment, one of the subtask execution results may comprise the task execution result (e.g., a subtask execution result that utilized other subtask execution results as inputs). In another embodiment, a plurality of the subtask execution results may be combined to determine the task execution result (e.g., from multiple smaller subtasks processed in parallel). In another embodiment, the orchestration generative AI engine may utilize AI reasoning to determine the task execution result from the subtask execution results.

A determination may be made at 2465 whether to recommend an action to the user. In one embodiment, the task execution result and/or a subtask execution result may indicate that an action should be recommended to the user. If an action should be recommended to the user, the task execution result may be augmented with the recommended action at 2469. For example, a recommended action may be to rebalance the user's portfolio (e.g., based on information obtained during task execution regarding a digital asset in the user's portfolio). In another example, a recommended action may be to set up alerts regarding a digital asset (e.g., based on the frequency of the user's inquiries regarding the digital asset and/or volatility associated with the digital asset and/or presence of the digital asset in the user's portfolio). In another example, a recommended action may be to subscribe to a data provider (e.g., based on determining that the data provider's data would have been relevant during task execution but the user is not authorized to use the data provider's data). In one implementation, data corresponding to the recommended action (e.g., HTML formatted string(s) (e.g., with a message and/or a link), data field(s) (e.g., indicating that subscription to a specified data provider should be recommended)) may be inserted into a datastructure corresponding to the task execution result.

The task execution result may be provided to the requestor (e.g., the user) at 2473. For example, the task execution result may be provided in the form of a news summary, a trading strategy, a portfolio trading signal, and/or the like. In various embodiments, the task execution result may be provided via a GUI response, an email, an app notification, and/or the like. In one implementation, the task execution result may be provided to the requestor via an AI task processing response.

FIG. 25 shows non-limiting, example embodiments of a logic flow illustrating an AI data determining (AIDD) component for the AIDAC. In FIG. 25, an AI data determining request may be obtained at 2501. For example, the AI data determining request (e.g., an API call) may be obtained as a result of a request from an AITP component (e.g., an AI subtask processing request) to determine relevant (sub)task data for a (sub)task. It is to be understood that the AIDD component may be utilized to determine relevant data for a task or for a subtask.

Request parameters associated with the AI data determining request may be determined at 2505. For example, request parameters such as (sub)task type, (sub)task instructions, execution engine identifier, entity identifier, user identifier, and/or the like may be determined. In one implementation, the AI data determining request may be parsed (e.g., using PUP commands) to determine the request parameters (e.g., based on the values of the AI subtask processing request fields).

Relevant data providers for the (sub)task may be determined at 2509. In one embodiment, data providers and/or datasets for the (sub)task may be determined dynamically through function calling mechanisms available to an orchestration generative AI engine. In one implementation, various data providers accessible within the AIDAC may be exposed as callable functions within a predefined (e.g., JSON) schema function-calling framework, allowing the orchestration generative AI engine to request data from a specific data provider and/or a specific dataset from a data provider. In one embodiment, the orchestration generative AI engine may determine the relevant data providers for the (sub)task via dynamic reasoning about (sub)task execution. In one implementation, the orchestration generative AI engine may analyze names, descriptions, parameters, and/or the like of functions to determine a set of functions of the JSON schema corresponding to data providers that are likely to be relevant based on contextual input (e.g., (sub)task type, (sub)task instructions) and/or AI reasoning. In another embodiment, the orchestration generative AI engine may determine the relevant data providers for the (sub)task by analyzing an associated task template. In one implementation, the task template may specify relevant data providers for the (sub)task (e.g., a set of functions of the JSON schema corresponding to the relevant data providers). In some alternative embodiments, such determinations, analyses, requests, and/or the like may instead be performed by a subtask execution generative AI engine.

A determination may be made at 2513 whether there remain data providers to process. In one implementation, each of the relevant data providers (e.g., data providers, datasets) may be processed. If there remain data providers to process, the next data provider may be selected for processing at 2517. For example, a function of the JSON schema corresponding to the selected data provider may be called.

A determination may be made at 2521 whether a user associated with the AI data determining request (e.g., specified via the user identifier) is authorized to use the selected data provider's data. In one embodiment, data from the selected data provider may be accessible to any AIDAC user. In another embodiment, data from the selected data provider may be accessible to AIDAC users with a subscription to the the selected data provider (e.g., subscription to a specific data provider, subscription to a specific dataset). For example, the subscription may be specific to the user, to an entity (e.g., company, organization, and/or the like (e.g., specified via the entity identifier)) associated with the user, and/or the like. In one implementation, the user's data provider authorization data may be checked (e.g., via the function of the JSON schema corresponding to the selected data provider) to determine whether the user is authorized to use the selected data provider's data.

If the user is not authorized to use the selected data provider's data, the selected data provider may be added to a set of subscription recommendations at 2523. In one embodiment, the AIDAC may facilitate providing an optimal task execution result by alerting the user when data from a relevant data provider is not accessible to the user. In one implementation, an identifier of the selected data provider may be added to the set of subscription recommendations (e.g., an array). For example, the set of subscription recommendations may be utilized to inform the user regarding relevant data providers that are not accessible to the user and/or to allow the user to subscribe to data providers in the set of subscription recommendations. If the user chooses to subscribe to data providers in the set of subscription recommendations, the task may be executed again using data from additional data providers to provide an improved task execution result.

If the user is authorized to use the selected data provider's data, a determination may be made at 2525 whether historical data from the selected data provider is available. In one embodiment, historical data may be stored in a repository (e.g., a vector database storing embeddings) and the repository may be checked (e.g., via the function of the JSON schema corresponding to the selected data provider) to determine whether data from the selected data provider exists. If historical data from the selected data provider is available, relevant historical data from the selected data provider for the (sub)task may be determined at 2529. For example, market data, on-chain data, social data, and/or the like may be determined. In one implementation, contextual input (e.g., (sub)task type, (sub)task instructions) and/or AI reasoning may be utilized (e.g., via the function of the JSON schema corresponding to the selected data provider) to generate a query to a search service (e.g., Amazon OpenSearch Service) to determine and/or obtain relevant historical data (e.g., embeddings) from the selected data provider for the (sub)task.

A determination may be made at 2533 whether on-demand data from the selected data provider is available. In one embodiment, on-demand data may be obtained during (sub)task execution (e.g., in real time) from data providers that provide on-demand data. In one implementation, a configuration setting associated with the selected data provider may be checked to determine whether on-demand data is available. If on-demand data from the selected data provider is available, relevant on-demand data from the selected data provider for the (sub)task may be determined at 2537. For example, market data, on-chain data, social data, and/or the like may be determined. In one implementation, contextual input (e.g., (sub)task type, (sub)task instructions) may be utilized (e.g., via the function of the JSON schema corresponding to the selected data provider) to determine (e.g., via AI reasoning) and/or obtain (e.g., via scraping a website associated with the selected data provider, via an API call to the selected data provider) relevant on-demand data (e.g., converted into embeddings via a RAG service) from the selected data provider for the (sub)task.

A determination may be made at 2541 whether entity data for an entity associated with the user is available. For example, an entity may provide entity data (e.g., the user's digital asset portfolio data) to facilitate task execution (e.g., generating a trading strategy). In one embodiment, entity data may be stored in a repository (e.g., a vector database storing embeddings) and the repository may be checked to determine whether the entity data for the entity exists. In an alternative embodiment, user data may be utilized instead of entity data (e.g., for a user not associated with an entity).

If the entity data for the entity is available, a determination may be made at 2545 whether a subtask execution generative AI engine (e.g., execution LLM) for the (sub)task (e.g., specified via the execution engine identifier) is authorized to use the entity data for the entity. In one implementation, authorization settings associated with the entity data for the entity may be checked to determine whether the subtask execution generative AI engine is authorized to use the entity data for the entity. For example, the entity and/or the user may authorize the use of the entity data with some subtask execution generative AI engines (e.g., ZDR AI service providers), but not with other subtask execution generative AI engines.

If the subtask execution generative AI engine is authorized to use the entity data for the entity, entity data authorized for access by the user may be determined at 2549. For example, the user may be authorized to access shared entity data accessible to multiple users (e.g., having a specified role). In another example, the user may be authorized to access the user's data (e.g., the user's digital asset portfolio data), but not data of other users associated with the entity (e.g., other users' digital asset portfolio data). In one implementation, role-based authorization may be utilized to determine the entity data authorized for access by the user.

Relevant entity data for the (sub)task accessible by the user may be determined at 2553. In one implementation, the orchestration generative AI engine may generate, based on contextual input (e.g., (sub)task type, (sub)task instructions) and/or AI reasoning, to generate a query to a search service (e.g., Amazon OpenSearch Service) to determine and/or obtain relevant entity data for the (sub)task (e.g., embeddings) accessible by the user. For example, the user's digital asset portfolio data may be determined. In another example, a dataset of market data, on-chain data, social data, and/or the like proprietary to the entity may be determined.

The determined relevant data may be composited at 2561. In one embodiment, the determined relevant data may comprise relevant historical data from various relevant data providers, relevant on-demand data from various relevant data providers, relevant entity data, relevant user data, and/or the like. In one implementation, the determined relevant data may be obtained and/or composited into execution context data (e.g., prompt instructions to be provided to the subtask execution generative AI engine for the (sub)task). For example, the composited execution context data may comprise prompt instructions similar to the following:

### Execution Context Prompt Instructions

### Relevant Subtask Data

Historical ETH trading data for the last 30 days
On-demand social sentiment data regarding ETH
Portfolio ETH positions

The composited relevant data may be provided to the requestor at 2565. For example, the composited execution context data may be provided to the AITP component (e.g., via an API call response). In one implementation, the composited relevant data may be provided to the orchestration generative AI engine. In another implementation, the composited relevant data may be provided to the subtask execution generative AI engine.

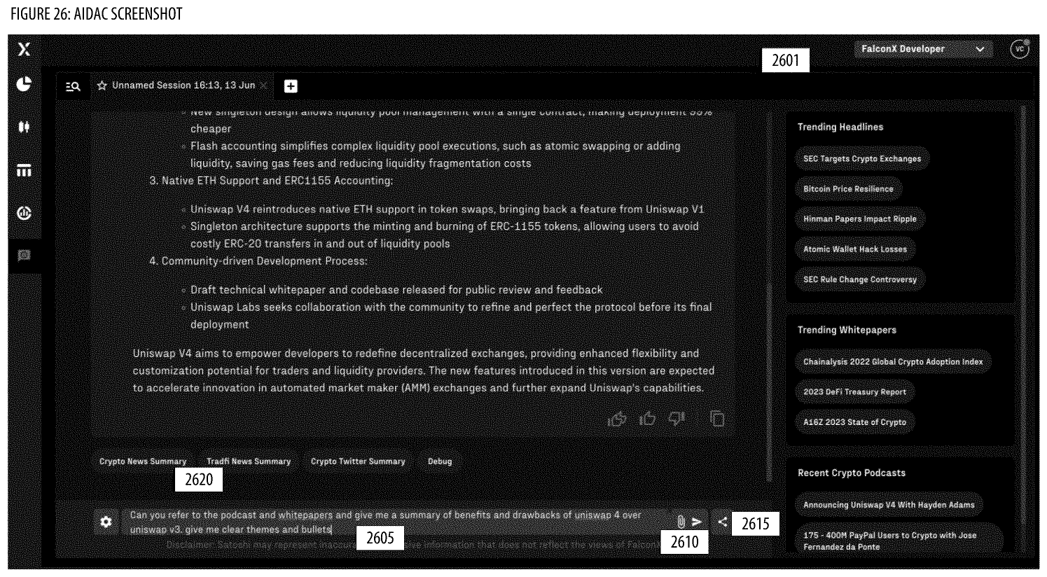

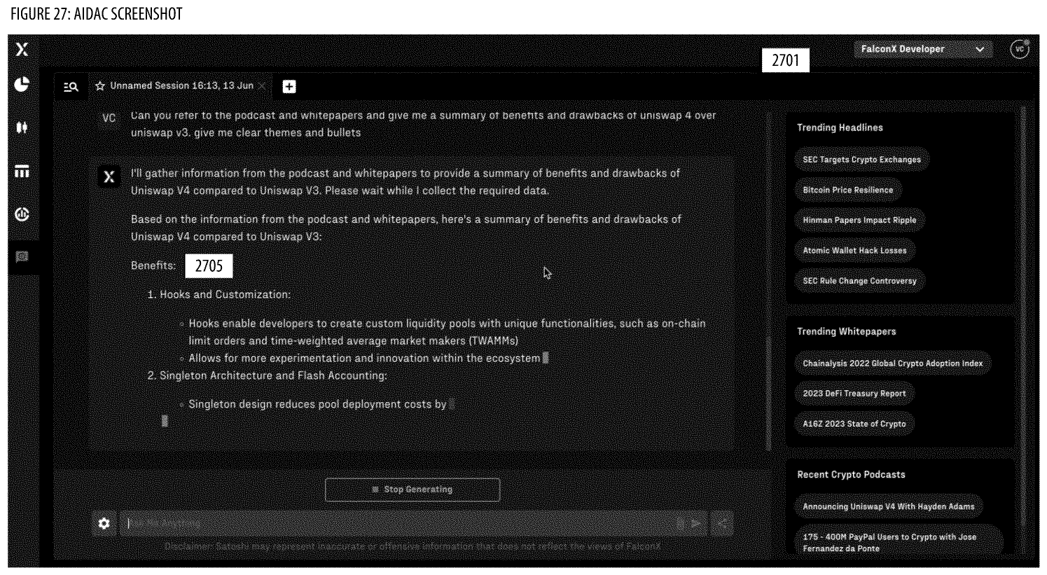

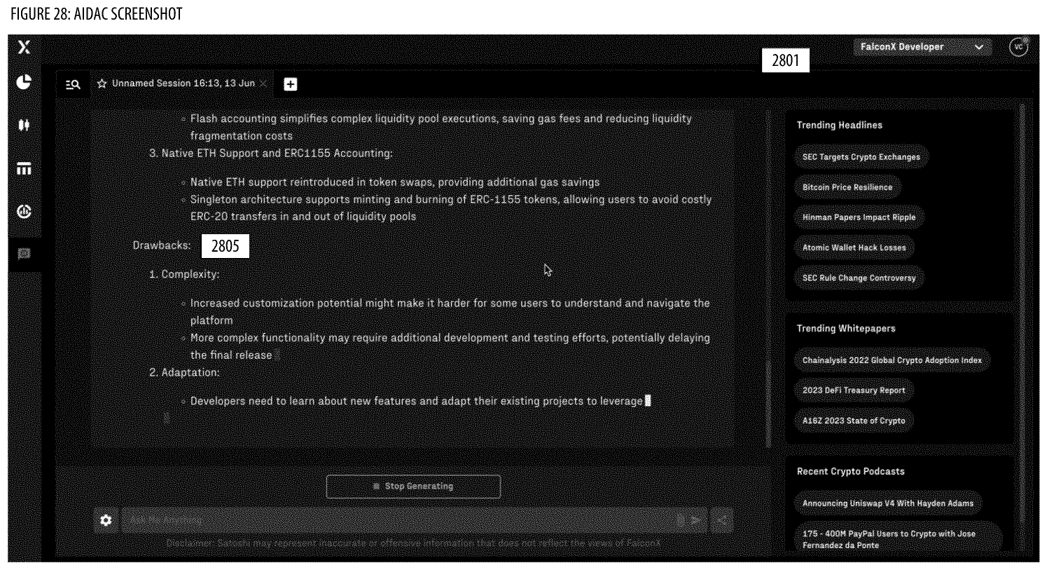

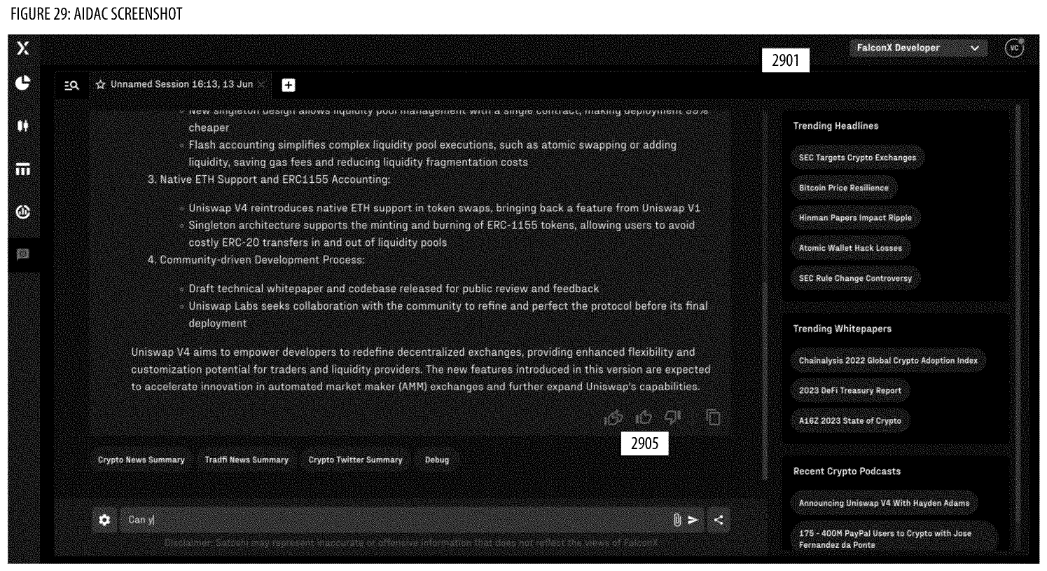

FIGS. 26-29 show non-limiting, example embodiments of a screenshot illustrating user interface(s) of the AIDAC. In FIGS. 26-29, an exemplary user interface (e.g., for a mobile device, for a website) that may be utilized by a user to request execution of a task via AI and/or to obtain an execution result is illustrated. Screen 2601 shows that the user may utilize a user prompt input widget 2605 to provide a free text user prompt specifying the task. The user may also provide relevant entity data and/or relevant user data via a relevant data attachment widget 2610 that allows the user to provide an attachment (e.g., a file to upload) and/or via a relevant data scraping widget 2615 that allows the user to specify a URI link (e.g., a webpage to scrape). In an alternative embodiment, the user may specify the task via one of the GUI command widgets 2620. In some implementations, a GUI command widget may correspond to a GUI command, which may be associated with a task template. Screen 2701 shows an execution result widget 2705 illustrating a first portion of the execution result (e.g., describing benefits). Screen 2801 shows an execution result widget 2805 illustrating a second portion of the execution result (e.g., describing drawbacks). Screen 2901 shows that the user may utilize one of the execution result feedback widgets 2905 to provide feedback regarding the execution result. In some implementations, the user's feedback may be utilized to improve execution result quality. For example, if the user liked (e.g., actuated thumbs up widget) or really liked (e.g., actuated double thumbs up widget) the execution result, rankings of performance of subtask execution generative AI engine(s) utilized to generate the execution result for their respective subtask(s) may be increased. In another example, if the user did not like (e.g., actuated thumbs down widget) the execution result, rankings of performance of subtask execution generative AI engine(s) utilized to generate the execution result for their respective subtask(s) may be decreased and/or the task may be executed again using alternative (e.g., next best performing) subtask execution generative AI engine(s).

FIG. 30 shows non-limiting, example embodiments of a screenshot illustrating user interface(s) of the AIDAC. In FIG. 30, an exemplary user interface (e.g., for a mobile device, for a website) showing a task execution result is illustrated. For example, such task execution result may be generated in response to a user's request to show ETF flows (e.g., specified via an ETF Flow command discussed with regard to FIG. 24 at 2409).

### Additional Alternative Embodiment Examples

The following alternative example embodiments provide a number of variations of some of the already discussed principles for expanded color on the abilities of the AIDAC.

Additional embodiments may include:

1. A temporal-quantum-limited asset caching apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions comprising:
   obtain an action guarantee temporal-quantum datastructure,
      in which the action guarantee temporal-quantum datastructure includes a value obtained from an administrative guarantee temporal-quantum user interface and a customer guarantee temporal-quantum preference datastructure;
   obtain a historic transaction attributes datastructure,
      in which the historic transaction attributes datastructure structured as including pricing and fill values;
   provide the historic transaction attributes datastructure to a temporal-fill machine learning engine,
      in which the fill machine learning engine generates structured temporal-fill parameters datastructures with the historic transaction attributes datastructure;
   obtain a user temporal-quantum-limited asset request datastructure from a temporal-quantum-limited asset request user interface;
   obtain temporal-fill parameters datastructures from the temporal-fill machine learning engine;
   query a quantum-limited asset cache with temporal-quantum-limited asset request datastructure and the temporal-fill parameters datastructures;
   provide temporal-fill asset datastructure to the temporal-quantum-limited asset request user interface,
      in which temporal-fill asset datastructure includes an asset identifier, and a temporal-quantum value,
      in which temporal-fill asset datastructure is structured as including a trigger for the temporal-quantum-limited asset request user interface,
      in which the temporal-quantum-limited asset request user interface is structured as employing the trigger for temporal-quantum-fill countdown user interface display element;
   obtain a temporal-fill asset request datastructure from the triggered temporal-quantum-limited asset request user interface,
   determine if temporal-fill asset request datastructure was obtained prior to expiration of the countdown user interface display element, and if obtainment was prior to the expiration, secure obtainment of an asset identified in the temporal-fill asset request datastructure.

2. The apparatus of embodiment 1, in which the asset identified in the temporal-fill asset request datastructure is secured from the quantum-limited asset cache.

3. A temporal-quantum-limited asset caching processor-readable, non-transient medium, the medium storing a component collection, the component collection storage structured with processor-executable instructions comprising:
obtain an action guarantee temporal-quantum datastructure,
   in which the action guarantee temporal-quantum datastructure includes a value obtained from an administrative guarantee temporal-quantum user interface and a customer guarantee temporal-quantum preference datastructure;
obtain a historic transaction attributes datastructure,
   in which the historic transaction attributes datastructure structured as including pricing and fill values;
provide the historic transaction attributes datastructure to a temporal-fill machine learning engine,
   in which the fill machine learning engine generates structured temporal-fill parameters datastructures with the historic transaction attributes datastructure;
obtain a user temporal-quantum-limited asset request datastructure from a temporal-quantum-limited asset request user interface;
obtain temporal-fill parameters datastructures from the temporal-fill machine learning engine;
query a quantum-limited asset cache with temporal-quantum-limited asset request datastructure and the temporal-fill parameters datastructures;
provide temporal-fill asset datastructure to the temporal-quantum-limited asset request user interface,
   in which temporal-fill asset datastructure includes an asset identifier, and a temporal-quantum value,
   in which temporal-fill asset datastructure is structured as including a trigger for the temporal-quantum-limited asset request user interface,
   in which the temporal-quantum-limited asset request user interface is structured as employing the trigger for temporal-quantum-fill countdown user interface display element;
obtain a temporal-fill asset request datastructure from the triggered temporal-quantum-limited asset request user interface,
determine if temporal-fill asset request datastructure was obtained prior to expiration of the countdown user interface display element, and if obtainment was prior to the expiration, secure obtainment of an asset identified in the temporal-fill asset request datastructure.

4. The medium of embodiment 3, in which the asset identified in the temporal-fill asset request datastructure is secured from the quantum-limited asset cache.

5. A temporal-quantum-limited asset caching processor-implemented system, comprising: means to store a component collection;
means to process processor-executable instructions from the component collection, the component collection storage structured with processor-executable instructions including:
   obtain an action guarantee temporal-quantum datastructure,
      in which the action guarantee temporal-quantum datastructure includes a value obtained from an administrative guarantee temporal-quantum user interface and a customer guarantee temporal-quantum preference datastructure;
   obtain a historic transaction attributes datastructure,
      in which the historic transaction attributes datastructure structured as including pricing and fill values;
   provide the historic transaction attributes datastructure to a temporal-fill machine learning engine,
      in which the fill machine learning engine generates structured temporal-fill parameters datastructures with the historic transaction attributes datastructure;
   obtain a user temporal-quantum-limited asset request datastructure from a temporal-quantum-limited asset request user interface;
   obtain temporal-fill parameters datastructures from the temporal-fill machine learning engine;
   query a quantum-limited asset cache with temporal-quantum-limited asset request datastructure and the temporal-fill parameters datastructures;
   provide temporal-fill asset datastructure to the temporal-quantum-limited asset request user interface,
      in which temporal-fill asset datastructure includes an asset identifier, and a temporal-quantum value,
      in which temporal-fill asset datastructure is structured as including a trigger for the temporal-quantum-limited asset request user interface,
      in which the temporal-quantum-limited asset request user interface is structured as employing the trigger for temporal-quantum-fill countdown user interface display element;
   obtain a temporal-fill asset request datastructure from the triggered temporal-quantum-limited asset request user interface,
   determine if temporal-fill asset request datastructure was obtained prior to expiration of the countdown user interface display element, and if obtainment was prior to the expiration, secure obtainment of an asset identified in the temporal-fill asset request datastructure.

6. The system of embodiment 5, in which the asset identified in the temporal-fill asset request datastructure is secured from the quantum-limited asset cache.

7. A temporal-quantum-limited asset caching process, including processing processor-executable instructions via at least one processor from a component collection stored in at least one memory, the component collection storage structured with processor-executable instructions comprising:
obtain an action guarantee temporal-quantum datastructure,
   in which the action guarantee temporal-quantum datastructure includes a value obtained from an administrative guarantee temporal-quantum user interface and a customer guarantee temporal-quantum preference datastructure;
obtain a historic transaction attributes datastructure,
   in which the historic transaction attributes datastructure structured as including pricing and fill values;
provide the historic transaction attributes datastructure to a temporal-fill machine learning engine,
   in which the fill machine learning engine generates structured temporal-fill parameters datastructures with the historic transaction attributes datastructure;
obtain a user temporal-quantum-limited asset request datastructure from a temporal-quantum-limited asset request user interface;
obtain temporal-fill parameters datastructures from the temporal-fill machine learning engine;
query a quantum-limited asset cache with temporal-quantum-limited asset request datastructure and the temporal-fill parameters datastructures;
provide temporal-fill asset datastructure to the temporal-quantum-limited asset request user interface,
   in which temporal-fill asset datastructure includes an asset identifier, and a temporal-quantum value,
   in which temporal-fill asset datastructure is structured as including a trigger for the temporal-quantum-limited asset request user interface,
   in which the temporal-quantum-limited asset request user interface is structured as employing the trigger for temporal-quantum-fill countdown user interface display element;
obtain a temporal-fill asset request datastructure from the triggered temporal-quantum-limited asset request user interface,
determine if temporal-fill asset request datastructure was obtained prior to expiration of the countdown user interface display element, and if obtainment was prior to the expiration, secure obtainment of an asset identified in the temporal-fill asset request datastructure.

8. The process of embodiment 7, in which the asset identified in the temporal-fill asset request datastructure is secured from the quantum-limited asset cache.

101. A temporal quantum limited asset fill user interface generating apparatus, comprising:
at least one memory;
a component collection stored in the at least one memory;
any of at least one processor disposed in communication with the at least one memory, the any of at least one processor executing processor-executable instructions from the component collection, storage of the component collection structured with processor-executable instructions comprising:
   obtain, via the any of at least one processor, a temporal quantum limited asset value request datastructure, in which the temporal quantum limited asset value request datastructure is structured as specifying an asset and an asset quantity;
   determine, via the any of at least one processor, a temporal quantum to utilize;
   obtain, via the any of at least one processor, a predicted temporal quantum asset value of the asset for the asset quantity after duration of the temporal quantum via a machine learning engine comprising a deep neural network;
   generate, via the any of at least one processor, a temporal quantum limited asset value datastructure structured as specifying a provided temporal quantum limited asset value of the asset determined from the predicted temporal quantum asset value of the asset and a provided temporal quantum duration determined from the duration of the temporal quantum; and
   provide, via the any of at least one processor, a temporal quantum limited asset fill user interface structured in accordance with the temporal quantum limited asset value datastructure, in which the temporal quantum limited asset fill user interface comprises:
      an asset value interaction interface mechanism that displays the provided temporal quantum limited asset value,
      a temporal quantum duration countdown interaction interface mechanism that displays a remaining duration of a countdown timer that expires once the provided temporal quantum duration elapses, and
      an asset fill trigger interaction interface mechanism that facilitates execution of an asset fill transaction at the provided temporal quantum limited asset value for the asset quantity, in which the asset fill trigger interaction interface mechanism is structured to be disabled upon expiration of the countdown timer.

102. The apparatus of embodiment 101, in which the asset is structured as specifying a primary asset identifier and a secondary asset identifier.

103. The apparatus of embodiment 101, in which the asset is structured as specifying a market identifier.

104. The apparatus of embodiment 101, in which the temporal quantum is specific to the asset.

105. The apparatus of embodiment 101, in which the temporal quantum is determined at least in part in accordance with the asset quantity.

106. The apparatus of embodiment 101, in which the predicted temporal quantum asset value of the asset is structured as comprising a predicted temporal quantum asset value to buy and a predicted temporal quantum asset value to sell.

107. The apparatus of embodiment 101, in which the instructions to obtain the predicted temporal quantum asset value of the asset are structured as instructions to:
provide, via the any of at least one processor, the asset, the asset quantity, and the temporal quantum via an input vector to the deep neural network; and
obtain, via the any of at least one processor, the predicted temporal quantum asset value of the asset via an output vector from the deep neural network.

108. The apparatus of embodiment 101, in which the provided temporal quantum limited asset value of the asset is equal to the predicted temporal quantum asset value of the asset.

109. The apparatus of embodiment 101, in which the provided temporal quantum limited asset value of the asset is determined by adjusting the predicted temporal quantum asset value of the asset via a set of rules in accordance with asset fill preferences of a user associated with the temporal quantum limited asset value request datastructure.

110. The apparatus of embodiment 101, in which the provided temporal quantum duration is equal to the duration of the temporal quantum.

111. The apparatus of embodiment 101, in which the provided temporal quantum duration is determined by adjusting the duration of the temporal quantum via a set of rules in accordance with asset fill preferences of a user associated with the temporal quantum limited asset value request datastructure.

112. The apparatus of embodiment 101, in which the provided temporal quantum limited asset value of the asset comprises a provided temporal quantum limited asset value to buy and a provided temporal quantum limited asset value to sell.

113. The apparatus of embodiment 112, in which the asset value interaction interface mechanism comprises an asset value to buy display region and an asset value to sell display region.

114. The apparatus of embodiment 101, in which the temporal quantum duration countdown interaction interface mechanism comprises a progress bar indicator.

115. The apparatus of embodiment 101, in which the temporal quantum limited asset fill user interface further comprises a primary asset selection interaction interface mechanism that facilitates selection of a primary asset subcomponent of the asset, in which the asset quantity is associated with the primary asset subcomponent of the asset.

116. A temporal quantum limited asset fill user interface generating processor-readable, non-transient medium, the medium storing a component collection, storage of the component collection structured with processor-executable instructions comprising:
obtain, via any of at least one processor, a temporal quantum limited asset value request datastructure, in which the temporal quantum limited asset value request datastructure is structured as specifying an asset and an asset quantity;
determine, via the any of at least one processor, a temporal quantum to utilize;
obtain, via the any of at least one processor, a predicted temporal quantum asset value of the asset for the asset quantity after duration of the temporal quantum via a machine learning engine comprising a deep neural network;
generate, via the any of at least one processor, a temporal quantum limited asset value datastructure structured as specifying a provided temporal quantum limited asset value of the asset determined from the predicted temporal quantum asset value of the asset and a provided temporal quantum duration determined from the duration of the temporal quantum; and
provide, via the any of at least one processor, a temporal quantum limited asset fill user interface structured in accordance with the temporal quantum limited asset value datastructure, in which the temporal quantum limited asset fill user interface comprises:
   an asset value interaction interface mechanism that displays the provided temporal quantum limited asset value,
   a temporal quantum duration countdown interaction interface mechanism that displays a remaining duration of a countdown timer that expires once the provided temporal quantum duration elapses, and
   an asset fill trigger interaction interface mechanism that facilitates execution of an asset fill transaction at the provided temporal quantum limited asset value for the asset quantity, in which the asset fill trigger interaction interface mechanism is structured to be disabled upon expiration of the countdown timer.

117. The medium of embodiment 116, in which the asset is structured as specifying a primary asset identifier and a secondary asset identifier.

118. The medium of embodiment 116, in which the asset is structured as specifying a market identifier.

119. The medium of embodiment 116, in which the temporal quantum is specific to the asset.

120. The medium of embodiment 116, in which the temporal quantum is determined at least in part in accordance with the asset quantity.

121. The medium of embodiment 116, in which the predicted temporal quantum asset value of the asset is structured as comprising a predicted temporal quantum asset value to buy and a predicted temporal quantum asset value to sell.

122. The medium of embodiment 116, in which the instructions to obtain the predicted temporal quantum asset value of the asset are structured as instructions to:
provide, via the any of at least one processor, the asset, the asset quantity, and the temporal quantum via an input vector to the deep neural network; and
obtain, via the any of at least one processor, the predicted temporal quantum asset value of the asset via an output vector from the deep neural network.

123. The medium of embodiment 116, in which the provided temporal quantum limited asset value of the asset is equal to the predicted temporal quantum asset value of the asset.

124. The medium of embodiment 116, in which the provided temporal quantum limited asset value of the asset is determined by adjusting the predicted temporal quantum asset value of the asset via a set of rules in accordance with asset fill preferences of a user associated with the temporal quantum limited asset value request datastructure.

125. The medium of embodiment 116, in which the provided temporal quantum duration is equal to the duration of the temporal quantum.

126. The medium of embodiment 116, in which the provided temporal quantum duration is determined by adjusting the duration of the temporal quantum via a set of rules in accordance with asset fill preferences of a user associated with the temporal quantum limited asset value request datastructure.

127. The medium of embodiment 116, in which the provided temporal quantum limited asset value of the asset comprises a provided temporal quantum limited asset value to buy and a provided temporal quantum limited asset value to sell.

128. The medium of embodiment 127, in which the asset value interaction interface mechanism comprises an asset value to buy display region and an asset value to sell display region.

129. The medium of embodiment 116, in which the temporal quantum duration countdown interaction interface mechanism comprises a progress bar indicator.

130. The medium of embodiment 116, in which the temporal quantum limited asset fill user interface further comprises a primary asset selection interaction interface mechanism that facilitates selection of a primary asset subcomponent of the asset, in which the asset quantity is associated with the primary asset subcomponent of the asset.

131. A temporal quantum limited asset fill user interface generating processor-implemented system, comprising:
means to store a component collection;
means to process processor-executable instructions from the component collection, storage of the component collection structured with processor-executable instructions comprising:
   obtain, via any of at least one processor, a temporal quantum limited asset value request datastructure, in which the temporal quantum limited asset value request datastructure is structured as specifying an asset and an asset quantity;
   determine, via the any of at least one processor, a temporal quantum to utilize;
   obtain, via the any of at least one processor, a predicted temporal quantum asset value of the asset for the asset quantity after duration of the temporal quantum via a machine learning engine comprising a deep neural network;
   generate, via the any of at least one processor, a temporal quantum limited asset value datastructure structured as specifying a provided temporal quantum limited asset value of the asset determined from the predicted temporal quantum asset value of the asset and a provided temporal quantum duration determined from the duration of the temporal quantum; and
   provide, via the any of at least one processor, a temporal quantum limited asset fill user interface structured in accordance with the temporal quantum limited asset value datastructure, in which the temporal quantum limited asset fill user interface comprises:
      an asset value interaction interface mechanism that displays the provided temporal quantum limited asset value,
      a temporal quantum duration countdown interaction interface mechanism that displays a remaining duration of a countdown timer that expires once the provided temporal quantum duration elapses, and
      an asset fill trigger interaction interface mechanism that facilitates execution of an asset fill transaction at the provided temporal quantum limited asset value for the asset quantity, in which the asset fill trigger interaction interface mechanism is structured to be disabled upon expiration of the countdown timer.

132. The system of embodiment 131, in which the asset is structured as specifying a primary asset identifier and a secondary asset identifier.

133. The system of embodiment 131, in which the asset is structured as specifying a market identifier.

134. The system of embodiment 131, in which the temporal quantum is specific to the asset.

135. The system of embodiment 131, in which the temporal quantum is determined at least in part in accordance with the asset quantity.

136. The system of embodiment 131, in which the predicted temporal quantum asset value of the asset is structured as comprising a predicted temporal quantum asset value to buy and a predicted temporal quantum asset value to sell.

137. The system of embodiment 131, in which the instructions to obtain the predicted temporal quantum asset value of the asset are structured as instructions to:
provide, via the any of at least one processor, the asset, the asset quantity, and the temporal quantum via an input vector to the deep neural network; and
obtain, via the any of at least one processor, the predicted temporal quantum asset value of the asset via an output vector from the deep neural network.

138. The system of embodiment 131, in which the provided temporal quantum limited asset value of the asset is equal to the predicted temporal quantum asset value of the asset.

139. The system of embodiment 131, in which the provided temporal quantum limited asset value of the asset is determined by adjusting the predicted temporal quantum asset value of the asset via a set of rules in accordance with asset fill preferences of a user associated with the temporal quantum limited asset value request datastructure.

140. The system of embodiment 131, in which the provided temporal quantum duration is equal to the duration of the temporal quantum.

141. The system of embodiment 131, in which the provided temporal quantum duration is determined by adjusting the duration of the temporal quantum via a set of rules in accordance with asset fill preferences of a user associated with the temporal quantum limited asset value request datastructure.

142. The system of embodiment 131, in which the provided temporal quantum limited asset value of the asset comprises a provided temporal quantum limited asset value to buy and a provided temporal quantum limited asset value to sell.

143. The system of embodiment 142, in which the asset value interaction interface mechanism comprises an asset value to buy display region and an asset value to sell display region.

144. The system of embodiment 131, in which the temporal quantum duration countdown interaction interface mechanism comprises a progress bar indicator.

145. The system of embodiment 131, in which the temporal quantum limited asset fill user interface further comprises a primary asset selection interaction interface mechanism that facilitates selection of a primary asset subcomponent of the asset, in which the asset quantity is associated with the primary asset subcomponent of the asset.

146. A temporal quantum limited asset fill user interface generating processor-implemented process, including processing processor-executable instructions via any of at least one processor from a component collection stored in at least one memory, storage of the component collection structured with processor-executable instructions comprising:
obtain, via any of at least one processor, a temporal quantum limited asset value request datastructure, in which the temporal quantum limited asset value request datastructure is structured as specifying an asset and an asset quantity;
determine, via the any of at least one processor, a temporal quantum to utilize;
obtain, via the any of at least one processor, a predicted temporal quantum asset value of the asset for the asset quantity after duration of the temporal quantum via a machine learning engine comprising a deep neural network;
generate, via the any of at least one processor, a temporal quantum limited asset value datastructure structured as specifying a provided temporal quantum limited asset value of the asset determined from the predicted temporal quantum asset value of the asset and a provided temporal quantum duration determined from the duration of the temporal quantum; and
provide, via the any of at least one processor, a temporal quantum limited asset fill user interface structured in accordance with the temporal quantum limited asset value datastructure, in which the temporal quantum limited asset fill user interface comprises:
   an asset value interaction interface mechanism that displays the provided temporal quantum limited asset value,
   a temporal quantum duration countdown interaction interface mechanism that displays a remaining duration of a countdown timer that expires once the provided temporal quantum duration elapses, and
   an asset fill trigger interaction interface mechanism that facilitates execution of an asset fill transaction at the provided temporal quantum limited asset value for the asset quantity, in which the asset fill trigger interaction interface mechanism is structured to be disabled upon expiration of the countdown timer.

147. The process of embodiment 146, in which the asset is structured as specifying a primary asset identifier and a secondary asset identifier.

148. The process of embodiment 146, in which the asset is structured as specifying a market identifier.

149. The process of embodiment 146, in which the temporal quantum is specific to the asset.

150. The process of embodiment 146, in which the temporal quantum is determined at least in part in accordance with the asset quantity.

151. The process of embodiment 146, in which the predicted temporal quantum asset value of the asset is structured as comprising a predicted temporal quantum asset value to buy and a predicted temporal quantum asset value to sell.

152. The process of embodiment 146, in which the instructions to obtain the predicted temporal quantum asset value of the asset are structured as instructions to:
provide, via the any of at least one processor, the asset, the asset quantity, and the temporal quantum via an input vector to the deep neural network; and
obtain, via the any of at least one processor, the predicted temporal quantum asset value of the asset via an output vector from the deep neural network.

153. The process of embodiment 146, in which the provided temporal quantum limited asset value of the asset is equal to the predicted temporal quantum asset value of the asset.

154. The process of embodiment 146, in which the provided temporal quantum limited asset value of the asset is determined by adjusting the predicted temporal quantum asset value of the asset via a set of rules in accordance with asset fill preferences of a user associated with the temporal quantum limited asset value request datastructure.

155. The process of embodiment 146, in which the provided temporal quantum duration is equal to the duration of the temporal quantum.

156. The process of embodiment 146, in which the provided temporal quantum duration is determined by adjusting the duration of the temporal quantum via a set of rules in accordance with asset fill preferences of a user associated with the temporal quantum limited asset value request datastructure.

157. The process of embodiment 146, in which the provided temporal quantum limited asset value of the asset comprises a provided temporal quantum limited asset value to buy and a provided temporal quantum limited asset value to sell.

158. The process of embodiment 157, in which the asset value interaction interface mechanism comprises an asset value to buy display region and an asset value to sell display region.

159. The process of embodiment 146, in which the temporal quantum duration countdown interaction interface mechanism comprises a progress bar indicator.

160. The process of embodiment 146, in which the temporal quantum limited asset fill user interface further comprises a primary asset selection interaction interface mechanism that facilitates selection of a primary asset subcomponent of the asset, in which the asset quantity is associated with the primary asset subcomponent of the asset.

201. A temporal quantum asset values predicting machine learning engine training apparatus, comprising:
at least one memory;
a component collection stored in the at least one memory;
any of at least one processor disposed in communication with the at least one memory, the any of at least one processor executing processor-executable instructions from the component collection, storage of the component collection structured with processor-executable instructions comprising:
   obtain, via the any of at least one processor, a machine learning (ML) engine training request datastructure, in which the ML engine training request datastructure is structured as specifying a set of assets;
   determine, via the any of at least one processor, for each respective asset in the set of assets, a plurality of asset quantity levels associated with the respective asset and a temporal quantum associated with the respective asset;
   generate, via the any of at least one processor, for each respective sample interval of a sample duration comprising a plurality of sample intervals, a time series input vector capturing asset value movements, for each respective asset in the set of assets, across each of the plurality of asset quantity levels associated with the respective asset over duration of the temporal quantum associated with the respective asset for the respective sample interval;
   train, via the any of at least one processor, a temporal features ML prediction logic data structure via a temporal features training set comprising the generated time series input vectors capturing asset value movements, in which the temporal features ML prediction logic data structure is trained to generate a hidden state output vector;
   train, via the any of at least one processor, a temporal quantum asset value predicting ML prediction logic data structure via a temporal quantum asset value predicting training set comprising the hidden state output vector integrated with a set of additional static inputs, in which the temporal quantum asset value predicting ML prediction logic data structure is trained to predict a temporal quantum asset value of each respective asset in the set of assets over duration of the temporal quantum associated with the respective asset; and
   store, via the any of at least one processor, the trained temporal quantum asset value predicting ML prediction logic data structure.

202. The apparatus of embodiment 201, in which each respective asset in the set of assets is structured as specifying a primary asset identifier associated with the respective asset and a secondary asset identifier associated with the respective asset.

203. The apparatus of embodiment 201, in which each respective asset in the set of assets is structured as specifying a market identifier associated with the respective asset.

204. The apparatus of embodiment 201, in which the instructions to determine a plurality of asset quantity levels associated with an asset are structured as instructions to:
obtain, via the any of at least one processor, historic transaction execution data via a set of historic transaction attributes datastructures comprising asset value data and asset quantity data for previously executed transactions;
divide, via the any of at least one processor, the historic transaction execution data into a specified number of buckets; and
determine, via the any of at least one processor, a representative asset quantity level for each respective bucket by calculating a measure of central tendency associated with each bucket; and
determine, via the any of at least one processor, the plurality of asset quantity levels associated with the asset as the determined representative asset quantity levels.

205. The apparatus of embodiment 204, in which the storage of the component collection is further structured with processor-executable instructions comprising:
remove, via the any of at least one processor, outliers associated with the historic transaction execution data prior to dividing the historic transaction execution data into buckets.

206. The apparatus of embodiment 204, in which the storage of the component collection is further structured with processor-executable instructions comprising:
round, via the any of at least one processor, each calculated measure of central tendency associated with each bucket to a nearest specified multiple.

207. The apparatus of embodiment 201, in which the instructions to determine a plurality of asset quantity levels associated with an asset are structured as instructions to retrieve the plurality of asset quantity levels associated with the asset from a cache.

208. The apparatus of embodiment 201, in which a temporal quantum associated with an asset is specific to the asset.

209. The apparatus of embodiment 201, in which a temporal quantum associated with an asset is shared by the set of assets.

210. The apparatus of embodiment 201, in which a time series input vector separately captures asset value movements for each respective liquidity venue in a set of available liquidity venues for an asset.

211. The apparatus of embodiment 201, in which the temporal features ML prediction logic data structure corresponds to a recurrent neural network (RNN).

212. The apparatus of embodiment 211, in which the recurrent neural network is a Long Short-Term Memory (LSTM) RNN.

213. The apparatus of embodiment 201, in which the temporal quantum asset value predicting ML prediction logic data structure corresponds to a deep neural network (DNN).

214. The apparatus of embodiment 201, in which the set of additional static inputs comprises liquidity venue identifiers.

215. The apparatus of embodiment 201, in which a predicted temporal quantum asset value of an asset is structured as comprising a predicted temporal quantum asset value to buy and a predicted temporal quantum asset value to sell.

216. A temporal quantum asset values predicting machine learning engine training processor-readable, non-transient medium, the medium storing a component collection, storage of the component collection structured with processor-executable instructions comprising:
obtain, via any of at least one processor, a machine learning (ML) engine training request datastructure, in which the ML engine training request datastructure is structured as specifying a set of assets;
determine, via the any of at least one processor, for each respective asset in the set of assets, a plurality of asset quantity levels associated with the respective asset and a temporal quantum associated with the respective asset;
generate, via the any of at least one processor, for each respective sample interval of a sample duration comprising a plurality of sample intervals, a time series input vector capturing asset value movements, for each respective asset in the set of assets, across each of the plurality of asset quantity levels associated with the respective asset over duration of the temporal quantum associated with the respective asset for the respective sample interval;
train, via the any of at least one processor, a temporal features ML prediction logic data structure via a temporal features training set comprising the generated time series input vectors capturing asset value movements, in which the temporal features ML prediction logic data structure is trained to generate a hidden state output vector;
train, via the any of at least one processor, a temporal quantum asset value predicting ML prediction logic data structure via a temporal quantum asset value predicting training set comprising the hidden state output vector integrated with a set of additional static inputs, in which the temporal quantum asset value predicting ML prediction logic data structure is trained to predict a temporal quantum asset value of each respective asset in the set of assets over duration of the temporal quantum associated with the respective asset; and
store, via the any of at least one processor, the trained temporal quantum asset value predicting ML prediction logic data structure.

217. The medium of embodiment 216, in which each respective asset in the set of assets is structured as specifying a primary asset identifier associated with the respective asset and a secondary asset identifier associated with the respective asset.

218. The medium of embodiment 216, in which each respective asset in the set of assets is structured as specifying a market identifier associated with the respective asset.

219. The medium of embodiment 216, in which the instructions to determine a plurality of asset quantity levels associated with an asset are structured as instructions to:
obtain, via the any of at least one processor, historic transaction execution data via a set of historic transaction attributes datastructures comprising asset value data and asset quantity data for previously executed transactions;
divide, via the any of at least one processor, the historic transaction execution data into a specified number of buckets; and
determine, via the any of at least one processor, a representative asset quantity level for each respective bucket by calculating a measure of central tendency associated with each bucket; and
determine, via the any of at least one processor, the plurality of asset quantity levels associated with the asset as the determined representative asset quantity levels.

220. The medium of embodiment 219, in which the storage of the component collection is further structured with processor-executable instructions comprising:
remove, via the any of at least one processor, outliers associated with the historic transaction execution data prior to dividing the historic transaction execution data into buckets.

221. The medium of embodiment 219, in which the storage of the component collection is further structured with processor-executable instructions comprising:
round, via the any of at least one processor, each calculated measure of central tendency associated with each bucket to a nearest specified multiple.

222. The medium of embodiment 216, in which the instructions to determine a plurality of asset quantity levels associated with an asset are structured as instructions to retrieve the plurality of asset quantity levels associated with the asset from a cache.

223. The medium of embodiment 216, in which a temporal quantum associated with an asset is specific to the asset.

224. The medium of embodiment 216, in which a temporal quantum associated with an asset is shared by the set of assets.

225. The medium of embodiment 216, in which a time series input vector separately captures asset value movements for each respective liquidity venue in a set of available liquidity venues for an asset.

226. The medium of embodiment 216, in which the temporal features ML prediction logic data structure corresponds to a recurrent neural network (RNN).

227. The medium of embodiment 226, in which the recurrent neural network is a Long Short-Term Memory (LSTM) RNN.

228. The medium of embodiment 216, in which the temporal quantum asset value predicting ML prediction logic data structure corresponds to a deep neural network (DNN).

229. The medium of embodiment 216, in which the set of additional static inputs comprises liquidity venue identifiers.

230. The medium of embodiment 216, in which a predicted temporal quantum asset value of an asset is structured as comprising a predicted temporal quantum asset value to buy and a predicted temporal quantum asset value to sell.

231. A temporal quantum asset values predicting machine learning engine training processor-implemented system, comprising:
means to store a component collection;
means to process processor-executable instructions from the component collection, storage of the component collection structured with processor-executable instructions comprising:
   obtain, via any of at least one processor, a machine learning (ML) engine training request datastructure, in which the ML engine training request datastructure is structured as specifying a set of assets;
   determine, via the any of at least one processor, for each respective asset in the set of assets, a plurality of asset quantity levels associated with the respective asset and a temporal quantum associated with the respective asset;
   generate, via the any of at least one processor, for each respective sample interval of a sample duration comprising a plurality of sample intervals, a time series input vector capturing asset value movements, for each respective asset in the set of assets, across each of the plurality of asset quantity levels associated with the respective asset over duration of the temporal quantum associated with the respective asset for the respective sample interval;
   train, via the any of at least one processor, a temporal features ML prediction logic data structure via a temporal features training set comprising the generated time series input vectors capturing asset value movements, in which the temporal features ML prediction logic data structure is trained to generate a hidden state output vector;
   train, via the any of at least one processor, a temporal quantum asset value predicting ML prediction logic data structure via a temporal quantum asset value predicting training set comprising the hidden state output vector integrated with a set of additional static inputs, in which the temporal quantum asset value predicting ML prediction logic data structure is trained to predict a temporal quantum asset value of each respective asset in the set of assets over duration of the temporal quantum associated with the respective asset; and
   store, via the any of at least one processor, the trained temporal quantum asset value predicting ML prediction logic data structure.

232. The system of embodiment 231, in which each respective asset in the set of assets is structured as specifying a primary asset identifier associated with the respective asset and a secondary asset identifier associated with the respective asset.

233. The system of embodiment 231, in which each respective asset in the set of assets is structured as specifying a market identifier associated with the respective asset.

234. The system of embodiment 231, in which the instructions to determine a plurality of asset quantity levels associated with an asset are structured as instructions to:
obtain, via the any of at least one processor, historic transaction execution data via a set of historic transaction attributes datastructures comprising asset value data and asset quantity data for previously executed transactions;
divide, via the any of at least one processor, the historic transaction execution data into a specified number of buckets; and
determine, via the any of at least one processor, a representative asset quantity level for each respective bucket by calculating a measure of central tendency associated with each bucket; and
determine, via the any of at least one processor, the plurality of asset quantity levels associated with the asset as the determined representative asset quantity levels.

235. The system of embodiment 234, in which the storage of the component collection is further structured with processor-executable instructions comprising:
remove, via the any of at least one processor, outliers associated with the historic transaction execution data prior to dividing the historic transaction execution data into buckets.

236. The system of embodiment 234, in which the storage of the component collection is further structured with processor-executable instructions comprising:
round, via the any of at least one processor, each calculated measure of central tendency associated with each bucket to a nearest specified multiple.

237. The system of embodiment 231, in which the instructions to determine a plurality of asset quantity levels associated with an asset are structured as instructions to retrieve the plurality of asset quantity levels associated with the asset from a cache.

238. The system of embodiment 231, in which a temporal quantum associated with an asset is specific to the asset.

239. The system of embodiment 231, in which a temporal quantum associated with an asset is shared by the set of assets.

240. The system of embodiment 231, in which a time series input vector separately captures asset value movements for each respective liquidity venue in a set of available liquidity venues for an asset.

241. The system of embodiment 231, in which the temporal features ML prediction logic data structure corresponds to a recurrent neural network (RNN).

242. The system of embodiment 241, in which the recurrent neural network is a Long Short-Term Memory (LSTM) RNN.

243. The system of embodiment 231, in which the temporal quantum asset value predicting ML prediction logic data structure corresponds to a deep neural network (DNN).

244. The system of embodiment 231, in which the set of additional static inputs comprises liquidity venue identifiers.

245. The system of embodiment 231, in which a predicted temporal quantum asset value of an asset is structured as comprising a predicted temporal quantum asset value to buy and a predicted temporal quantum asset value to sell.

246. A temporal quantum asset values predicting machine learning engine training processor-implemented process, including processing processor-executable instructions via any of at least one processor from a component collection stored in at least one memory, storage of the component collection structured with processor-executable instructions comprising:
obtain, via any of at least one processor, a machine learning (ML) engine training request datastructure, in which the ML engine training request datastructure is structured as specifying a set of assets;
determine, via the any of at least one processor, for each respective asset in the set of assets, a plurality of asset quantity levels associated with the respective asset and a temporal quantum associated with the respective asset;
generate, via the any of at least one processor, for each respective sample interval of a sample duration comprising a plurality of sample intervals, a time series input vector capturing asset value movements, for each respective asset in the set of assets, across each of the plurality of asset quantity levels associated with the respective asset over duration of the temporal quantum associated with the respective asset for the respective sample interval;
train, via the any of at least one processor, a temporal features ML prediction logic data structure via a temporal features training set comprising the generated time series input vectors capturing asset value movements, in which the temporal features ML prediction logic data structure is trained to generate a hidden state output vector;
train, via the any of at least one processor, a temporal quantum asset value predicting ML prediction logic data structure via a temporal quantum asset value predicting training set comprising the hidden state output vector integrated with a set of additional static inputs, in which the temporal quantum asset value predicting ML prediction logic data structure is trained to predict a temporal quantum asset value of each respective asset in the set of assets over duration of the temporal quantum associated with the respective asset; and
store, via the any of at least one processor, the trained temporal quantum asset value predicting ML prediction logic data structure.

247. The process of embodiment 246, in which each respective asset in the set of assets is structured as specifying a primary asset identifier associated with the respective asset and a secondary asset identifier associated with the respective asset.

248. The process of embodiment 246, in which each respective asset in the set of assets is structured as specifying a market identifier associated with the respective asset.

249. The process of embodiment 246, in which the instructions to determine a plurality of asset quantity levels associated with an asset are structured as instructions to:
obtain, via the any of at least one processor, historic transaction execution data via a set of historic transaction attributes datastructures comprising asset value data and asset quantity data for previously executed transactions;
divide, via the any of at least one processor, the historic transaction execution data into a specified number of buckets; and
determine, via the any of at least one processor, a representative asset quantity level for each respective bucket by calculating a measure of central tendency associated with each bucket; and
determine, via the any of at least one processor, the plurality of asset quantity levels associated with the asset as the determined representative asset quantity levels.

250. The process of embodiment 249, in which the storage of the component collection is further structured with processor-executable instructions comprising:
remove, via the any of at least one processor, outliers associated with the historic transaction execution data prior to dividing the historic transaction execution data into buckets.

251. The process of embodiment 249, in which the storage of the component collection is further structured with processor-executable instructions comprising:
round, via the any of at least one processor, each calculated measure of central tendency associated with each bucket to a nearest specified multiple.

252. The process of embodiment 246, in which the instructions to determine a plurality of asset quantity levels associated with an asset are structured as instructions to retrieve the plurality of asset quantity levels associated with the asset from a cache.

253. The process of embodiment 246, in which a temporal quantum associated with an asset is specific to the asset.

254. The process of embodiment 246, in which a temporal quantum associated with an asset is shared by the set of assets.

255. The process of embodiment 246, in which a time series input vector separately captures asset value movements for each respective liquidity venue in a set of available liquidity venues for an asset.

256. The process of embodiment 246, in which the temporal features ML prediction logic data structure corresponds to a recurrent neural network (RNN).

257. The process of embodiment 256, in which the recurrent neural network is a Long Short-Term Memory (LSTM) RNN.

258. The process of embodiment 246, in which the temporal quantum asset value predicting ML prediction logic data structure corresponds to a deep neural network (DNN).

259. The process of embodiment 246, in which the set of additional static inputs comprises liquidity venue identifiers.

260. The process of embodiment 246, in which a predicted temporal quantum asset value of an asset is structured as comprising a predicted temporal quantum asset value to buy and a predicted temporal quantum asset value to sell.

301. An AI task processing apparatus, comprising:
at least one memory;
a component collection stored in the at least one memory;
any of at least one processor disposed in communication with the at least one memory, the any of at least one processor executing processor-executable instructions from the component collection, storage of the component collection structured with processor-executable instructions comprising:
   obtain, via the any of at least one processor, a task processing request datastructure, in which the task processing request datastructure is structured as specifying task instructions for a task;
   determine, via the any of at least one processor, a set of subtasks for the task by analyzing the task instructions via an orchestration generative AI engine, in which a subtask corresponds to a function specified via a predefined schema incorporated into an execution context of the orchestration generative AI engine;
   determine, via the any of at least one processor, via the orchestration artificial intelligence engine, for each respective subtask in the set of subtasks, a subtask execution generative AI engine to utilize for the respective subtask;
   determine, via the any of at least one processor, via the orchestration artificial intelligence engine, for each respective subtask in the set of subtasks, a relevant subtask dataset for the respective subtask, in which the relevant subtask dataset for the respective subtask is incorporated into an execution context of the subtask execution generative AI engine to utilize for the respective subtask;
   obtain, via the any of at least one processor, via the orchestration artificial intelligence engine, for each respective subtask in the set of subtasks, a subtask execution result for the respective subtask from the subtask execution generative AI engine to utilize for the respective subtask;
   evaluate, via the any of at least one processor, via the orchestration artificial intelligence engine, for each respective subtask in the set of subtasks, acceptability of the subtask execution result for the respective subtask; and
   composite, via the any of at least one processor, via the orchestration artificial intelligence engine, a task execution result for the task via one or more of the obtained subtask execution results.

302. The apparatus of embodiment 301, in which the task instructions comprise a free text user prompt.

303. The apparatus of embodiment 301, in which the task instructions comprise one of: a GUI command, a CLI command, an API command.

304. The apparatus of embodiment 301, in which the instructions to determine the set of subtasks for the task further comprise instructions to:
determine, via the any of at least one processor, a task template associated with the task; and
in which the set of subtasks for the task is determined via the task template.

305. The apparatus of embodiment 301, in which the instructions to determine the subtask execution generative AI engine to utilize for the respective subtask are structured as instructions to determine a best performing subtask execution generative AI engine for a function corresponding to the respective subtask.

306. The apparatus of embodiment 301, in which the instructions to determine the subtask execution generative AI engine to utilize for the respective subtask are structured as instructions to determine a plurality of subtask execution generative AI engines to utilize in parallel for the respective subtask.

307. The apparatus of embodiment 301, in which a relevant subtask dataset comprises relevant historical data, relevant on-demand data, and relevant entity data associated with an entity or a user specified via the task processing request datastructure.

308. The apparatus of embodiment 301, in which the instructions to obtain the subtask execution result for the respective subtask further comprise instructions to provide subtask execution instructions generated via the orchestration generative AI engine to the subtask execution generative AI engine to utilize for the respective subtask.

309. The apparatus of embodiment 301, in which the instructions to obtain the subtask execution result for the respective subtask further comprise instructions to provide subtask execution instructions, specified via a function of the predefined schema corresponding to the respective subtask, to the subtask execution generative AI engine to utilize for the respective subtask.

310. The apparatus of embodiment 301, in which the acceptability of a subtask execution result is evaluated via one or more of AI reasoning, validation mechanisms, structured checks.

311. The apparatus of embodiment 301, in which the instructions to evaluate acceptability of the subtask execution result for the respective subtask further comprise instructions to determine via the orchestration generative AI engine corrective measures for the respective subtask upon determining that the subtask execution result for the respective subtask is not acceptable.

312. The apparatus of embodiment 311, in which the corrective measures for the respective subtask comprise corrective instructions to utilize for the subtask execution generative AI engine to utilize for the respective subtask.

313. The apparatus of embodiment 311, in which the corrective measures for the respective subtask comprise a selection of another subtask execution generative AI engine to utilize for the respective subtask.

314. The apparatus of embodiment 311, in which the corrective measures for the respective subtask comprise obtaining an additional relevant subtask dataset for the respective subtask.

315. The apparatus of embodiment 301, in which the storage of the component collection is further structured with processor-executable instructions comprising:
augment, via the any of at least one processor, via the orchestration artificial intelligence engine, the task execution result for the task with a recommended action determined via analysis of the task execution result.

316. An AI task processing processor-readable, non-transient medium, the medium storing a component collection, storage of the component collection structured with processor-executable instructions comprising:
obtain, via any of at least one processor, a task processing request datastructure, in which the task processing request datastructure is structured as specifying task instructions for a task;
determine, via the any of at least one processor, a set of subtasks for the task by analyzing the task instructions via an orchestration generative AI engine, in which a subtask corresponds to a function specified via a predefined schema incorporated into an execution context of the orchestration generative AI engine;
determine, via the any of at least one processor, via the orchestration artificial intelligence engine, for each respective subtask in the set of subtasks, a subtask execution generative AI engine to utilize for the respective subtask;
determine, via the any of at least one processor, via the orchestration artificial intelligence engine, for each respective subtask in the set of subtasks, a relevant subtask dataset for the respective subtask, in which the relevant subtask dataset for the respective subtask is incorporated into an execution context of the subtask execution generative AI engine to utilize for the respective subtask;
obtain, via the any of at least one processor, via the orchestration artificial intelligence engine, for each respective subtask in the set of subtasks, a subtask execution result for the respective subtask from the subtask execution generative AI engine to utilize for the respective subtask;
evaluate, via the any of at least one processor, via the orchestration artificial intelligence engine, for each respective subtask in the set of subtasks, acceptability of the subtask execution result for the respective subtask; and
composite, via the any of at least one processor, via the orchestration artificial intelligence engine, a task execution result for the task via one or more of the obtained subtask execution results.

317. The medium of embodiment 316, in which the task instructions comprise a free text user prompt.

318. The medium of embodiment 316, in which the task instructions comprise one of: a GUI command, a CLI command, an API command.

319. The medium of embodiment 316, in which the instructions to determine the set of subtasks for the task further comprise instructions to:
determine, via the any of at least one processor, a task template associated with the task; and
in which the set of subtasks for the task is determined via the task template.

320. The medium of embodiment 316, in which the instructions to determine the subtask execution generative AI engine to utilize for the respective subtask are structured as instructions to determine a best performing subtask execution generative AI engine for a function corresponding to the respective subtask.

321. The medium of embodiment 316, in which the instructions to determine the subtask execution generative AI engine to utilize for the respective subtask are structured as instructions to determine a plurality of subtask execution generative AI engines to utilize in parallel for the respective subtask.

322. The medium of embodiment 316, in which a relevant subtask dataset comprises relevant historical data, relevant on-demand data, and relevant entity data associated with an entity or a user specified via the task processing request datastructure.

323. The medium of embodiment 316, in which the instructions to obtain the subtask execution result for the respective subtask further comprise instructions to provide subtask execution instructions generated via the orchestration generative AI engine to the subtask execution generative AI engine to utilize for the respective subtask.

324. The medium of embodiment 316, in which the instructions to obtain the subtask execution result for the respective subtask further comprise instructions to provide subtask execution instructions, specified via a function of the predefined schema corresponding to the respective subtask, to the subtask execution generative AI engine to utilize for the respective subtask.

325. The medium of embodiment 316, in which the acceptability of a subtask execution result is evaluated via one or more of AI reasoning, validation mechanisms, structured checks.

326. The medium of embodiment 316, in which the instructions to evaluate acceptability of the subtask execution result for the respective subtask further comprise instructions to determine via the orchestration generative AI engine corrective measures for the respective subtask upon determining that the subtask execution result for the respective subtask is not acceptable.

327. The medium of embodiment 326, in which the corrective measures for the respective subtask comprise corrective instructions to utilize for the subtask execution generative AI engine to utilize for the respective subtask.

328. The medium of embodiment 326, in which the corrective measures for the respective subtask comprise a selection of another subtask execution generative AI engine to utilize for the respective subtask.

329. The medium of embodiment 326, in which the corrective measures for the respective subtask comprise obtaining an additional relevant subtask dataset for the respective subtask.

330. The medium of embodiment 316, in which the storage of the component collection is further structured with processor-executable instructions comprising:
augment, via the any of at least one processor, via the orchestration artificial intelligence engine, the task execution result for the task with a recommended action determined via analysis of the task execution result.

331. An AI task processing processor-implemented system, comprising:
means to store a component collection;
means to process processor-executable instructions from the component collection, storage of the component collection structured with processor-executable instructions comprising:
   obtain, via any of at least one processor, a task processing request datastructure, in which the task processing request datastructure is structured as specifying task instructions for a task;
   determine, via the any of at least one processor, a set of subtasks for the task by analyzing the task instructions via an orchestration generative AI engine, in which a subtask corresponds to a function specified via a predefined schema incorporated into an execution context of the orchestration generative AI engine;
   determine, via the any of at least one processor, via the orchestration artificial intelligence engine, for each respective subtask in the set of subtasks, a subtask execution generative AI engine to utilize for the respective subtask;
   determine, via the any of at least one processor, via the orchestration artificial intelligence engine, for each respective subtask in the set of subtasks, a relevant subtask dataset for the respective subtask, in which the relevant subtask dataset for the respective subtask is incorporated into an execution context of the subtask execution generative AI engine to utilize for the respective subtask;
   obtain, via the any of at least one processor, via the orchestration artificial intelligence engine, for each respective subtask in the set of subtasks, a subtask execution result for the respective subtask from the subtask execution generative AI engine to utilize for the respective subtask;
   evaluate, via the any of at least one processor, via the orchestration artificial intelligence engine, for each respective subtask in the set of subtasks, acceptability of the subtask execution result for the respective subtask; and
   composite, via the any of at least one processor, via the orchestration artificial intelligence engine, a task execution result for the task via one or more of the obtained subtask execution results.

332. The system of embodiment 331, in which the task instructions comprise a free text user prompt.

333. The system of embodiment 331, in which the task instructions comprise one of: a GUI command, a CLI command, an API command.

334. The system of embodiment 331, in which the instructions to determine the set of subtasks for the task further comprise instructions to:
determine, via the any of at least one processor, a task template associated with the task; and
in which the set of subtasks for the task is determined via the task template.

335. The system of embodiment 331, in which the instructions to determine the subtask execution generative AI engine to utilize for the respective subtask are structured as instructions to determine a best performing subtask execution generative AI engine for a function corresponding to the respective subtask.

336. The system of embodiment 331, in which the instructions to determine the subtask execution generative AI engine to utilize for the respective subtask are structured as instructions to determine a plurality of subtask execution generative AI engines to utilize in parallel for the respective subtask.

337. The system of embodiment 331, in which a relevant subtask dataset comprises relevant historical data, relevant on-demand data, and relevant entity data associated with an entity or a user specified via the task processing request datastructure.

338. The system of embodiment 331, in which the instructions to obtain the subtask execution result for the respective subtask further comprise instructions to provide subtask execution instructions generated via the orchestration generative AI engine to the subtask execution generative AI engine to utilize for the respective subtask.

339. The system of embodiment 331, in which the instructions to obtain the subtask execution result for the respective subtask further comprise instructions to provide subtask execution instructions, specified via a function of the predefined schema corresponding to the respective subtask, to the subtask execution generative AI engine to utilize for the respective subtask.

340. The system of embodiment 331, in which the acceptability of a subtask execution result is evaluated via one or more of AI reasoning, validation mechanisms, structured checks.

341. The system of embodiment 331, in which the instructions to evaluate acceptability of the subtask execution result for the respective subtask further comprise instructions to determine via the orchestration generative AI engine corrective measures for the respective subtask upon determining that the subtask execution result for the respective subtask is not acceptable.

342. The system of embodiment 341, in which the corrective measures for the respective subtask comprise corrective instructions to utilize for the subtask execution generative AI engine to utilize for the respective subtask.

343. The system of embodiment 341, in which the corrective measures for the respective subtask comprise a selection of another subtask execution generative AI engine to utilize for the respective subtask.

344. The system of embodiment 341, in which the corrective measures for the respective subtask comprise obtaining an additional relevant subtask dataset for the respective subtask.

345. The system of embodiment 331, in which the storage of the component collection is further structured with processor-executable instructions comprising:
augment, via the any of at least one processor, via the orchestration artificial intelligence engine, the task execution result for the task with a recommended action determined via analysis of the task execution result.

346. An AI task processing processor-implemented process, including processing processor-executable instructions via any of at least one processor from a component collection stored in at least one memory, storage of the component collection structured with processor-executable instructions comprising:
obtain, via any of at least one processor, a task processing request datastructure, in which the task processing request datastructure is structured as specifying task instructions for a task;
determine, via the any of at least one processor, a set of subtasks for the task by analyzing the task instructions via an orchestration generative AI engine, in which a subtask corresponds to a function specified via a predefined schema incorporated into an execution context of the orchestration generative AI engine;
determine, via the any of at least one processor, via the orchestration artificial intelligence engine, for each respective subtask in the set of subtasks, a subtask execution generative AI engine to utilize for the respective subtask;
determine, via the any of at least one processor, via the orchestration artificial intelligence engine, for each respective subtask in the set of subtasks, a relevant subtask dataset for the respective subtask, in which the relevant subtask dataset for the respective subtask is incorporated into an execution context of the subtask execution generative AI engine to utilize for the respective subtask;
obtain, via the any of at least one processor, via the orchestration artificial intelligence engine, for each respective subtask in the set of subtasks, a subtask execution result for the respective subtask from the subtask execution generative AI engine to utilize for the respective subtask;
evaluate, via the any of at least one processor, via the orchestration artificial intelligence engine, for each respective subtask in the set of subtasks, acceptability of the subtask execution result for the respective subtask; and
composite, via the any of at least one processor, via the orchestration artificial intelligence engine, a task execution result for the task via one or more of the obtained subtask execution results.

347. The process of embodiment 346, in which the task instructions comprise a free text user prompt.

348. The process of embodiment 346, in which the task instructions comprise one of: a GUI command, a CLI command, an API command.

349. The process of embodiment 346, in which the instructions to determine the set of subtasks for the task further comprise instructions to:
determine, via the any of at least one processor, a task template associated with the task; and
in which the set of subtasks for the task is determined via the task template.

350. The process of embodiment 346, in which the instructions to determine the subtask execution generative AI engine to utilize for the respective subtask are structured as instructions to determine a best performing subtask execution generative AI engine for a function corresponding to the respective subtask.

351. The process of embodiment 346, in which the instructions to determine the subtask execution generative AI engine to utilize for the respective subtask are structured as instructions to determine a plurality of subtask execution generative AI engines to utilize in parallel for the respective subtask.

352. The process of embodiment 346, in which a relevant subtask dataset comprises relevant historical data, relevant on-demand data, and relevant entity data associated with an entity or a user specified via the task processing request datastructure.

353. The process of embodiment 346, in which the instructions to obtain the subtask execution result for the respective subtask further comprise instructions to provide subtask execution instructions generated via the orchestration generative AI engine to the subtask execution generative AI engine to utilize for the respective subtask.

354. The process of embodiment 346, in which the instructions to obtain the subtask execution result for the respective subtask further comprise instructions to provide subtask execution instructions, specified via a function of the predefined schema corresponding to the respective subtask, to the subtask execution generative AI engine to utilize for the respective subtask.

355. The process of embodiment 346, in which the acceptability of a subtask execution result is evaluated via one or more of AI reasoning, validation mechanisms, structured checks.

356. The process of embodiment 346, in which the instructions to evaluate acceptability of the subtask execution result for the respective subtask further comprise instructions to determine via the orchestration generative AI engine corrective measures for the respective subtask upon determining that the subtask execution result for the respective subtask is not acceptable.

357. The process of embodiment 356, in which the corrective measures for the respective subtask comprise corrective instructions to utilize for the subtask execution generative AI engine to utilize for the respective subtask.

358. The process of embodiment 356, in which the corrective measures for the respective subtask comprise a selection of another subtask execution generative AI engine to utilize for the respective subtask.

359. The process of embodiment 356, in which the corrective measures for the respective subtask comprise obtaining an additional relevant subtask dataset for the respective subtask.

360. The process of embodiment 346, in which the storage of the component collection is further structured with processor-executable instructions comprising:
augment, via the any of at least one processor, via the orchestration artificial intelligence engine, the task execution result for the task with a recommended action determined via analysis of the task execution result.

401. An AI task data determining apparatus, comprising:
at least one memory;
a component collection stored in the at least one memory;
any of at least one processor disposed in communication with the at least one memory, the any of at least one processor executing processor-executable instructions from the component collection, storage of the component collection structured with processor-executable instructions comprising:
   obtain, via the any of at least one processor, an AI data determining request datastructure, in which the AI data determining request datastructure is structured as specifying task instructions for a task;
   determine, via the any of at least one processor, a set of relevant data providers for the task by analyzing the task instructions via an orchestration generative AI engine, in which a data provider corresponds to a function specified via a predefined schema incorporated into an execution context of the orchestration generative AI engine;
   retrieve, via the any of at least one processor, via the orchestration artificial intelligence engine, for each respective relevant data provider in the set of relevant data providers, relevant historical data from the respective data provider via the function corresponding to the respective relevant data provider;
   obtain, via the any of at least one processor, via the orchestration artificial intelligence engine, for each respective relevant data provider in the set of relevant data providers, relevant on-demand data from the respective data provider via the function corresponding to the respective relevant data provider;
   verify, via the any of at least one processor, that a subtask execution generative AI engine for the task is authorized to use entity data associated with an entity or a user specified via the AI data determining request datastructure;
   obtain, via the any of at least one processor, via the orchestration artificial intelligence engine, relevant entity data accessible by the user; and
   composite, via the any of at least one processor, via the orchestration artificial intelligence engine, execution context data for the task from the retrieved relevant historical data, the obtained relevant on-demand data, and the obtained relevant entity data.

402. The apparatus of embodiment 401, in which the task is a subtask of another task.

403. The apparatus of embodiment 401, in which a data provider is one of: a data provider entity, a dataset.

404. The apparatus of embodiment 401, in which the orchestration generative AI engine is implemented via one of: a large language model, a foundation model.

405. The apparatus of embodiment 401, in which the instructions to determine the set of relevant data providers for the task further comprise instructions to:
determine, via the any of at least one processor, a task template associated with the task; and
in which the set of relevant data providers for the task is determined via the task template.

406. The apparatus of embodiment 401, in which the storage of the component collection is further structured with processor-executable instructions comprising:
determine, via the any of at least one processor, that the user specified via the AI data determining request datastructure is not authorized to use a relevant data provider; and
add, via the any of at least one processor, an identifier of the relevant data provider to a set of subscription recommendations.

407. The apparatus of embodiment 401, in which the instructions to retrieve relevant historical data from the respective data provider are structured as instructions to retrieve embeddings corresponding to the relevant historical data from a vector database.

408. The apparatus of embodiment 401, in which the instructions to obtain relevant on-demand data from the respective data provider are structured as instructions to:
scrape, via the any of at least one processor, raw on-demand data via a URI associated with the respective data provider; and
convert, via the any of at least one processor, the raw on-demand data into embeddings via a retrieval-augmented generation service.

409. The apparatus of embodiment 401, in which the instructions to obtain relevant entity data are structured as instructions to retrieve embeddings corresponding to the relevant entity data from a vector database.

410. The apparatus of embodiment 409, in which the instructions to retrieve embeddings corresponding to the relevant entity data are structured as instructions to analyze the task instructions via AI reasoning of the orchestration generative AI engine to generate a search query to a search service associated with the vector database.

411. The apparatus of embodiment 401, in which the instructions to obtain relevant entity data are structured as instructions to:
obtain, via the any of at least one processor, raw entity data via an attachment or a URI supplied by the user; and
convert, via the any of at least one processor, the raw entity data into embeddings via a retrieval-augmented generation service.

412. The apparatus of embodiment 401, in which the relevant entity data comprises the user's digital asset portfolio data.

413. The apparatus of embodiment 401, in which the execution context data for the task comprises prompt instructions provided to the orchestration generative AI engine.

414. The apparatus of embodiment 401, in which the execution context data for the task comprises prompt instructions provided to the subtask execution generative AI engine.

415. The apparatus of embodiment 401, in which the subtask execution generative AI engine is implemented via one of: a large language model, a foundation model.

416. An AI task data determining processor-readable, non-transient medium, the medium storing a component collection, storage of the component collection structured with processor-executable instructions comprising:
obtain, via any of at least one processor, an AI data determining request datastructure, in which the AI data determining request datastructure is structured as specifying task instructions for a task;
determine, via the any of at least one processor, a set of relevant data providers for the task by analyzing the task instructions via an orchestration generative AI engine, in which a data provider corresponds to a function specified via a predefined schema incorporated into an execution context of the orchestration generative AI engine;
retrieve, via the any of at least one processor, via the orchestration artificial intelligence engine, for each respective relevant data provider in the set of relevant data providers, relevant historical data from the respective data provider via the function corresponding to the respective relevant data provider;
obtain, via the any of at least one processor, via the orchestration artificial intelligence engine, for each respective relevant data provider in the set of relevant data providers, relevant on-demand data from the respective data provider via the function corresponding to the respective relevant data provider;
verify, via the any of at least one processor, that a subtask execution generative AI engine for the task is authorized to use entity data associated with an entity or a user specified via the AI data determining request datastructure;
obtain, via the any of at least one processor, via the orchestration artificial intelligence engine, relevant entity data accessible by the user; and
composite, via the any of at least one processor, via the orchestration artificial intelligence engine, execution context data for the task from the retrieved relevant historical data, the obtained relevant on-demand data, and the obtained relevant entity data.

417. The medium of embodiment 416, in which the task is a subtask of another task.

418. The medium of embodiment 416, in which a data provider is one of: a data provider entity, a dataset.

419. The medium of embodiment 416, in which the orchestration generative AI engine is implemented via one of: a large language model, a foundation model.

420. The medium of embodiment 416, in which the instructions to determine the set of relevant data providers for the task further comprise instructions to:
determine, via the any of at least one processor, a task template associated with the task; and
in which the set of relevant data providers for the task is determined via the task template.

421. The medium of embodiment 416, in which the storage of the component collection is further structured with processor-executable instructions comprising:
determine, via the any of at least one processor, that the user specified via the AI data determining request datastructure is not authorized to use a relevant data provider; and
add, via the any of at least one processor, an identifier of the relevant data provider to a set of subscription recommendations.

422. The medium of embodiment 416, in which the instructions to retrieve relevant historical data from the respective data provider are structured as instructions to retrieve embeddings corresponding to the relevant historical data from a vector database.

423. The medium of embodiment 416, in which the instructions to obtain relevant on-demand data from the respective data provider are structured as instructions to:
scrape, via the any of at least one processor, raw on-demand data via a URI associated with the respective data provider; and
convert, via the any of at least one processor, the raw on-demand data into embeddings via a retrieval-augmented generation service.

424. The medium of embodiment 416, in which the instructions to obtain relevant entity data are structured as instructions to retrieve embeddings corresponding to the relevant entity data from a vector database.

425. The medium of embodiment 424, in which the instructions to retrieve embeddings corresponding to the relevant entity data are structured as instructions to analyze the task instructions via AI reasoning of the orchestration generative AI engine to generate a search query to a search service associated with the vector database.

426. The medium of embodiment 416, in which the instructions to obtain relevant entity data are structured as instructions to:
obtain, via the any of at least one processor, raw entity data via an attachment or a URI supplied by the user; and
convert, via the any of at least one processor, the raw entity data into embeddings via a retrieval-augmented generation service.

427. The medium of embodiment 416, in which the relevant entity data comprises the user's digital asset portfolio data.

428. The medium of embodiment 416, in which the execution context data for the task comprises prompt instructions provided to the orchestration generative AI engine.

429. The medium of embodiment 416, in which the execution context data for the task comprises prompt instructions provided to the subtask execution generative AI engine.

430. The medium of embodiment 416, in which the subtask execution generative AI engine is implemented via one of: a large language model, a foundation model.

431. An AI task data determining processor-implemented system, comprising:
means to store a component collection;
means to process processor-executable instructions from the component collection, storage of the component collection structured with processor-executable instructions comprising:
   obtain, via any of at least one processor, an AI data determining request datastructure, in which the AI data determining request datastructure is structured as specifying task instructions for a task;
   determine, via the any of at least one processor, a set of relevant data providers for the task by analyzing the task instructions via an orchestration generative AI engine, in which a data provider corresponds to a function specified via a predefined schema incorporated into an execution context of the orchestration generative AI engine;
   retrieve, via the any of at least one processor, via the orchestration artificial intelligence engine, for each respective relevant data provider in the set of relevant data providers, relevant historical data from the respective data provider via the function corresponding to the respective relevant data provider;
   obtain, via the any of at least one processor, via the orchestration artificial intelligence engine, for each respective relevant data provider in the set of relevant data providers, relevant on-demand data from the respective data provider via the function corresponding to the respective relevant data provider;
   verify, via the any of at least one processor, that a subtask execution generative AI engine for the task is authorized to use entity data associated with an entity or a user specified via the AI data determining request datastructure;
   obtain, via the any of at least one processor, via the orchestration artificial intelligence engine, relevant entity data accessible by the user; and
   composite, via the any of at least one processor, via the orchestration artificial intelligence engine, execution context data for the task from the retrieved relevant historical data, the obtained relevant on-demand data, and the obtained relevant entity data.

432. The system of embodiment 431, in which the task is a subtask of another task.

433. The system of embodiment 431, in which a data provider is one of: a data provider entity, a dataset.

434. The system of embodiment 431, in which the orchestration generative AI engine is implemented via one of: a large language model, a foundation model.

435. The system of embodiment 431, in which the instructions to determine the set of relevant data providers for the task further comprise instructions to:
determine, via the any of at least one processor, a task template associated with the task; and
in which the set of relevant data providers for the task is determined via the task template.

436. The system of embodiment 431, in which the storage of the component collection is further structured with processor-executable instructions comprising:
determine, via the any of at least one processor, that the user specified via the AI data determining request datastructure is not authorized to use a relevant data provider; and
add, via the any of at least one processor, an identifier of the relevant data provider to a set of subscription recommendations.

437. The system of embodiment 431, in which the instructions to retrieve relevant historical data from the respective data provider are structured as instructions to retrieve embeddings corresponding to the relevant historical data from a vector database.

438. The system of embodiment 431, in which the instructions to obtain relevant on-demand data from the respective data provider are structured as instructions to:
scrape, via the any of at least one processor, raw on-demand data via a URI associated with the respective data provider; and
convert, via the any of at least one processor, the raw on-demand data into embeddings via a retrieval-augmented generation service.

439. The system of embodiment 431, in which the instructions to obtain relevant entity data are structured as instructions to retrieve embeddings corresponding to the relevant entity data from a vector database.

440. The system of embodiment 439, in which the instructions to retrieve embeddings corresponding to the relevant entity data are structured as instructions to analyze the task instructions via AI reasoning of the orchestration generative AI engine to generate a search query to a search service associated with the vector database.

441. The system of embodiment 431, in which the instructions to obtain relevant entity data are structured as instructions to:
obtain, via the any of at least one processor, raw entity data via an attachment or a URI supplied by the user; and
convert, via the any of at least one processor, the raw entity data into embeddings via a retrieval-augmented generation service.

442. The system of embodiment 431, in which the relevant entity data comprises the user's digital asset portfolio data.

443. The system of embodiment 431, in which the execution context data for the task comprises prompt instructions provided to the orchestration generative AI engine.

444. The system of embodiment 431, in which the execution context data for the task comprises prompt instructions provided to the subtask execution generative AI engine.

445. The system of embodiment 431, in which the subtask execution generative AI engine is implemented via one of: a large language model, a foundation model.

446. An AI task data determining processor-implemented process, including processing processor-executable instructions via any of at least one processor from a component collection stored in at least one memory, storage of the component collection structured with processor-executable instructions comprising:
obtain, via any of at least one processor, an AI data determining request datastructure, in which the AI data determining request datastructure is structured as specifying task instructions for a task;
determine, via the any of at least one processor, a set of relevant data providers for the task by analyzing the task instructions via an orchestration generative AI engine, in which a data provider corresponds to a function specified via a predefined schema incorporated into an execution context of the orchestration generative AI engine;
retrieve, via the any of at least one processor, via the orchestration artificial intelligence engine, for each respective relevant data provider in the set of relevant data providers, relevant historical data from the respective data provider via the function corresponding to the respective relevant data provider;
obtain, via the any of at least one processor, via the orchestration artificial intelligence engine, for each respective relevant data provider in the set of relevant data providers, relevant on-demand data from the respective data provider via the function corresponding to the respective relevant data provider;
verify, via the any of at least one processor, that a subtask execution generative AI engine for the task is authorized to use entity data associated with an entity or a user specified via the AI data determining request datastructure;
obtain, via the any of at least one processor, via the orchestration artificial intelligence engine, relevant entity data accessible by the user; and
composite, via the any of at least one processor, via the orchestration artificial intelligence engine, execution context data for the task from the retrieved relevant historical data, the obtained relevant on-demand data, and the obtained relevant entity data.

447. The process of embodiment 446, in which the task is a subtask of another task.

448. The process of embodiment 446, in which a data provider is one of: a data provider entity, a dataset.

449. The process of embodiment 446, in which the orchestration generative AI engine is implemented via one of: a large language model, a foundation model.

450. The process of embodiment 446, in which the instructions to determine the set of relevant data providers for the task further comprise instructions to:
determine, via the any of at least one processor, a task template associated with the task; and
in which the set of relevant data providers for the task is determined via the task template.

451. The process of embodiment 446, in which the storage of the component collection is further structured with processor-executable instructions comprising:
determine, via the any of at least one processor, that the user specified via the AI data determining request datastructure is not authorized to use a relevant data provider; and
add, via the any of at least one processor, an identifier of the relevant data provider to a set of subscription recommendations.

452. The process of embodiment 446, in which the instructions to retrieve relevant historical data from the respective data provider are structured as instructions to retrieve embeddings corresponding to the relevant historical data from a vector database.

453. The process of embodiment 446, in which the instructions to obtain relevant on-demand data from the respective data provider are structured as instructions to:
scrape, via the any of at least one processor, raw on-demand data via a URI associated with the respective data provider; and
convert, via the any of at least one processor, the raw on-demand data into embeddings via a retrieval-augmented generation service.

454. The process of embodiment 446, in which the instructions to obtain relevant entity data are structured as instructions to retrieve embeddings corresponding to the relevant entity data from a vector database.

455. The process of embodiment 454, in which the instructions to retrieve embeddings corresponding to the relevant entity data are structured as instructions to analyze the task instructions via AI reasoning of the orchestration generative AI engine to generate a search query to a search service associated with the vector database.

456. The process of embodiment 446, in which the instructions to obtain relevant entity data are structured as instructions to:
obtain, via the any of at least one processor, raw entity data via an attachment or a URI supplied by the user; and
convert, via the any of at least one processor, the raw entity data into embeddings via a retrieval-augmented generation service.

457. The process of embodiment 446, in which the relevant entity data comprises the user's digital asset portfolio data.

458. The process of embodiment 446, in which the execution context data for the task comprises prompt instructions provided to the orchestration generative AI engine.

459. The process of embodiment 446, in which the execution context data for the task comprises prompt instructions provided to the subtask execution generative AI engine.

460. The process of embodiment 446, in which the subtask execution generative AI engine is implemented via one of: a large language model, a foundation model.

### AIDAC Controller

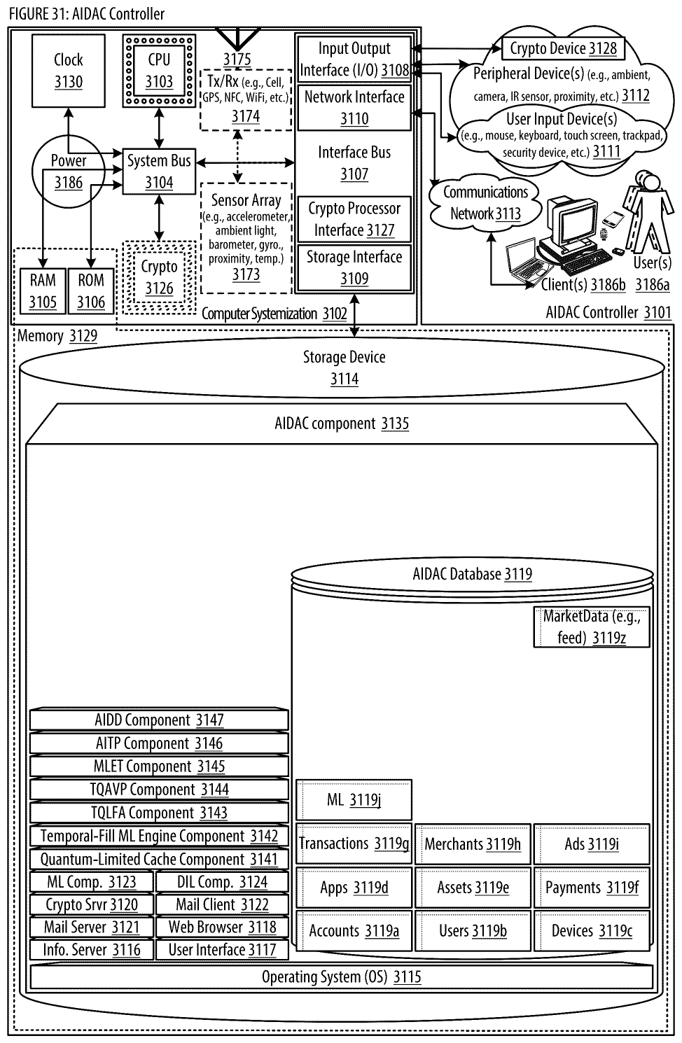

FIG. 31 shows a block diagram illustrating non-limiting, example embodiments of a AIDAC controller. In this embodiment, the AIDAC controller 3101 may serve to aggregate, process, store, search, serve, identify, instruct, generate, match, and/or facilitate interactions with a computer through artificial intelligence systems technologies, and/or other related data.

Users, which may be people and/or other systems, may engage information technology systems (e.g., computers) to facilitate information processing. In turn, computers employ processors to process information; such processors 3103 may be referred to as central processing units (CPU). One form of processor is referred to as a microprocessor. CPUs use communicative circuits to pass binary encoded signals acting as instructions to allow various operations. These instructions may be operational and/or data instructions containing and/or referencing other instructions and data in various processor accessible and operable areas of memory 3129 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the AIDAC controller 3101 may be connected to and/or communicate with entities such as, but not limited to any of: one or more users from peripheral devices 3112 (e.g., user input devices 3111); an optional cryptographic processor device 3128; and/or a communications network 3113.

Networks comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is referred to as a “node.” Networks are generally thought to facilitate the transfer of information from source points to destinations. A node specifically tasked with furthering the passage of information from a source to a destination is called a “router.” There are many forms of networks such as Local Area Networks (LANs), Pico networks, Wide Area Networks (WANs), Wireless Networks (WLANs), etc. For example, the Internet is, generally, an interconnection of a multitude of networks whereby remote clients and servers may access and interoperate with one another.

The AIDAC controller 3101 may be based on computer systems that may comprise, but are not limited to, components such as any of: a computer systemization 3102 connected to memory 3129.

### Computer Systemization

A computer systemization 3102 may comprise a clock 3130, central processing unit (“CPU(s)” and/or “processor(s)” (these terms are used interchangeably throughout the disclosure unless noted to the contrary)) 3103, a memory 3129 (e.g., a read only memory (ROM) 3106, a random access memory (RAM) 3105, etc.), and/or an interface bus 3107, and most frequently, although not necessarily, are all interconnected and/or communicating through a system bus 3104 on one or more (mother)board(s) 3102 having conductive and/or otherwise transportive circuit pathways through which instructions (e.g., binary encoded signals) may travel to effectuate communications, operations, storage, etc. The computer systemization may be connected to a power source 3186; e.g., optionally the power source may be internal. Optionally, a cryptographic processor 3126 may be connected to the system bus. In another embodiment, the cryptographic processor, transceivers (e.g., ICs) 3174, and/or sensor array (e.g., any of: accelerometer, altimeter, ambient light, barometer, global positioning system (GPS) (thereby allowing AIDAC controller to determine its location), gyroscope, magnetometer, pedometer, proximity, ultra-violet sensor, etc.) 3173 may be connected as either internal and/or external peripheral devices 3112 via the interface bus I/O 3108 (not pictured) and/or directly via the interface bus 3107. In turn, the transceivers may be connected to antenna(s) 3175, thereby effectuating wireless transmission and reception of various communication and/or sensor protocols; for example the antenna(s) may connect to various transceiver chipsets (depending on deployment needs), including any of. Broadcom® BCM4329FKUBG transceiver chip (e.g., providing 802.11n, Bluetooth® 2.1+EDR, FM, etc.); a Broadcom® BCM4752 GPS receiver with accelerometer, altimeter, GPS, gyroscope, magnetometer; a Broadcom® BCM4335 transceiver chip (e.g., providing 2G, 3G, and 4G long-term evolution (LTE) cellular communications; 802.1 lac, Bluetooth® 4.0 low energy (LE) (e.g., beacon features)); a Broadcom® BCM43341 transceiver chip (e.g., providing 2G, 3G and 4G LTE cellular communications; 802.11g, Bluetooth® 4.0, near field communication (NFC), FM radio); an Infineon Technologies® X-Gold 618-PMB9800 transceiver chip (e.g., providing 2G/3G HSDPA/HSUPA communications); a MediaTek® MT6620 transceiver chip (e.g., providing 802.11n (also known as WiFi® in numerous iterations), Bluetooth® 4.0 LE, FM, GPS; a Lapis Semiconductor® ML8511 UV sensor; a Maxim Integrated® MAX44000 ambient light and infrared proximity sensor; a Texas Instruments® WiLink® WL1283 transceiver chip (e.g., providing 802.11n, Bluetooth® 3.0, FM, GPS); and/or the like. The system clock may have a crystal oscillator and generates a base signal through the computer systemization's circuit pathways. The clock may be coupled to the system bus and various clock multipliers that may increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to any of: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks®), netbooks, tablets (e.g., Android®, iPads®, and Windows® tablets, etc.), mobile smartphones (e.g., Android®, iPhones®, Nokia®, Palm® and Windows® phones, etc.), wearable device(s) (e.g., headsets (e.g., Apple AirPods (Pro)®, glasses, goggles (e.g., Apple Vision Pro®, Google Glass®), watches, etc.), and/or the like. Often, the processors themselves may incorporate various specialized processing units, such as, but not limited to any of: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 3129 beyond the processor itself, internal memory may include, but is not limited to any of: fast registers, various levels of cache memory (e.g., level 1, 2, 3, etc.), (dynamic/static) RAM, solid state memory, etc. The processor may access this memory through the use of a memory address space that is accessible via instruction address, which the processor can construct and decode allowing it to access a circuit path to a specific memory address space having a memory state. The CPU may be a microprocessor such as: AMD's® Athlon®, Duron® and/or Opteron®; Apple's® A, M, S, U series of processors (e.g., A5, A6, A7, A8 . . . M1, M2 . . . S1, S2 . . . U1 . . . etc.); ARM's® application, embedded and secure processors; IBM® and/or Motorola's DragonBall® and PowerPC®; IBM's® and Sony's® Cell processor; Intel's® 80X86 series (e.g., 80386, 80486), Pentium®, Celeron®, Core (2) Duo®, i series (e.g., i3, i5, i7, i9, etc.), Itanium®, Xeon®, and/or XScale®; Motorola's® 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code), e.g., via load/read address commands; e.g., the CPU may read processor issuable instructions from memory (e.g., reading it from a component collection (e.g., an interpreted and/or compiled program application/library including allowing the processor to execute instructions from the application/library) stored in the memory). Such instruction passing facilitates communication within the AIDAC controller and beyond through various interfaces. Should processing requirements dictate a greater amount speed and/or capacity, distributed processors (e.g., see Distributed AIDAC below), mainframe, multi-core, parallel, and/or supercomputer architectures may similarly be employed. Alternatively, should deployment requirements dictate greater portability, smaller mobile devices (e.g., Personal Digital Assistants (PDAs)) may be employed.

Depending on the particular implementation, features of the AIDAC may be achieved by implementing a microcontroller such as any of: CAST's® R8051XC2 microcontroller; Diligent's® Basys 3 Artix-7, Nexys A7-100T, U192015125IT, etc.; Intel's® MCS 51 (i.e., 8051 microcontroller); and/or the like. Also, to implement certain features of the AIDAC, some feature implementations may rely on embedded components, such as any of: Application-Specific Integrated Circuit (“ASIC”), Digital Signal Processing (“DSP”), Field Programmable Gate Array (“FPGA”), and/or the like embedded technology. For example, any of the AIDAC component collection (distributed or otherwise) and/or features may be implemented via the microprocessor and/or via embedded components; e.g., via any of: ASIC, coprocessor, DSP, FPGA, and/or the like. Alternately, some implementations of the AIDAC may be implemented with embedded components that are configured and used to achieve a variety of features or signal processing.

Depending on the particular implementation, the embedded components may include software solutions, hardware solutions, and/or some combination of both hardware/software solutions. For example, AIDAC features discussed herein may be achieved through implementing FPGAs, which are a semiconductor devices containing programmable logic components called “logic blocks”, and programmable interconnects, such as any of: the high performance FPGA Virtex® series, the low cost Spartan® series manufactured by Xilinx®, and/or the like. Logic blocks and interconnects can be programmed by the customer or designer, after the FPGA is manufactured, to implement any of the AIDAC features. A hierarchy of programmable interconnects allow logic blocks to be interconnected as needed by the AIDAC system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the AIDAC may be developed on FPGAs and then migrated into a fixed version that more resembles ASIC implementations. Alternate or coordinating implementations may migrate AIDAC controller features to a final ASIC instead of or in addition to FPGAs. Depending on the implementation all of the aforementioned embedded components and microprocessors may be considered the “CPU” and/or “processor” for the AIDAC.

### Power Source

The power source 3186 may be of any various form for powering small electronic circuit board devices such as any of the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 3186 is connected to at least one of the interconnected subsequent components of the AIDAC thereby providing an electric current to all subsequent components. In one example, the power source 3186 is connected to the system bus component 3104. In an alternative embodiment, an outside power source 3186 is provided through a connection across the I/O 3108 interface. For example, Ethernet (with power on Ethernet), IEEE 1394, USB and/or the like connections carry both data and power across the connection and is therefore a suitable source of power.

### Interface Adapters

Interface bus(ses) 3107 may accept, connect, and/or communicate to a number of interface adapters, variously although not necessarily in the form of adapter cards, such as but not limited to any of: input output interfaces (I/O) 3108, storage interfaces 3109, network interfaces 3110, and/or the like. Optionally, cryptographic processor interfaces 3127 similarly may be connected to the interface bus. The interface bus provides for the communications of interface adapters with one another as well as with other components of the computer systemization. Interface adapters are adapted for a compatible interface bus. Interface adapters variously connect to the interface bus via a slot architecture. Various slot architectures may be employed, such as, but not limited to any of: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 3109 may accept, communicate, and/or connect to a number of storage devices such as, but not limited to any of: (removable) storage devices 3114, removable disc devices, and/or the like. Storage interfaces may employ connection protocols such as, but not limited to any of: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEE®) 1394, fiber channel, Non-Volatile Memory (NVM) Express (NVMe), Small Computer Systems Interface (SCSI), Thunderbolt, Universal Serial Bus (USB), and/or the like.

Network interfaces 3110 may accept, communicate, and/or connect to a communications network 3113. Through a communications network 3113, the AIDAC controller is accessible through remote clients 3133b (e.g., computers with web browsers) by users 3133a. Network interfaces may employ connection protocols such as, but not limited to any of: direct connect, Ethernet (e.g., any of: fiber, thick, thin, twisted pair 10/100/1000/10000 Base T, and/or the like), Token Ring, wireless connection such as IEEE 802.11a-y, and/or the like. Should processing requirements dictate a greater amount speed and/or capacity, distributed network controllers (e.g., see Distributed AIDAC below), architectures may similarly be employed to pool, load balance, and/or otherwise decrease/increase the communicative bandwidth required by the AIDAC controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi®, Wireless Application Protocol (WAP), I-mode, and/or the like); and/or the like. A network interface may be regarded as a specialized form of an input output interface. Further, multiple network interfaces 3110 may be used to engage with various communications network types 3113. For example, multiple network interfaces may be employed to allow for the communication over broadcast, multicast, and/or unicast networks.

Input Output interfaces (I/O) 3108 may accept, communicate, and/or connect to any of: user, peripheral devices 3112 (e.g., input devices 3111), cryptographic processor devices 3128, and/or the like. I/O may employ connection protocols such as, but not limited to any of: audio: analog, digital, monaural, RCA, stereo, and/or the like; data: Apple Desktop Bus (ADB)®, IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, Thunderbolt®/USB-C, VGA, and/or the like; wireless transceivers: 802.11a-y; Bluetooth®; cellular (e.g., code division multiple access (CDMA), high speed packet access (HSPA(+)), high-speed downlink packet access (HSDPA), global system for mobile communications (GSM), long term evolution (LTE), WiMax®, etc.); and/or the like. One output device may include a video display, which may comprise a Cathode Ray Tube (CRT), Liquid Crystal Display (LCD), Light-Emitting Diode (LED), Organic Light-Emitting Diode (OLED), and/or the like based monitor with an interface (e.g., HDMI circuitry and cable) that accepts signals from a video interface, may be used. The video interface composites information generated by a computer systemization and generates video signals based on the composited information in a video memory frame. Another output device is a television set, which accepts signals from a video interface. The video interface provides the composited video information through a video connection interface that accepts a video display interface (e.g., an RCA composite video connector accepting an RCA composite video cable; a DVI connector accepting a DVI display cable, etc.).

Peripheral devices 3112 may be connected and/or communicate to I/O and/or other facilities of the like such as any of: network interfaces, storage interfaces, directly to the interface bus, system bus, the CPU, and/or the like. Peripheral devices may be external, internal and/or part of the AIDAC controller. Peripheral devices may include any of: antenna, audio devices (e.g., line-in, line-out, microphone input, speakers, etc.), cameras (e.g., gesture (e.g., Microsoft Kinect®) detection, motion detection, still, video, webcam, etc.), dongles (e.g., for copy protection ensuring secure transactions with a digital signature, as connection/format adaptors, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 3111 often are a type of peripheral device 512 (see above) and may include any of: accelerometers, camaras, card readers, dongles, finger print readers, gloves, graphics tablets, joysticks, keyboards, microphones, mouse (mice), remote controls, security/biometric devices (e.g., facial identifiers, fingerprint reader, iris reader, retina reader, etc.), styluses, touch screens (e.g., capacitive, resistive, etc.), trackballs, trackpads, watches, and/or the like.

It should be noted that although user input devices and peripheral devices may be employed, the AIDAC controller may be embodied as an embedded, dedicated, and/or monitor-less (i.e., headless) device, and access may be provided over a network interface connection.

Cryptographic units such as, but not limited to any of: microcontrollers, processors 3126, interfaces 3127, and/or devices 3128 may be attached, and/or communicate with the AIDAC controller. A MC68HC16 microcontroller, manufactured by Motorola, Inc.®, may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other specialized cryptographic processors include any of: Broadcom's® CryptoNetX and other Security Processors; nCipher's® nShield; SafeNet's® Luna PCI (e.g., 7100) series; Semaphore Communications'® 40 MHz Roadrunner 184; Sun's® Cryptographic Accelerators (e.g., Accelerator 6000 PCIe Board, Accelerator 500 Daughtercard); Via Nano® Processor (e.g., L2100, L2200, U2400) line, which is capable of performing 500+MB/s of cryptographic instructions; VLSI Technology's® 33 MHz 6868; and/or the like.

### Memory

Generally, any mechanization and/or embodiment allowing a processor to affect the storage and/or retrieval of information is regarded as memory 3129. The storing of information in memory may result in a physical alteration of the memory to have a different physical state that makes the memory a (e.g., physical) structure with a unique encoding of the memory stored therein. While memory is often physical and/or non-transitory, short term transitory memories may also be employed in various contexts, e.g., network communication may also be employed to send data as signals acting as transitory as well, for applications not requiring more long-term storage. Often, memory is a fungible technology and resource, thus, any number of memory embodiments may be employed in lieu of or in concert with one another. It is to be understood that the AIDAC controller and/or a computer systemization may employ various forms of memory 3129. For example, a computer systemization may be configured to have the operation of on-chip CPU memory (e.g., registers), RAM, ROM, and any other storage devices performed by a paper punch tape or paper punch card mechanism; however, such an embodiment would result in an extremely slow rate of operation. In one configuration, memory 3129 may include ROM 3106, RAM 3105, and a storage device 3114. A storage device 3114 may be any various computer system storage. Storage devices may include: an array of devices (e.g., Redundant Array of Independent Disks (RAID)); a cache memory, a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; register memory (e.g., in a CPU), solid state memory devices (e.g., USB memory, solid state drives (SSD), etc.); other processor-readable storage mediums; and/or other devices of the like. Thus, a computer systemization generally employs and makes use of memory.

### Component Collection

The memory 3129 may contain a collection of processor-executable application/library/program and/or database components (e.g., including processor-executable instructions) and/or data such as, but not limited to any of: operating system component(s) 3115 (operating system); information server component(s) 3116 (information server); user interface component(s) 3117 (user interface); Web browser component(s) 3118 (Web browser); database(s) 3119; mail server component(s) 3121; mail client component(s) 3122; cryptographic server component(s) 3120 (cryptographic server); machine learning component 3123; distributed immutable ledger component 3124; the AIDAC component(s) 3135 (e.g., which may include TQLFA, TQAVP, MLET, AITP, AIDD 3141-3147, and/or the like components); and/or the like (i.e., collectively referred to throughout as a “component collection”). These components may be stored and accessed from the storage devices and/or from storage devices accessible through an interface bus. Although unconventional program components such as those in the component collection may be stored in a local storage device 3114, they may also be loaded and/or stored in memory such as: cache, peripheral devices, processor registers, RAM, remote storage facilities through a communications network, ROM, various forms of memory, and/or the like.

### Operating System

The operating system component 3115 is an executable program component facilitating the operation of the AIDAC controller. The operating system may facilitate access to any of: I/O, network interfaces, peripheral devices, storage devices, and/or the like. The operating system may be a highly fault tolerant, scalable, and secure system such as any of: Apple's Macintosh OS X® (Server) and macOS®; AT&T® Plan 9®; Be OS®; Blackberry's QNX®; Google's Chrome®; Microsoft's Windows® 7/8/10; Unix and Unix-like system distributions (such as AT&T's® UNIX®; Berkley Software Distribution (BSD)® variations such as FreeBSD®, NetBSD®, OpenBSD®, and/or the like; Linux® distributions such as Red Hat®, Ubuntu®, and/or the like); and/or the like operating systems. However, more limited and/or less secure operating systems also may be employed such as any of: Apple Macintosh OS® (i.e., versions 1-9), IBM OS/2®, Microsoft DOS®, Microsoft Windows® 2000/2003/3.1/95/98/CE/Millennium/Mobile/NT/Vista/XP/7/X (Server)®, Palm OS®, and/or the like. Additionally, for robust mobile deployment applications, mobile operating systems may be used, such as any of: Apple's iOS®; China Operating System COS®; Google's Android®; Microsoft® Windows® RT/Phone®; Palm's WebOS®; Samsung®/Intel's Tizen®; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with any of: communications networks, data, I/O, peripheral devices, program components, memory, user input devices, and/or the like. The operating system may provide communications protocols that allow the AIDAC controller to communicate with other entities through a communications network 3113. Various communication protocols may be used by the AIDAC controller as a subcarrier transport mechanism for interaction, such as, but not limited to any of: multicast, TCP/IP, UDP, unicast, and/or the like.

### Information Server

An information server component 3116 is a stored program component that is executed by a CPU. The information server may be an Internet information server such as, but not limited to any of: Apache Software Foundation's Apache®, Microsoft's Internet Information Server®, and/or the like. The information server may allow for the execution of program components through facilities such as any of: Active Server Page (ASP), ActiveX, (ANSI) (Objective−) C (++), C# and/or .NET®, Common Gateway Interface (CGI) scripts, dynamic (D) hypertext markup language (HTML), FLASH®, Java®, JavaScript®, Practical Extraction Report Language (PERL)®, Hypertext Pre-Processor (PHP), pipes, Python®, Ruby, wireless application protocol (WAP), WebObjects®, and/or the like. The information server may support secure communications protocols such as, but not limited to any of: File Transfer Protocol (FTP(S)); HyperText Transfer Protocol (HTTP); Secure Hypertext Transfer Protocol (HTTPS), Secure Socket Layer (SSL) Transport Layer Security (TLS), messaging protocols (e.g., America Online (AOL®) Instant Messenger (AIM)®, Application Exchange (APEX), ICQ, Internet Relay Chat (IRC), Microsoft Network (MSN) Messenger® Service, Presence and Instant Messaging Protocol (PRIM), Internet Engineering Task Force's® (IETF's) Session Initiation Protocol (SIP), SIP for Instant Messaging and Presence Leveraging Extensions (SIMPLE), Slack®, open XML-based Extensible Messaging and Presence Protocol (XMPP) (i.e., Jabber® or Open Mobile Alliance's (OMA's) Instant Messaging and Presence Service (IMPS)), Yahoo! Instant Messenger® Service, and/or the like). The information server may provide results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the AIDAC controller based on the remainder of the HTTP request. For example, a request such as http:// followed by the address, e.g., 123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with any of: the AIDAC database 3119, operating systems, other program components, user interfaces, Web browsers, and/or the like.

Access to the AIDAC database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the AIDAC. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in SQL by instantiating a search string with the proper join/select commands based on the tagged text entries, and the resulting command is provided over the bridge mechanism to the AIDAC as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as buttons, check boxes, cursors, graphical views, menus, scrollers, text fields, and windows (collectively referred to as widgets) similarly facilitate the access, capabilities, operation, and display of data and computer hardware and operating system resources, and status. Operation interfaces are called user interfaces. Graphical user interfaces (GUIs) such as the Apple's iOS®, Macintosh Operating System's Aqua®; IBM's OS/2®; Google's Chrome® (e.g., and other webbrowser/cloud based client OSs); Microsoft's Windows® 2000/2003/3.1/95/98/CE/Millennium/Mobile/NT/Vista/XP/7/X (Server)® (i.e., Aero, Surface, etc.); Unix's X-Windows (e.g., which may include additional Unix graphic interface libraries and layers such as K Desktop Environment (KDE)®, mythTV and GNU Network Object Model Environment (GNOME))®, web interface libraries (e.g., ActiveX®, AJAX, (D)HTML, FLASH®, Java®, JavaScript®, etc. interface libraries such as, but not limited to any of: Dojo, jQuery(UI), MooTools, Prototype, script.aculo.us, SWFObject, Yahoo! User Interface®, and/or the like, any of which may be used and) provide a baseline and mechanism of accessing and displaying information graphically to users.

A user interface component 3117 is a stored program component that is executed by a CPU. The user interface may be a graphic user interface as provided by, with, and/or atop operating systems and/or operating environments, and may provide executable library APIs (as may operating systems and the numerous other components noted in the component collection) that allow instruction calls to generate user interface elements such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 3118 is a stored program component that is executed by a CPU. The Web browser may be a hypertext viewing application such as any of: Apple's (mobile) Safari®, Brave Software, Inc.'s Brave Browser (including Virtual Private Network (VPN) features), Google's Chrome®, Microsoft Edge®, Microsoft Internet Explorer®, Mozilla's Firefox®, Netscape Navigator®, The Tor Project, Inc.'s Tor Browser® (including VPN features), and/or the like. Secure Web browsing may be supplied with 128 bit (or greater) encryption by way of HTTPS, SSL, and/or the like. Web browsers allowing for the execution of program components through facilities such as any of: ActiveX®, AJAX, (D)HTML, FLASH®, Java®, JavaScript®, web browser plug-in APIs (e.g., FireFox®, Safari® Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with any of: information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the AIDAC enabled nodes. The combined application may be nugatory on systems employing Web browsers.

### Mail Server

A mail server component 3121 is a stored program component that is executed by a CPU 3103. The mail server may be an Internet mail server such as, but not limited to any of: dovecot, Courier IMAP, Cyrus IMAP, Maildir, Microsoft Exchange®, sendmail, and/or the like. The mail server may allow for the execution of program components through facilities such as any of: ASP, ActiveX®, (ANSI) (Objective−) C (++), C# and/or NET, CGI scripts, Java®, JavaScript®, PERL®, PUP, pipes, Python®, WebObjects®, and/or the like. The mail server may support communications protocols such as, but not limited to any of: Internet message access protocol (IMAP), Messaging Application Programming Interface (MAPI)/Microsoft Exchange®, post office protocol (POP3), simple mail transfer protocol (SMTP), and/or the like. The mail server can route, forward, and process incoming and outgoing mail messages that have been sent, relayed and/or otherwise traversing through and/or to the AIDAC. Alternatively, the mail server component may be distributed out to mail service providing entities such as Google's® cloud services (e.g., Gmail® and notifications may alternatively be provided via messenger services such as AOL's Instant Messenger®, Apple's iMessage®, Google Messenger®, SnapChat®, etc.).

Access to the AIDAC mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 3122 is a stored program component that is executed by a CPU 3103. The mail client may be a mail viewing application such as any of: Apple Mail®, Microsoft Entourage®, Microsoft Outlook®, Microsoft Outlook Express®, Mozilla®, Thunderbird®, and/or the like. Mail clients may support a number of transfer protocols, such as any of: IMAP, Microsoft Exchange®, POP3, SMTP, and/or the like. A mail client may communicate to and/or with other components in a component collection, including itself, and/or facilities of the like. Most frequently, the mail client communicates with ay of: mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 3120 is a stored program component that is executed by any of: a CPU 3103, cryptographic processor 3126, cryptographic processor interface 3127, cryptographic processor device 3128, and/or the like. Cryptographic processor interfaces may allow for expedition of encryption and/or decryption requests by the cryptographic component; however, the cryptographic component, alternatively, may run on a CPU and/or GPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to any of: digital certificates (e.g., X.509 authentication framework), digital signatures, dual signatures, enveloping, password access protection, public key management, and/or the like. The cryptographic component facilitates numerous (encryption and/or decryption) security protocols such as, but not limited to any of: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the AIDAC may encrypt all incoming and/or outgoing communications and may serve as node within a virtual private network (VPN) with a wider communications network. The cryptographic component facilitates the process of “security authorization” whereby access to a resource is inhibited by a security protocol and the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to allow the AIDAC component to engage in secure transactions if so desired. The cryptographic component facilitates the secure accessing of resources on the AIDAC and facilitates the access of secured resources on remote systems; i.e., it may act as a client and/or server of secured resources. Most frequently, the cryptographic component communicates with any of: information servers, operating systems, other program components, and/or the like. The cryptographic component may contain, communicate, generate, obtain, and/or provide program component, system, user, and/or data communications, requests, and/or responses.

### Machine Learning (ML)

In one non limiting embodiment, the AIDAC includes a machine learning component 3123, which may be a stored program component that is executed by a CPU 3103. The machine learning component, alternatively, may run on any of: a set of specialized processors, ASICs, FPGAs, GPUs, and/or the like. The machine learning component may be deployed to execute serially, in parallel, distributed, and/or the like, such as by utilizing cloud computing. The machine learning component may employ an ML platform such as any of: Amazon SageMaker, Azure® Machine Learning, DataRobot AI Cloud, Google AI Platform, IBM Watson® Studio, and/or the like. The machine learning component may be implemented using any of: an ML framework such as any of: PyTorch, Apache MXNet, MathWorks Deep Learning Toolbox, scikit-learn, TensorFlow, XGBoost, and/or the like. The machine learning component facilitates training and/or testing of ML prediction logic data structures (e.g., models) and/or utilizing ML prediction logic data structures (e.g., models) to output ML predictions by the AIDAC. The machine learning component may employ various artificial intelligence and/or learning mechanisms such as any of: Reinforcement Learning, Supervised Learning, Unsupervised Learning, and/or the like. The machine learning component may employ ML prediction logic data structure (e.g., model) types such as any of: Bayesian Networks, Classification prediction logic data structures (e.g., models), Decision Trees, Neural Networks (NNs), Regression prediction logic data structures (e.g., models), and/or the like.

### Distributed Immutable Ledger (DIL)

In one non limiting embodiment, the AIDAC includes a distributed immutable ledger component 3124, which may be a stored program component that is executed by a CPU 3103. The distributed immutable ledger component, alternatively, may run on any of: a set of specialized processors, ASICs, FPGAs, GPUs, and/or the like. The distributed immutable ledger component may be deployed to execute as any of: serially, in parallel, distributed, and/or the like, such as by utilizing a peer-to-peer network. The distributed immutable ledger component may be implemented as a blockchain (e.g., public blockchain, private blockchain, hybrid blockchain) that comprises cryptographically linked records (e.g., blocks). The distributed immutable ledger component may employ a platform such as any of: Bitcoin, Bitcoin Cash, Dogecoin, Ethereum, Litecoin, Monero, Zcash, and/or the like. The distributed immutable ledger component may employ a consensus mechanism such as any of: proof of authority, proof of space, proof of stake, proof of work, and/or the like. The distributed immutable ledger component may be used to provide mechanisms such as any of: data storage, cryptocurrency, inventory tracking, non-fungible tokens (NFTs), smart contracts, and/or the like.

### The AIDAC Database

The AIDAC database component 3119 may be embodied in a database and its stored data. The database is a stored program component, which is executed by the CPU; the stored program component portion configuring the CPU to process the stored data. The database may be a fault tolerant, relational, scalable, secure database such as any of: Claris FileMaker®, MySQL®, Oracle®, Sybase®, etc. may be used. Additionally, optimized fast memory and distributed databases such as any of: IBM's Netezza®, MongoDB's MongoDB®, opensource Hadoop®, opensource VoltDB, SAP's Hana®, etc. Relational databases are an extension of a flat file. Relational databases include a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the AIDAC database may be implemented using various other data-structures, such as any of: an array, hash, (linked) list, struct, structured text file (e.g., JSON, XML, and/or the like), table, flat file database, and/or the like. Such data-structures may be stored in memory and/or in (structured) files. In another alternative, an object-oriented database may be used, such as any of: Frontier™, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the AIDAC database is implemented as a data-structure, the use of the AIDAC database 3119 may be integrated into another component such as the AIDAC component 3135. Also, the database may be implemented as a mix of data structures, objects, programs, relational structures, scripts, and/or the like. Databases may be consolidated and/or distributed in countless variations (e.g., see Distributed AIDAC below). Portions of databases, e.g., tables, may be exported and/or imported and thus decentralized and/or integrated.

In another embodiment, the database component (and/or other storage mechanism of the AIDAC) may store data immutably so that tampering with the data becomes physically impossible and the fidelity and security of the data may be assured. In some embodiments, the database may be stored to write only or write once, read many (WORM) mediums. In another embodiment, the data may be stored on distributed ledger systems (e.g., via blockchain) so that any tampering to entries would be readily identifiable. In one embodiment, the database component may employ the distributed immutable ledger component DIL 3124 mechanism.

In one embodiment, the database component 3119 includes several tables representative of the schema, tables, structures, keys, entities and relationships of the described database 3119a-z:
An accounts table 3119a includes fields such as, but not limited to any of: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, linkWalletsID, accountPrioritAccaountRatio, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;
A users table 3119b includes fields such as, but not limited to any of: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, reputationScore, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a AIDAC);
An devices table 3119c includes fields such as, but not limited to any of: deviceID, sensorIDs, accountID, assetIDs, paymentIDs, deviceType, deviceName, deviceManufacturer, deviceModel, deviceVersion, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, walletAppInstalledFlag, deviceAccessPrivileges, devicePreferences, deviceRestrictions, hardware_config, software_config, storage_location, sensor_value, pin reading, data length, channel_requirement, sensor_name, sensor_model_no, sensor_manufacturer, sensor type, sensor_serial_number, sensor_power_requirement, device_power_requirement, location, sensor_associated_tool, sensor_dimensions, device_dimensions, sensor_communications_type, device_communications_type, power_percentage, power_condition, temperature_setting, speed_adjust, hold_duration, part_actuation, and/or the like. Device table may, in some embodiments, include fields corresponding to one or more Bluetooth® profiles, such as those published at www.bluetooth.org/en-us/specification/adopted-specifications, and/or other device specifications, and/or the like;
An apps table 3119d includes fields such as, but not limited to any of: appID, appName, appType, appDependencies, accountID, deviceIDs, transactionID, userID, appStoreAuthKey, appStoreAccountID, appStoreIPaddress, appStoreURLaccessCode, appStorePortNo, appAccessPrivileges, appPreferences, appRestrictions, portNum, access_API_call, linked_wallets_list, and/or the like;
An assets table 3119e includes fields such as, but not limited to any of: assetID, accountID, userID, distributorAccountID, distributorPaymentID, distributorOnwerID, assetOwnerID, assetType, assetSourceDeviceID, assetSourceDeviceType, assetSourceDeviceName, assetSourceDistributionChannelID, assetSourceDistributionChannelType, assetSourceDistributionChannelName, assetTargetChannelID, assetTargetChannelType, assetTargetChannelName, assetName, assetSeriesName, assetSeriesSeason, assetSeriesEpisode, assetCode, assetQuantity, assetCost, assetPrice, assetValue, assetManufactuer, assetModelNo, assetSerialNo, assetLocation, assetAddress, assetState, assetZTPcode, assetState, assetCountry, assetEmail, assetGarbageCollected, assetTPaddress, assetURLaccessCode, assetOwnerAccountID, subscriptionIDs, assetAuthroizationCode, assetAccessPrivileges, assetPreferences, assetRestrictions, assetAPL, assetAPIconnectionAddress, and/or the like;
A payments table 3119f includes fields such as, but not limited to any of: paymentID, accountID, userID, couponID, couponValue, couponConditions, couponExpiration, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZTPcode, paymentCountry, paymentEmail, paymentAuthKey, paymentIPaddress, paymentURLaccessCode, paymentPortNo, paymentAccessPrivileges, paymentPreferences, payementRestrictions, and/or the like;
An transactions table 3119g includes fields such as, but not limited to any of: transactionID, accountID, assetIDs, deviceIDs, paymentIDs, transactionIDs, userID, merchantID, transactionType, transactionDate, transactionTime, transactionAmount, transactionQuantity, transactionDetails, productsList, productType, productTitle, productsSummary, productParamsList, transactionNo, transactionAccessPrivileges, transactionPreferences, transactionRestrictions, merchantAuthKey, merchantAuthCode, and/or the like;
An merchants table 3119h includes fields such as, but not limited to any of: merchantID, merchantTaxID, merchanteName, merchantContactUserID, accountID, issuerID, acquirerID, merchantEmail, merchantAddress, merchantState, merchantZIPcode, merchantCountry, merchantAuthKey, merchantTPaddress, portNum, merchantURLaccessCode, merchantPortNo, merchantAccessPrivileges, merchantPreferences, merchantRestrictions, and/or the like;
An ads table 3119i includes fields such as, but not limited to any of: adID, advertiserID, adMerchantID, adNetworkID, adName, adTags, advertiserName, adSponsor, adTime, adGeo, adAttributes, adFormat, adProduct, adText, adMedia, adMediaID, adChannelID, adTagTime, adAudioSignature, adHash, adTemplateID, adTemplateData, adSourceID, adSourceName, adSourceServerIP, adSourceURL, adSourceSecurityProtocol, adSourceFTP, adAuthKey, adAccessPrivileges, adPreferences, adRestrictions, adNetworkXchangeID, adNetworkXchangeName, adNetworkXchangeCost, adNetworkXchangeMetricType (e.g., CPA, CPC, CPM, CTR, etc.), adNetworkXchangeMetricValue, adNetworkXchangeServer, adNetworkXchangePortNumber, publisherID, publisherAddress, publisherURL, publisherTag, publisherIndustry, publisherName, publisherDescription, siteDomain, siteURL, siteContent, siteTag, siteContext, siteImpression, siteVisits, siteHeadline, sitePage, siteAdPrice, sitePlacement, sitePosition, bidID, bidExchange, bidOS, bidTarget, bidTimestamp, bidPrice, bidImpressionID, bidType, bidScore, adType (e.g., mobile, desktop, wearable, largescreen, interstitial, etc.), assetID, merchantID, deviceID, userID, accountID, impressionID, impressionOS, impressionTimeStamp, impressionGeo, impressionAction, impressionType, impressionPublisherID, impressionPublisherURL, and/or the like;
An ML table 3119j includes fields such as, but not limited to any of: MLID, predictionLogicStructureID, predictionLogicStructureType, predictionLogicStructureConfiguration, predictionLogicStructureTrainedStructure, predictionLogicStructureTrainingData, predictionLogicStructureTrainingDataConfiguration, predictionLogicStructureTestingData, predictionLogicStructureTestingDataConfiguration, predictionLogicStructureOutputData, predictionLogicStructureOutputDataConfiguration, and/or the like;
A market_data table 3119z includes fields such as, but not limited to any of: market_data_feed_ID, asset_ID, asset symbol, asset_name, spot_price, bid_price, ask_price, and/or the like; in one embodiment, the market data table is populated through a market data feed (e.g., Bloomberg's PhatPipe®, Consolidated Quote System® (CQS), Consolidated Tape Association® (CTA), Consolidated Tape System® (CTS), Dun & Bradstreet®, OTC Montage Data Feed® (OMDF), Reuter's Tib®, Triarch®, US equity trade and quote market data®, Unlisted Trading Privileges® (UTP) Trade Data Feed® (UTDF), UTP Quotation Data Feed® (UQDF), and/or the like feeds, e.g., via ITC 2.1 and/or respective feed protocols), for example, through Microsoft's® Active Template Library and Dealing Object Technology's real-time toolkit Rtt.Multi.

In one embodiment, the AIDAC database may interact with other database systems. For example, employing a distributed database system, queries and data access by search AIDAC component may treat the combination of the AIDAC database, an integrated data security layer database as a single database entity (e.g., see Distributed AIDAC below).

In one embodiment, user programs may contain various user interface primitives, which may serve to update the AIDAC. Also, various accounts may require custom database tables depending upon the environments and the types of clients the AIDAC may need to serve. It should be noted that any unique fields may be designated as a key field throughout. In an alternative embodiment, these tables have been decentralized into their own databases and their respective database controllers (i.e., individual database controllers for each of the above tables). The AIDAC may also be configured to distribute the databases over several computer systemizations and/or storage devices. Similarly, configurations of the decentralized database controllers may be varied by consolidating and/or distributing the various database components 3119a-z. The AIDAC may be configured to keep track of various settings, inputs, and parameters via database controllers.

The AIDAC database may communicate to and/or with other components in a component collection, including itself, and/or facilities of the like. Most frequently, the AIDAC database communicates with any of: the AIDAC component, other program components, and/or the like. The database may contain, retain, and provide information regarding other nodes and data.

### The AIDACs

The AIDAC component 3135 is a stored program component that is executed by a CPU via stored instruction code configured to engage signals across conductive pathways of the CPU and ISICI controller components. In one embodiment, the AIDAC component incorporates any and/or all combinations of the aspects of the AIDAC that were discussed in the previous figures. As such, the AIDAC affects accessing, obtaining and the provision of information, services, transactions, and/or the like across various communications networks. The features and embodiments of the AIDAC discussed herein increase network efficiency by reducing data transfer requirements with the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., may reduce the capacity and structural infrastructure requirements to support the AIDAC's features and facilities, and in many cases reduce the costs, energy consumption/requirements, and extend the life of AIDAC's underlying infrastructure; this has the added benefit of making the AIDAC more reliable. Similarly, many of the features and mechanisms are designed to be easier for users to use and access, thereby broadening the audience that may enjoy/employ and exploit the feature sets of the AIDAC; such ease of use also helps to increase the reliability of the AIDAC. In addition, the feature sets include heightened security as noted via the Cryptographic components 3120, 3126, 3128 and throughout, making access to the features and data more reliable and secure

The AIDAC transforms temporal quantum limited asset value request, temporal quantum limited asset fill request, ML engine training request, AI task processing request datastructure/inputs, via AIDAC components (e.g., TQLFA, TQAVP, MLET, AITP, AIDD), into temporal quantum limited asset value response, temporal quantum limited asset fill response, ML engine training response, AI task processing response outputs.

The AIDAC component facilitates access of information between nodes may be developed by employing various development tools and languages such as, but not limited to any of: Apache® components, Assembly, ActiveX, binary executables, (ANSI) (Objective−) C (++), C# and/or .NET®, database adapters, CGI scripts, Java®, JavaScript®, mapping tools, procedural and object oriented development tools, PERL®, PUP, Python®, Ruby, shell scripts, SQL commands, web application server extensions, web development environments and libraries (e.g., Microsoft's® ActiveX®; Adobe AIR®, FLEX & FLASH®; AJAX; (D)HTML; Dojo, Java®; JavaScript®; jQuery(UI); MooTools; Prototype; script.aculo.us; Simple Object Access Protocol (SOAP); SWFObject; Yahoo!® User Interface; and/or the like), WebObjects®, and/or the like. In one embodiment, the AIDAC server employs a cryptographic server to encrypt and decrypt communications. The AIDAC component may communicate to and/or with other components in a component collection, including itself, and/or facilities of the like. Most frequently, the AIDAC component communicates with any of: the AIDAC database, operating systems, other program components, and/or the like. The AIDAC may contain, communicate, generate, obtain, and/or provide program component, system, user, and/or data communications, requests, and/or responses.

### Distributed AIDACs

The structure and/or operation of any of the AIDAC node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion. As such, a combination of hardware may be distributed within a location, within a region and/or globally where logical access to a controller may be abstracted as a singular node, yet where a multitude of private, semiprivate and publicly accessible node controllers (e.g., via dispersed data centers) are coordinated to serve requests (e.g., providing private cloud, semiprivate cloud, and public cloud computing resources) and allowing for the serving of such requests in discrete regions (e.g., isolated, local, regional, national, global cloud access, etc.).

Thus, AIDAC may be implemented with varying functional, logical, operational, organizational, structural and/or topological modifications may be made without departing from the scope and/or spirit of the disclosure. For example, unless expressly described otherwise, it is to be understood that the logical and/or topological structure of any combination of any program components (e.g., of the component collection), other components, data flow order, logic flow order, and/or any present feature sets as described in the figures and/or throughout are not limited to a fixed operating order and/or arrangement, but rather, any disclosed order is exemplary (e.g., such description may be presented as such for ease of description and understanding of disclosed principles) and all equivalents, and the components may execute at the same or different processors and in varying orders. Furthermore, it is to be understood that such features are not limited to serial execution (e.g., such description may be presented as such for ease of description and understanding of disclosed principles), but rather, any number of threads, processes, services, servers, and/or the like that may execute asymmetrically, asynchronously, batch, concurrently, delayed, dynamically, in parallel, on-demand, periodically, real-time, symmetrically, simultaneously, synchronously, triggered, and/or the like may take place depending on how the components and even individual methods and/or functions are called. For example, in any of the dataflow and/or logic flow descriptions, any individual item and/or method and/or function called may only execute serially and/or asynchronously in a small deployment on a single core machine, but may be executed concurrently, in parallel, simultaneously, synchronously (as well as asynchronously yet still concurrent, in parallel, and/or simultaneously) when deployed on multicore processors or even across multiple machines and in and from multiple machines and geographic regions.

As such, the component collection may be consolidated and/or distributed in countless variations through various data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so as discussed through the disclosure and/or through various other data processing communication techniques. Furthermore, any part or sub parts of the AIDAC node controller's component collection (and/or any constituent processing instructions) may be executed on at least one processing unit, where that processing unit may be a sub-unit of a CPU, a core, an entirely different CPU and/or sub-unit at the same location or remotely at a different location, and/or across many multiple such processing units. For example, for load-balancing reasons, parts of the component collection may start to execute on a given CPU core, then the next instruction/execution element of the component collection may (e.g., be moved to) execute on another CPU core, on the same, or completely different CPU at the same or different location, e.g., because the CPU may become over taxed with instruction executions, and as such, a scheduler may move instructions at the taxed CPU and/or CPU sub-unit to another CPU and/or CPU sub-unit with a lesser instruction execution load. In another embodiment, processing may take place on hosted virtual machines such as on Amazon® Data/Web Services (AWS)® where virtual machines literally do not even exist while AIDAC is executing, and as processing demands increase, such additional virtual machines may be spun up and instantiated as necessary and created on-the-fly to increase processing throughput (e.g., by distributing processing of AIDAC component collection processor instructions), and conversely, virtual machines may be spun down and cease to exist as processing demands decrease; these virtual machines may be spun up/down on the same, or in completely remote and physically separate facilities and hardware. As such, it may be difficult and/or impossible to predict on which CPU, processing sub-unit, and/or virtual machine a process instruction begins execution and where it will continue and/or conclude execution, as it may be on the same and/or completely different CPU, processing sub-unit, virtual machine, and/or the like.

The configuration of the AIDAC controller may depend on the context of system deployment. Factors such as, but not limited to any of: the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to any of: data referencing (e.g., pointers), internal messaging, object instance variable communication, shared memory space, variable passing, and/or the like. For example, cloud services such as any of: Amazon Data/Web Services®, Microsoft Azure®, Hewlett Packard Helion®, IBM® Cloud services allow for AIDAC controller and/or AIDAC component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to any of: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON)®, NeXT Computer, Inc.'s® (Dynamic) Object Linking, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as any of: JSON, lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to any of: character (e.g., tab) delineated text, HTML, JSON, structured text streams, XML, and/or the like structured data. In another embodiment, inter-application data processing protocols themselves may have integrated parsers (e.g., JSON, SOAP, and/or like parsers) that may be employed to parse (e.g., communications) data. Further, the parsing grammar may be used beyond message parsing, but may also be used to parse any of: databases, data collections, data stores, structured data, and/or the like. Again, the desired configuration may depend upon the context, environment, and requirements of system deployment.

For example, in some implementations, the AIDAC controller may be executing a PUP script implementing a Secure Sockets Layer (“SSL”) socket server via the information server, which it listens to incoming communications on a server port to which a client may send data, e.g., data encoded in JSON format. Upon identifying an incoming communication, the PUP script may read the incoming message from the client device, parse the received JSON-encoded text data to extract information from the JSON-encoded text data into PUP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via an SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create (AF_INET, SOCK_STREAM, 0);
socket_bind($sock, $address, $port) or die (‘Could not bind to
address');
socket_listen($sock);
$client = socket_accept($sock);
// read input data from client device in 1024 byte blocks until end
of message
do {
  $input = “ ”;
  $input = socket_read($client, 1024);
  $data .= $input;
} while($input != “ ”);
// parse data to extract variables
$obj = json_decode($data, true);
// store input data in a database
mysql_connect (″201.408.185.132″,$DBserver, $password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:

www.xav.com/perl/site/lib/SOAP/Parser.html
publib.boulder.ibm.com/infocenter/tivihelp/v2r1/index.jsp?topic=/com.ibm.IBMDI.d
oc/referenceguide295.htm

and other parser implementations:

publib.boulder.ibm.com/infocenter/tivihelp/v2r1/index.jsp?topic=/com.ibm.IBMDI.d
oc/referenceguide259.htm

all of which are hereby expressly incorporated by reference.

In order to address various issues and advance the art, the entirety of this application for AI-Driven Digital Asset Co-pilot Apparatuses, Mechanisms, Mediums, Processes and Systems (including the Cover Page, Title, Headings, Field, Background, Summary, Brief Description of the Drawings, Detailed Description, Claims, Abstract, Figures, Appendices, and otherwise) shows, by way of illustration, various non-limiting example embodiments in which the claimed innovations may be practiced. The advantages and features described in the application are of a representative sample of embodiments only, and are not exhaustive and/or exclusive. They are presented to assist in understanding and teach the claimed principles. It should be noted that to the extent any financial and/or investment examples are included, such examples are for illustrative purpose(s) only, and are not, nor should they be interpreted, as investment advice. As such, all examples and/or embodiments are deemed to be non-limiting throughout this disclosure; it should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It may be appreciated that many of those undescribed embodiments incorporate and/or be based of same principles of the innovations and others are equivalent. As such, no inference should be drawn regarding those embodiments discussed herein relative to those not discussed herein other than it is as such for purposes of reducing space and repetition. Consequently, terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should not be construed to limit embodiments, and instead, again, are offered for convenience of description of orientation and/or convenience of reference, and as such, do not require that any embodiments be constructed or operated in a particular orientation unless explicitly indicated as such. Terms such as “attached”, “affixed”, “connected”, “coupled”, “interconnected”, etc. may refer to a relationship where structures are secured or attached to one another either directly or indirectly through intervening structures, as well as both movable or rigid attachments or relationships, unless expressly described otherwise. Similarly, descriptions of embodiments disclosed throughout this disclosure, any reference to direction or orientation is merely intended for convenience of description and/or of reference and is not intended in any way to limit the scope of described embodiments. Furthermore, it is to be understood, unless expressly described otherwise, that other embodiments may be utilized and functional, logical, operational, organizational, structural and/or topological modifications may be made without departing from the scope and/or spirit of the disclosure. For instance, unless expressly described otherwise, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Also, it is to be understood, unless expressly described otherwise, that such features are not limited to serial execution, but rather, any number of threads, processes, services, servers, and/or the like that may execute asymmetrically, asynchronously, batch, concurrently, delayed, dynamically, in parallel, on-demand, periodically, real-time, symmetrically, simultaneously, synchronously, triggered, and/or the like are contemplated by the disclosure (e.g., see Distributed AIDAC, above, for examples). Consequently, some of these features may be mutually contradictory, in that they cannot be simultaneously present in a single embodiment. Similarly, some features may be applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations-in-part, divisions, provisionals, re-issues, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a AIDAC individual and/or enterprise user, component, database configuration and/or relational model, data type, data transmission and/or network framework, feature, library, syntax structure, and/or the like, various embodiments of the AIDAC, may be implemented that allow a great deal of flexibility and customization. While various embodiments and discussions of the AIDAC have included artificial intelligence systems, however, it is to be understood that the embodiments described herein may be readily configured and/or customized for a wide variety of other applications and/or implementations. For example, aspects of the AIDAC also may be adapted for auctions for goods and services, data retrieval from live streams, performing tasks using a variety of AI engines (e.g., instead of or in concert with LLMs), and/or the like.

What is claimed is:

1. An AI task processing apparatus, comprising:
at least one memory;
a component collection stored in the at least one memory;
any of at least one processor disposed in communication with the at least one memory, the any of at least one processor executing processor-executable instructions from the component collection, storage of the component collection structured with processor-executable instructions comprising:
obtain a task processing request datastructure, in which the task processing request datastructure is structured as specifying task instructions for a task;
determine a set of subtasks for the task by analyzing the task instructions via an orchestration generative AI engine, in which a subtask corresponds to a function specified via a predefined schema incorporated into an execution context of the orchestration generative AI engine;
determine via the orchestration artificial intelligence engine, for each respective subtask in the set of subtasks, a subtask execution generative AI engine to utilize for the respective subtask;
determine via the orchestration artificial intelligence engine, for each respective subtask in the set of subtasks, a relevant subtask dataset for the respective subtask, in which the relevant subtask dataset for the respective subtask is incorporated into an execution context of the subtask execution generative AI engine to utilize for the respective subtask;
obtain via the orchestration artificial intelligence engine, for each respective subtask in the set of subtasks, a subtask execution result for the respective subtask from the subtask execution generative AI engine to utilize for the respective subtask;
evaluate via the orchestration artificial intelligence engine, for each respective subtask in the set of subtasks, acceptability of the subtask execution result for the respective subtask; and
composite via the orchestration artificial intelligence engine, a task execution result for the task via one or more of the obtained subtask execution results.

2. The apparatus of claim 1, in which the task instructions comprise a free text user prompt.

3. The apparatus of claim 1, in which the task instructions comprise one of: a GUI command, a CLI command, an API command.

4. The apparatus of claim 1, in which the instructions to determine the set of subtasks for the task further comprise instructions to:
determine a task template associated with the task; and
in which the set of subtasks for the task is determined via the task template.

5. The apparatus of claim 1, in which the instructions to determine the subtask execution generative AI engine to utilize for the respective subtask are structured as instructions to determine a best performing subtask execution generative AI engine for a function corresponding to the respective subtask.

6. The apparatus of claim 1, in which the instructions to determine the subtask execution generative AI engine to utilize for the respective subtask are structured as instructions to determine a plurality of subtask execution generative AI engines to utilize in parallel for the respective subtask.

7. The apparatus of claim 1, in which a relevant subtask dataset comprises relevant historical data, relevant on-demand data, and relevant entity data associated with an entity or a user specified via the task processing request datastructure.

8. The apparatus of claim 1, in which the instructions to obtain the subtask execution result for the respective subtask further comprise instructions to provide subtask execution instructions generated via the orchestration generative AI engine to the subtask execution generative AI engine to utilize for the respective subtask.

9. The apparatus of claim 1, in which the instructions to obtain the subtask execution result for the respective subtask further comprise instructions to provide subtask execution instructions, specified via a function of the predefined schema corresponding to the respective subtask, to the subtask execution generative AI engine to utilize for the respective subtask.

10. The apparatus of claim 1, in which the acceptability of a subtask execution result is evaluated via one or more of AI reasoning, validation mechanisms, structured checks.

11. The apparatus of claim 1, in which the instructions to evaluate acceptability of the subtask execution result for the respective subtask further comprise instructions to determine via the orchestration generative AI engine corrective measures for the respective subtask upon determining that the subtask execution result for the respective subtask is not acceptable.

12. The apparatus of claim 11, in which the corrective measures for the respective subtask comprise corrective instructions to utilize for the subtask execution generative AI engine to utilize for the respective subtask.

13. The apparatus of claim 11, in which the corrective measures for the respective subtask comprise a selection of another subtask execution generative AI engine to utilize for the respective subtask.

14. The apparatus of claim 11, in which the corrective measures for the respective subtask comprise obtaining an additional relevant subtask dataset for the respective subtask.

15. The apparatus of claim 1, in which the storage of the component collection is further structured with processor-executable instructions comprising:
augment via the orchestration artificial intelligence engine, the task execution result for the task with a recommended action determined via analysis of the task execution result.

16. An AI task processing processor-readable, non-transient medium, the medium storing a component collection, storage of the component collection structured with processor-executable instructions comprising:
obtain a task processing request datastructure, in which the task processing request datastructure is structured as specifying task instructions for a task;
determine a set of subtasks for the task by analyzing the task instructions via an orchestration generative AI engine, in which a subtask corresponds to a function specified via a predefined schema incorporated into an execution context of the orchestration generative AI engine;
determine via the orchestration artificial intelligence engine, for each respective subtask in the set of subtasks, a subtask execution generative AI engine to utilize for the respective subtask;
determine via the orchestration artificial intelligence engine, for each respective subtask in the set of subtasks, a relevant subtask dataset for the respective subtask, in which the relevant subtask dataset for the respective subtask is incorporated into an execution context of the subtask execution generative AI engine to utilize for the respective subtask;
obtain via the orchestration artificial intelligence engine, for each respective subtask in the set of subtasks, a subtask execution result for the respective subtask from the subtask execution generative AI engine to utilize for the respective subtask;
evaluate via the orchestration artificial intelligence engine, for each respective subtask in the set of subtasks, acceptability of the subtask execution result for the respective subtask; and
composite via the orchestration artificial intelligence engine, a task execution result for the task via one or more of the obtained subtask execution results.

17. An AI task processing processor-implemented system, comprising:
means to store a component collection;
means to process processor-executable instructions from the component collection, storage of the component collection structured with processor-executable instructions comprising:
obtain a task processing request datastructure, in which the task processing request datastructure is structured as specifying task instructions for a task;
determine a set of subtasks for the task by analyzing the task instructions via an orchestration generative AI engine, in which a subtask corresponds to a function specified via a predefined schema incorporated into an execution context of the orchestration generative AI engine;
determine via the orchestration artificial intelligence engine, for each respective subtask in the set of subtasks, a subtask execution generative AI engine to utilize for the respective subtask;
determine via the orchestration artificial intelligence engine, for each respective subtask in the set of subtasks, a relevant subtask dataset for the respective subtask, in which the relevant subtask dataset for the respective subtask is incorporated into an execution context of the subtask execution generative AI engine to utilize for the respective subtask;
obtain via the orchestration artificial intelligence engine, for each respective subtask in the set of subtasks, a subtask execution result for the respective subtask from the subtask execution generative AI engine to utilize for the respective subtask;
evaluate via the orchestration artificial intelligence engine, for each respective subtask in the set of subtasks, acceptability of the subtask execution result for the respective subtask; and
composite via the orchestration artificial intelligence engine, a task execution result for the task via one or more of the obtained subtask execution results.

18. An AI task processing process, including processing processor-executable instructions via any of at least one processor from a component collection stored in at least one memory, storage of the component collection structured with processor-executable instructions comprising:
obtain a task processing request datastructure, in which the task processing request datastructure is structured as specifying task instructions for a task;
determine a set of subtasks for the task by analyzing the task instructions via an orchestration generative AI engine, in which a subtask corresponds to a function specified via a predefined schema incorporated into an execution context of the orchestration generative AI engine;
determine via the orchestration artificial intelligence engine, for each respective subtask in the set of subtasks, a subtask execution generative AI engine to utilize for the respective subtask;
determine via the orchestration artificial intelligence engine, for each respective subtask in the set of subtasks, a relevant subtask dataset for the respective subtask, in which the relevant subtask dataset for the respective subtask is incorporated into an execution context of the subtask execution generative AI engine to utilize for the respective subtask;
obtain via the orchestration artificial intelligence engine, for each respective subtask in the set of subtasks, a subtask execution result for the respective subtask from the subtask execution generative AI engine to utilize for the respective subtask;
evaluate via the orchestration artificial intelligence engine, for each respective subtask in the set of subtasks, acceptability of the subtask execution result for the respective subtask; and
composite via the orchestration artificial intelligence engine, a task execution result for the task via one or more of the obtained subtask execution results.
